(19) United States
(12) Patent Application Publication
(10) Pub. No.: US 2009/0018778 A1
(43) Pub. Date: Jan. 15, 2009

(54) Method Related to Gestation Periods

(76) Inventors: David Peter Nation, Albert Park (AU); Ian Michael Lewis, St Kilda East (AU)

Correspondence Address: TECHNOLOGY LAW, PLLC, 3595 N. SUNSET WAY, SANFORD, MI, 48657, US

(21) Appl. No.: 12/223,491

(22) PCT Filed: Feb. 6, 2007
(86) PCT No.: PCT/AU2007/000117

§ 371 Date: Jul. 31, 2008

(30) Foreign Application Priority Data
Feb. 6, 2006 (AU) 200600568

(51) Int. Cl. A61D 19/00; G06F 19/00

(52) U.S. Cl. 702/19

(57) ABSTRACT

The present invention relates generally to a method for estimating the time elapsed within a gestation period of a pregnant or potentially pregnant ruminant, such as a cow. The method involves estimating the time elapsed within a gestation period of a pregnant or potentially pregnant ruminant, including the steps of providing a sample from the ruminant; calculating a value of a pregnancy indicator in the sample; and applying a regression formula to the value of the pregnancy indicator to provide an estimate of the time elapsed within the gestation period. The method may further include the steps of categorising the pregnancy status of the ruminant, qualitatively assessing the level of the pregnancy indicator value for application thereto of the regression formula, using the time elapsed to derive an estimate of a gestation-related event, and validating the estimated date of a gestation related event. The invention further provides computer software to generate an estimate of the time elapsed within a gestation period of a pregnant ruminant, and systems for generating an estimate of the time elapsed.

### FIELD OF THE INVENTION

The present invention relates generally to a method for estimating the time elapsed within a gestation period of a pregnant or potentially pregnant ruminant, such as a cow. The invention has particular application to the estimation of the conception date or other key dates during the gestation period of a cow, and it will be convenient to describe the invention in relation to that exemplary, but non-limiting application.

### BACKGROUND OF THE INVENTION

Traditional methods of pregnancy testing of cows include manual palpitation and ultrasound, both of which are carried out via the rectum of the cow. Such “invasive” methods are cumbersome, stressful for the cow, carry the risk of spontaneous abortion and disease transmission and are generally inconvenient for the farmer due to disruptions to milking routines and the need to organise suitably qualified personnel to conduct the examination. A pregnancy test that eliminates the need for manual testing and problems associated therewith has inherent value for dairy farmers.

A milk-based pregnancy test has been developed that measures the value of a pregnancy hormone, usually Estrone Sulphate (ES) in the milk. The hormone is released from the cow's placenta in increasing amounts as the pregnancy progresses. Several products enabling such pregnancy tests to be carried out are available, including Confirm®, an Enzyme Linked Immuno Sorbent Assay (ELISA) based product developed by ICPBio in New Zealand. In general, milk-based pregnancy tests are particularly convenient given that the collection of milk samples for determining quantity and quality, including fat and protein levels, is already common in most countries.

However, known milk-based pregnancy tests do not enable a farmer to determine the approximate conception date of the cow or the date she is due to calve. This information would be useful in determining the date at which pregnant cows must be “dried off” prior to the birth of a calf. Cows are “dried off” by the cessation of milking to allow for the udder to properly prepare for the next lactation that will commence when the cow calves.

The gestation period for a cow is approximately 9 months (282 days), and the cow should be “dried off”, that is milking ceased, 6-8 weeks prior to the birth. For commercial dairy farmers, this has an important short term financial impact as they cannot earn from the cow during this time.

It is therefore important that a farmer be able to accurately predict the cow's anticipated calving date in order to be able to determine when to begin drying off, so that the cow is able to be milked as long as possible.

It would therefore be desirable to provide an accurate method of estimating the time elapsed, such as the date of conception or a date of calving, of a pregnant ruminant during a gestation period. It would also be desirable for such a method to be simple and convenient in both its implementation and use. It would also be desirable to provide a method of estimating the time elapsed of a pregnant ruminant during a gestation period that alleviates or overcomes one or more disadvantages of the prior art.

### SUMMARY OF THE INVENTION

One aspect of the invention provides a method of estimating the time elapsed within a gestation period of a pregnant or potentially pregnant ruminant, including the step of:

applying a regression formula to a value of a pregnancy indicator in a sample obtained from the ruminant to thereby derive the time elapsed of the pregnant ruminant during the gestation period.

In one embodiment of this aspect of the invention there is provided a method of estimating the time elapsed within a gestation period of a pregnant or potentially pregnant ruminant, including the steps of:
providing a sample from the ruminant;
calculating a value of a pregnancy indicator in the sample; and
applying a regression formula to the value of the pregnancy indicator to provide an estimate of the time elapsed within the gestation period.

The regression formula may be characteristic of a profile of historically recorded temporal positions during a gestation period of one or more pregnant ruminants and the corresponding pregnancy indicator value in samples taken from those pregnant ruminants.

The ruminant may be a cow, sheep, goat, llama, camel or the mammal; preferably the ruminant is a cow.

The regression formula is preferably applied to pregnancy indicator values falling within a predetermined value range. The predetermined range preferably represents a period over which there is a sustained increase in the pregnancy indicator value. The predetermined range may be bound by a predetermined upper and lower value limit.

When the pregnancy indicator is estrone sulphate (ES), the lower value limit may be approximately 90 pg/mL, and the upper value limit may be approximately 320 pg/mL. Preferably, the lower values limit may be 100 pg/mL, and the upper value limit may be 300 pg/mL.

The pregnancy indicator may be a steroid or other protein associated with pregnancy selected from the group including estrone sulphate, estradiol-17β, estrone, progesterone, relaxin, activins, inhibins, follistatin and other pregnancy specific proteins. Preferably, the pregnancy indicator is estrone sulphate. The sample including the pregnancy indicator may be milk, urine, faecal matter or blood or blood derived products; preferably the sample is milk.

The regression formula, may be linear and may include the multiplication of the pregnancy indicator value by a first value and then subsequently adding a second value to determine the time elapsed of the pregnant or potentially pregnant ruminant during the gestation period. Where the pregnancy indicator is ES, the first value may be in the range of 0.1 to 0.3, and the second value may be in the range of 50 to 150; preferably 50 to 100.

The method may further include the step of averaging the estimated time elapsed derived from at least two samples taken from the ruminant. The averaging steps may include a weighted average or other transformation processes.

The method may further include the step of categorising the pregnancy status of the ruminant based on the value of the pregnancy indicator in the sample, prior to the application of the regression formula. When the pregnancy indicator is ES, the ruminant is categorised as being pregnant when the value of the pregnancy indicator is more than approximately 120 pg/mL; preferably more than approximately 150 pg/mL.

In an alternative embodiment, when the pregnancy indicator is ES, the ruminant is categorised as being pregnant when the ES value is less than approximately 120 pg/mL, and the ES value in an earlier sample is more than about 90 pg/mL, and the ES value has increased by at least about 0.1 pg/mL per day between the samples.

Alternatively when an earlier sample is obtained less than a predetermined period before a current sample, and when the ES value in that earlier sample is greater than about 100 pg/mL, and ES value has increased by at least about 0.1 pg/mL between samples, the cow may also be categorised as pregnant.

Where the ruminant is a cow, the predetermined period may be about 70 days.

In a further embodiment of this aspect of the invention, the ruminant may be characterised as not yet confirmed to be pregnant. When no earlier sample is obtained from the ruminant within the predetermined period, or where an earlier sample is taken within the predetermined period but the ES value in the earlier sample is less than about 100 pg/mL, the ruminant may be categorised as not yet confirmed to be pregnant.

In another embodiment, the ruminant may be categorised as probably pregnant. When no earlier sample is obtained from the ruminant within the predetermined period, or wherein an earlier sample is obtained within the predetermined period but the ES value in the earlier sample is more than about 100 pg/mL, the ruminant may be categorised as probably pregnant.

Alternatively, the pregnancy categorising step may include, where an earlier sample is taken within the predetermined period and the ES value in the earlier sample is greater than about 100 pg/mL, but the ES value does not increase by at least about 0.1 pg/mL per day between samples, categorising the ruminant to be probably pregnant.

The value of the pregnancy indicator may be determined by ELISA, RIA, IRMA or PCR.

The method may further include the step of qualitatively assessing the level of the pregnancy indicator value for application thereto of the regression formula.

The method may further include the step of using the estimated time elapsed within the gestation period of the ruminant to derive an estimate of the date of a gestation-related event. The gestation-related event may be one or more of the date of conception, the date of birthing and a date of milking cessation. Preferably the gestation-related event is the date of conception or the date of birthing; more preferably the date of conception.

In a further embodiment related to this aspect of the invention the method may include the step of validating the estimated date of a gestation-related event against reproductive data for that ruminant. The reproductive data may include one or more of a date of last birthing, one or more known artificial insemination dates, the period of exclusive artificial insemination, one or more known mating dates, and a nominated voluntary waiting period for the ruminant to recover from a previous pregnancy.

The validation step may include validating a gestation-related event, such as the date of conception. When the estimated conception date (ECD) is not within an exclusive artificial insemination period, and the ECD is within a predetermined period of any known mating date of the ruminant, the ECD is validated to be the closest known mating date. Where the ruminant is a cow, the predetermined period may be about 10 days.

The validation step may further include, when the ECD is not within an exclusive artificial insemination period and the ECD is not within the predetermined period of any known mating date of the ruminant, validating the ECD to be the ECD plus a safety period. Where the ruminant is a cow, the safety period may be about 7 days.

The validation step may include, when the ECD is within an exclusive artificial insemination period, and the ECD is after the last artificial insemination date and within a predetermined period of the last artificial insemination date, validating the ECD to be the last artificial insemination date. Where the ruminant is a cow, that predetermined period may be about 10 days.

The validation step may further include, when the ECD is within the exclusive artificial insemination period, and the ECD is after the last artificial insemination date and not within the predetermined period of the last artificial insemination date, validating the ECD to be the ECD.

The validation step may include, when the ECD is between two artificial insemination dates, and the artificial insemination dates are more than a predetermined period apart, validating the ECD to be the artificial insemination date closest to the ECD. Where the ruminant is a cow, that predetermined period may be about 26 days.

The validation step may include, when the ECD is between two artificial insemination dates, and the artificial insemination dates are less than the predetermined period apart, and the ECD is within a safety period of the first artificial insemination date, validating the ECD to be the first artificial insemination date. Where the ruminant is a cow, that predetermined period may be about 26 days. Similarly, the safety period may be about 7 days.

The validation step may further include, when the ECD is between two artificial insemination dates, and the artificial insemination dates are less than the predetermined period apart, and the ECD is not within the safety period of the first artificial insemination date, validating the ECD to be the second artificial insemination date.

The validation step may include, when the ECD does not fall between two artificial insemination dates, and the ECD is within a predetermined period of the first artificial insemination date, validating the ECD to be the first artificial insemination date. Where the ruminant is a cow, that predetermined period may be about 10.

The validation step may include, when the ECD does not fall between two artificial insemination dates, and the ECD is not within the predetermined period of the artificial insemination date, validating the ECD to be the ECD.

In one or more embodiments of the invention, the validation step is preferably carried out if the ruminant gave birth more than a predetermined period before the estimated conception date. The predetermined period may be either a voluntary waiting period or a fixed period, such as 30 days, which ever is the greater.

Yet another aspect of the invention provides a method for estimating the time elapsed during a gestation period of a pregnant or potentially pregnant ruminant, the method including the step of:

when a value of a pregnancy indicator in a sample taken from the ruminant exceeds a predetermined threshold, determining the estimated time elapsed of the pregnant ruminant from reproductive data for that ruminant.

Another aspect of the invention provides computer software including a series of instructions for use with a computing device, the computing device including a memory device for storing the series of instructions and a processor in communication with the memory device, the series of instructions causing the processor to generate an estimate of the time elapsed within a gestation period of a pregnant or potentially pregnant ruminant on the basis of a value of a pregnancy indicator in a sample obtained from the ruminant.

In a further aspect of the invention, there is provided a system for generating an estimate of the time elapsed within a gestation period of a pregnant or potentially pregnant ruminant on the basis of a value of a pregnancy indicator in a sample obtained from the ruminant, the system including:
memory means for storing the series of software instructions;
processor means in communication with the memory means and configured to execute the series of instructions to estimate the time elapsed of a pregnant ruminant during a gestation period on the basis of a value of a pregnancy indicator in a sample taken from the ruminant.

In one embodiment, the memory means of the system includes a database structure, said database structure being configured to store at least one or more of the following types of data:
values of a pregnancy indicator in a sample obtained from the ruminant;
historically recorded temporal positions within a gestation period of one or more pregnant ruminants and the corresponding pregnancy indicator value in samples taken from the pregnant ruminant;
historically recorded temporal positions of one or more other pregnant ruminants during a gestation period and the corresponding pregnancy indicator value in samples taken from those pregnant ruminants;
one or more parameters used in the regression formula;
date of last birthing of the ruminant;
one or more known dates of artificial insemination;
a period of exclusive use of artificial insemination;
one or more known mating dates of the ruminant;
a nominated voluntary waiting period for the ruminant to recover from a previous pregnancy.

The system may also include one or more remote terminals in data communication with a server system including the processor means and a memory means on which the database structure is stored, the remote terminal being adapted to enable entry of data into the database structure, and to query of the database to obtain data relating to the estimate of the time elapsed within the gestation period of the ruminant.

The system may also include a sample reading system for determining the value of a pregnancy indicator in the sample obtained from the ruminant

In yet another aspect of the invention, there is provided a kit for estimating the time elapsed within a gestation period of a pregnant or potentially pregnant ruminant including
a sample reading system for determining the value of a pregnancy indicator in a sample; and
computer software including a series of instructions for use with a computing device, the computing device including a memory device for storing the series of instructions and a processor in communication with the memory device, the series of instructions causing the processor to generate an estimate of the time elapsed within a gestation period of a pregnant or potentially pregnant ruminant on the basis of the value of a pregnancy indicator in a sample obtained from the ruminant.

For assistance at arriving at an understanding of the invention, examples of the method of estimating the time elapsed within a gestation period of a pregnant or potentially pregnant ruminant is illustrated in the attached drawings and exemplifications. However, as the drawings illustrate, embodiments wherein the ruminant is a cow and the pregnancy indicator is ES, their particularity is not to be understood as superseding the generality of the preceding description.

### BRIEF DESCRIPTION OF THE DRAWINGS

FIG. 1 is a graphical representation of the profile of estrone sulphate value levels in a pregnant cow during the gestation of the cow.

FIGS. 2 and 3 are schematic representations of different computer based environments for implementing a method for estimating the time elapsed within a gestation period of a pregnant or potentially pregnant ruminant in accordance with one embodiment of the present invention.

FIG. 4 is a schematic diagram of a computing device forming at least part of the computer based environments shown in FIGS. 2 and 3;

FIG. 5 is a flow chart that illustrates the step of determining the suitability of a calculated value of ES for storing and application thereto of the regression formula.

FIG. 6 is a flow chart that illustrates the step of categorising the cow as pregnant, not pregnant or probably pregnant based on the value of ES in samples, and/or the increase of ES per day between multiple samples.

FIG. 7 is a flow chart that illustrates the step of estimating the time elapsed within a gestation period of a ruminant and deriving an estimate of a date of a gestation-related event. In this case, the date is ECD.

FIG. 8 is a flow chart that illustrates the steps of validating the estimated date of a gestation-related event, being the ECD, against reproductive data for that ruminant and its herd.

FIG. 9 is a timing diagram showing the relationship of events and periods in reproductive data used during the implementation of the method for estimating the time elapsed within a gestation period of a pregnant or potentially pregnant ruminant during in accordance with one or more embodiments of the invention.

### DETAILED DESCRIPTION OF THE EMBODIMENTS

As used herein in this specification and claims, the singular forms “a”, “an” and “the” include plural referents unless the context clearly dictates otherwise.

The term “comprises” (or its grammatical variants) as used herein in this specification and claims is equivalent to the term “includes” and should not be taken as excluding the presence of other elements or features.

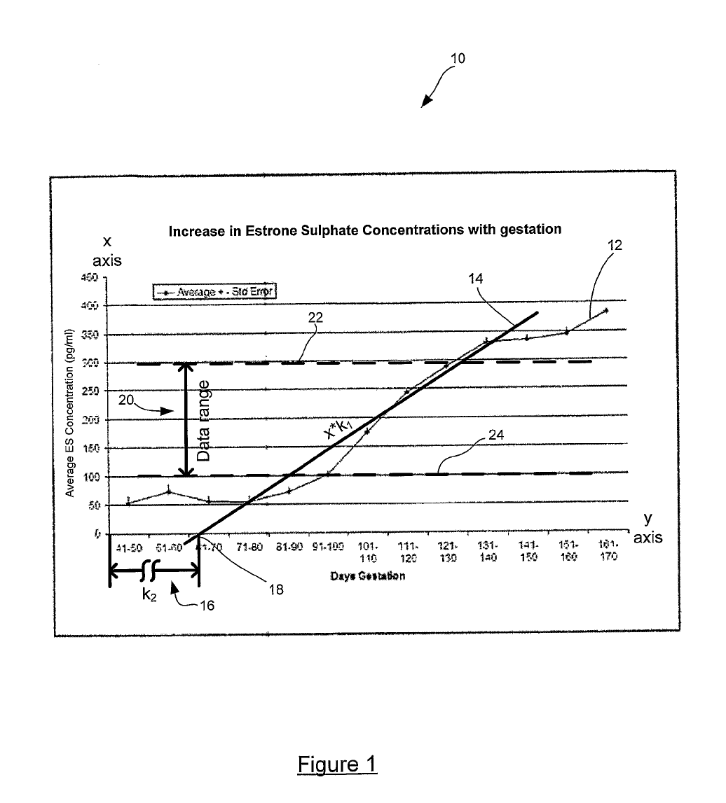

Referring now to FIG. 1 there is shown generally a graphical representation 10 of the relationship between a pregnancy indicator-Estrone Sulphate (ES)-value in milk samples taken from a pregnant cow (x axis) during the gestation of the cow (y axis). The term “gestation” as used herein in this specification and claims is the carrying of an embryo or fetus by a female. The term “pregnancy indicator” as used herein in this specification and claims means a substance, the presence of which or levels thereof are indicative of pregnancy in the animal.

The profile 12 of ES value against the days gestation has been derived by averaging the results of multiple samples from a number of different cows. Whilst in this example the steroid ES is used as a pregnancy indicator of a cow, in other embodiments the profiles of other pregnancy indicators such as a steroid or other protein associated with pregnancy selected from the group including estradiol-17 μl, estrone, progesterone, relaxin, activins, inhibins, follistatin and other pregnancy proteins may be utilised. The value of pregnancy indicators during the gestation period of the cow is typically determined from a milk sample, but may also be determined from a urine sample, faecal sample blood and blood derived products or other biological samples.

In a preferred embodiment the samples are tested within 24 hours of them having been taken. However, correctly stored samples as would be understood by the skilled person, are also suitable for use in the methods of the invention. In a preferred embodiment of the invention, the pregnancy indicator values are determined from milk that has already been collected for the purposes of determining the quantity and quality, including fat and protein content, of the milk. Any assay suited to the determination of hormones or other pregnancy indicators is suitable for use in the present invention. These assays include Enzyme Linked Immuno Sorbent Assay (ELISA), Radioimmunoassay (RIA), Immunoradiometric Assay (IRMA) and Polymerase Chain Reaction (PCR).

Whilst the specific values may change, the profile 12 shown in the graphical representation 10 of FIG. 1 is generally indicative of the change in ES values during the gestation of a cow. As can be seen from this figure, during the initial 90 to 100 days of the gestation, the ES values remains relatively stable. From 90 to 100 days gestation onwards, the ES values exhibit a sustained increase for the next 50 to 60 days before returning to stable (but elevated) levels. The applicant has determined that by applying a regression formula to an ES value from a sample taken from a pregnant cow, it is possible to derive the time elapsed (such as the number of days or weeks pregnant) of the cow during the gestation period.

From this time elapsed, it is possible to derive the estimated date of a gestation related event, such as the conception date, calving date and milking cessation date of the cow. “Milking cessation date” as used herein in this specification and claims refers to the date on which the farmer stops milking the ruminant to allow the ruminant's udder to properly prepare for the next lactation that will commence when the cow calves. Accurately determined estimations of the dates of gestation related events are highly beneficial to the effective management by farmers of their herds of cows.

One simple regression formula that can be used for determining the date of conception of the cow is a linear regression formula, represented generally by y=x*k₁+k₂, where x is the ES value in the milk sample, k₁ is a first constant value and k₂ is a second constant value. As can be seen from FIG. 1, the value of k₁ corresponds to the slope 14 of the profile 12 in that portion of the profile corresponding to the sustained temporal increase in ES value. The value k₂ defines an offset 16 between the intercept 18 of the slope 14 with the y axis and a desired gestation related event. In the example shown in FIG. 1, the desired gestation related event is the date of conception. Where the ruminant is a cow, the value of k₁ is typically in the range of 0.1 to 0.3. When determining the date of conception for a cow, the value of k₂ is typically in the range of 50 to 150 days, most typically 50 to 100 days. It will be appreciated that the value of k₂ will vary depending upon the desired gestation related event in question. It will also be appreciated that other forms of regression formula, such as polynomial regression formulas, have use in alternate embodiments of the invention.

Preferably, the regression formula is applied to pregnancy indicator values falling within a predetermined range. An exemplary range 20 is shown in FIG. 1. The range is bounded by a predetermined upper 22 and lower 24 value limits. Where the ruminant is a cow, the lower limit is approximately 90 pg/mL, and the upper limit is approximately 320 pg/mL. Preferably the range is from 100 pg/mL to 300 pg/mL. Excluding ES values that fall outside of this range from the estimation assists in improving the accuracy of the linear regression by ensuring that ES values occurring in the zone during which a sustained increase in ES values are used. However in other embodiments of the invention, the regression formula may be applied to pregnancy indicators having a minimum value but without an upper limit.

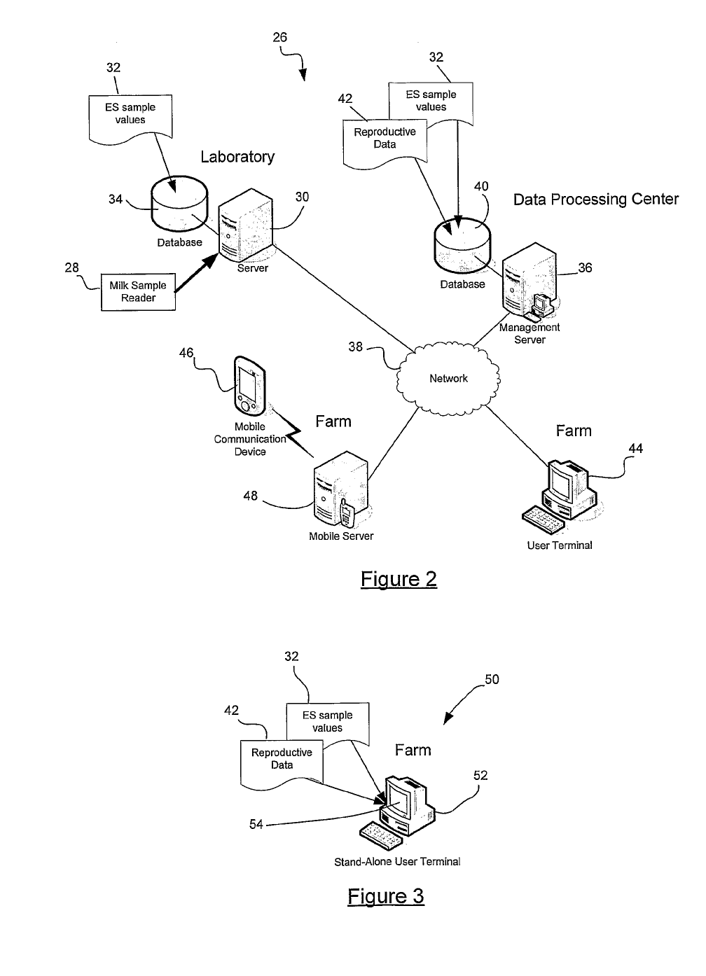

FIGS. 2 and 3 illustrate two separate computer based environments in which the method for estimating the time elapsed of a pregnant ruminant during a gestation period are implemented. It will be appreciated that these two environments are for the purposes of illustration only, and do not represent the only possible environments in which the method may be implemented. In the first computer based environment 26, ES values from one or more milk samples are read from a milk sample reader 28 and provided to a server 30 in a laboratory. The ES value 32 from each sample is maintained within a database 34 operatively connected to the server 30. The laboratory server 30 is in communication with a management server 36 within a data processing centre by means of a network 38, such as the Internet or other data communication network. The ES values 32 are communicated from the laboratory server 30 to the management server 36 for storage in a data processing centre database 40.

Reproductive data 42 is also maintained in the database 40 and includes data relating to the date of last calving, dates of artificial insemination, periods of exclusive artificial insemination, known mating dates and nominated voluntary waiting periods. The reproductive data is typically provided by a farmer, by means of a user terminal 44 or mobile communication device 46 and mobile server 48 connected to the network 38. The mobile communication device 46 or user terminal 44 may also be adapted to receive notifications and other communications from the data processing centre management server 36. In this computer based environment 26, the data processing centre uses the ES values to carry out a number of data processing operations to estimate the time elapsed within a gestation period of a pregnant ruminant. The estimated time elapsed is subsequently validated by use of the reproductive data 42. The results of the data validation are then communicated to the farmer via the user terminal 44 or mobile communication device 46.

Whilst the computer based environment 26 represents a typical distributed environment in which the method for estimating the time elapsed of a pregnant or potentially ruminant can be implemented, the estimation method can also be implemented in a stand alone environment. For example, the stand alone environment 50 shown in FIG. 3 includes a computing device 52 in which the ES values 32 and reproductive data 42 are stored. The computing device 52 performs the series of data processing operations required to carry out the estimating method and provides the results of those operations via the display 54 of the computing device.

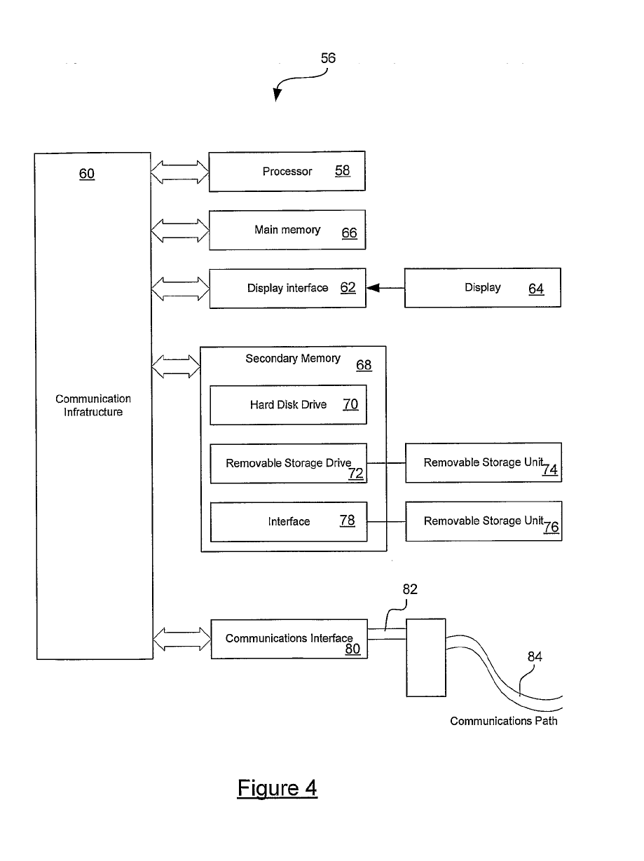

The present invention may be implemented using hardware, software or a combination thereof, and may be implemented in one or more computer systems or other processing systems, such as the exemplary computer based environments 26 and 50 shown in FIGS. 2 and 3. An example of such a computer system 56 is shown in FIG. 4. The computer system 56 includes one or more processors, such as the processor 58 connected to a communication infrastructure 60. Various software embodiments are described in terms of this exemplary computer system. It will be apparent to a person skilled in the relevant art how to implement the invention using other computer systems and/or computer architectures. The computer system 56 includes a display interface 62 for forwarding graphics, text and other data from the communication infrastructure 60 for display on the display unit 64.

The computer system 56 also includes a main memory 66, preferably random access memory, and may include a secondary memory 68. The secondary memory 68 may include, for example, a hard disk drive 70 and/or removable storage drive 72, representing a floppy disk drive, magnetic tape drive, optical disk drive etc. The removable storage drive 72 reads from and/or writes to a removable storage unit 74 in a well known manner. The removable storage unit 74 represents a floppy disk drive, magnetic tape drive, optical disk etc and is read by and written to by the removable storage drive 72. As will be appreciated, the removable storage unit 74 includes a computer useable storage medium having stored therein computer software and/or data. In alternate embodiments, the secondary memory 68 may include other similar means for allowing computer programs and other instructions to be loaded into the computer system 56. Such means may include, for example, a removable storage unit 76 and interface 78.

The computer system 56 may also include a communications interface 80 allowing software and data to be transferred between the computer system 56 and external devices. Examples of the communication interface 80 may include a modem, a network interface, a communications port, etc. Data and software transferred via the communications interface 80 are in the form of signals 82 which may be electronic, electromagnetic, optical or other signals capable of being received by the communications interface 80. These signals 82 are provided to the communications interface 80 via a communications path 84.

Computer programs (also called computer control logic) including a series of instructions are stored in the main memory 66 and/or secondary memories 68. Computer programs may be received via communications interface 80. Such computer programs, when executed, enable the computer system 56 to perform the features of the present invention as described herein. In particular, the series of instructions comprising the computer programs or software, when executed, enable the processor 58 to perform the features of the present invention. Accordingly, such computer programs represent controllers of the computer system 56.

In an embodiment where the invention is implemented using software, the software may be stored in a computer program product and loaded into computer system 56 using removable storage drive 72, hard disk drive 70 or communications interface 80. The control logic (software), when executed by the processor 58, causes the processor 58 to perform the functions of the invention as described herein. In other embodiments, the invention is implemented primarily in hardware using, for example, hardware components such as an Application Specific Integrated Circuit (ASIC). Implementations of the hardware state machine so as to perform the functions described herein will be apparent to persons skilled in the relevant art. In yet another embodiment, the invention may be implemented by using a combination of both hardware and software.

In another aspect of the invention, there is provided a kit suitable for use in the methods of the invention. The kit may include a sample reading system for calculating the value of a pregnancy indicator in a sample, together with computer software which, when executed, enable a computer system to perform the estimation of the time elapsed within a gestation period of a pregnant or potentially pregnant ruminant.

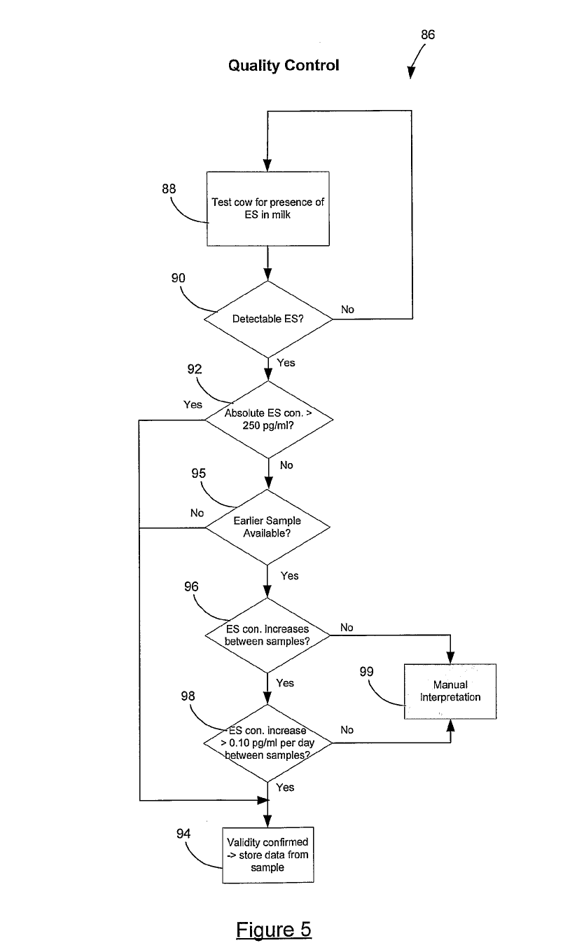

FIGS. 5 to 8 illustrate the logic carried out by the computer based environments 26 and 50 under the control of the computer software described here above, in order to carry out the estimating method of the present invention. Cows are routinely tested for the presence of hormones or other pregnancy indicators that change during pregnancy in blood and blood derived products, milk, faecal or urine samples. In an alternate embodiment, one or more of steps of FIGS. 5-8 may be carried out manually, where possible, using the same logic.

FIG. 5 illustrates a sample quality control process 86 that may optionally be undertaken, wherein the ES value in the sample is determined at step 88 and the suitability of the sample data to be stored and used in the method of the invention is confirmed. The process is typically, but not necessarily, carried out at the laboratory to which the milk or other samples are provided.

The milk or other sample is analysed for the presence and value of the pregnancy indicator, preferably ES, at step 88. Samples with erroneous negative test results being samples with undetectable ES, may optionally be designated at step 90 to be retested to confirm the result and reduce the incidence of false negative results. At step 92, a determination is made. Samples having an ES value of 250 pg/mL or more are confirmed as suitable and the data is stored at step 94 in the sample data 32 maintained in the database 34.

If the absolute ES value is less than 250 pg/mL, and an analysis from an earlier sample is available, the value is compared against the data of an earlier sample at step 95 from the same cow that has been maintained in the database 34. If it is determined at step 96 that there has been an increase in the value of ES between the samples, and further determined at step 98 that the increase is at least 0.10 pg/mL of ES per day between the two samples, the validity of the subsequent sample is confirmed at step 94 and the data is stored in the database 34.

If there is no earlier sample 95, then the data is also stored in the database 34 as a sample against which subsequent samples from that cow may be compared.

If there has not been an increase between two samples 96, or the increase is not at least 0.1 pg ES per day between two samples 98, the results are manually interpreted at step 99, as to whether they should be stored in the database 34 or not, particularly if they are only just outside the desired ranges or values.

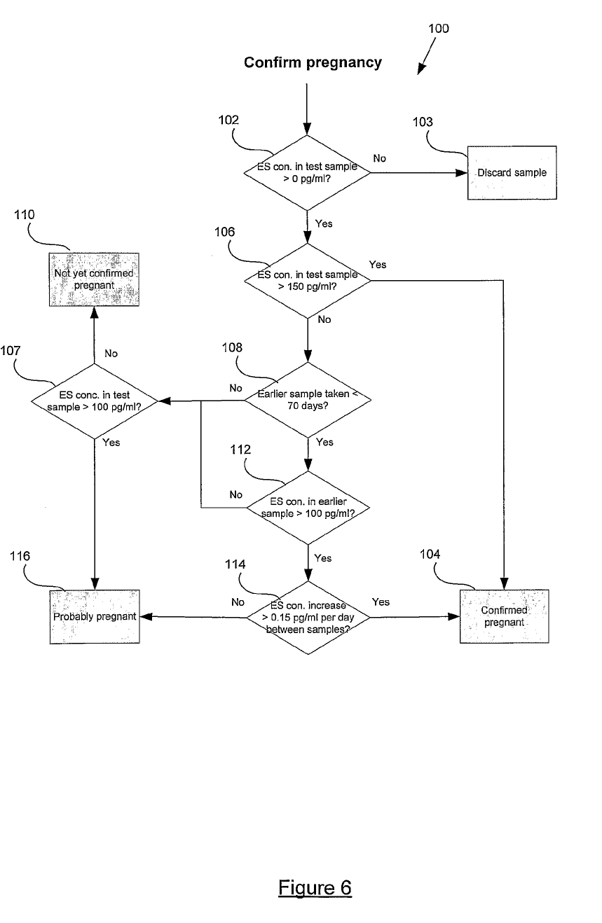

An additional optional step is illustrated in FIG. 6 wherein the pregnancy status of the cow is categorised as either pregnant, probably pregnant or not yet confirmed pregnant.

If a sample has not previously been assessed in the quality control process of FIG. 5, then any sample at step 102 for which there is no detectable ES is discarded at step 103. Otherwise, a determination is made at step 106. If a test sample has an ES value more than about 150 pg/mL the pregnancy status of the cow from which the sample was taken is equated at step 104 to be “confirmed pregnant”.

If the test sample is less than about 150 pg/mL, a determination is made at step 108 as to whether an earlier sample has been taken. If not, a determination is made at step 107 based on the ES value of the test sample. If the ES value in the sample is less than approximately 100 pg/mL, the pregnancy status of the cow is equated at step 110 to be “not yet confirmed pregnant”. If the ES value in the sample is more than approximately 100 pg/mL, then the pregnancy status of the cow is equated at step 116 to be “probably pregnant”.

If there is an earlier sample, preferably the earlier example was taken within a predetermined period, such as 70 days. If it is determined at step 112 that the ES value in the earlier sample was more than approximately 100 pg/mL, and it was further determined at step 114 that the ES value increased by at least about 0.10 pg/mL/day between samples, preferably at least 0.15 pg/mL, then the pregnancy status of the cow is equated at step 104 to be “confirmed pregnant”. If the earlier sample was less than approximately 100 pg/mL but the later test sample was in the range of 100-150 pg/mL, or if the increase in the ES value was not at least 0.10 pg/mL/day between the two samples, the pregnancy status of the cow is equated at step 116 to be “probably pregnant”.

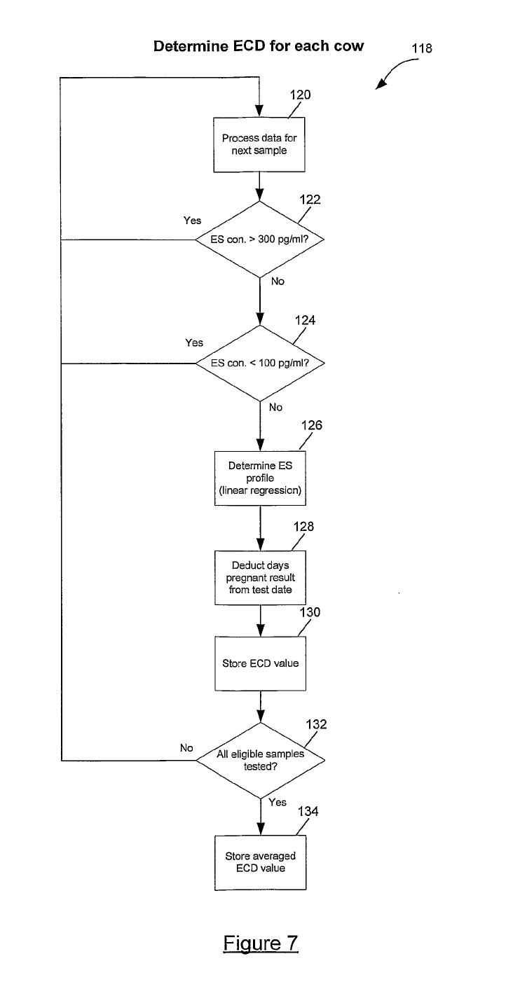

The time elapsed of a pregnant or probably pregnant cow during a gestation period is estimated and used to derive the date of a gestation-related event in the process 118 shown in FIG. 7, optionally using sample data that has been subjected to either or both of the processes illustrated in FIGS. 5 and 6. In this exemplary process, the gestation-related event is the conception date for each cow. It will be appreciated that in other embodiments of the invention, other gestation related events, such as the date of calving or milking cessation date for the cow may be determined. In yet other embodiments of the invention, the time elapsed of the pregnant cow during a gestation period, may be determined without necessarily relating this information to a gestation related event.

Accordingly, data from the ES sample data 32 for each sample is analysed at step 120. If the ES value for that sample is determined at step 122 to be greater than the upper value limit 22 shown in FIG. 1 (in this example 300 pg/mL), or determined at step 124 that the ES value for that sample is below the lower value limit 24 shown in FIG. 1 (in this example 100 pg/mL) then the sample data is rejected for the purpose of dating and data for the next sample is retrieved. However, if the ES value falls between the upper and lower value limits, then at step 126, a regression formula is applied to the ES value in order to determine an estimate of how far advanced the cow is during the gestation period.

In this example, a linear regression formula is applied. The number of days that the cow is advanced during a gestation period is determined by applying the formula y=x*k₁+k₂, where k₁ corresponds to an estimated daily increase in ES value between the upper and lower value limits 22 and 24 on the historically recorded profile shown in FIG. 1. A exemplary value of the constant k₁ is 0.1282, in conjunction with an exemplary value of the constant k₂ of 86.133. The Applicants have found that, depending upon the historically recorded ES profile in question, k₁ may have values of between 0.1 to 0.3, whilst the value of the constant k₂ may typically be between 50 to 150, most typically 50 to 100. It will be appreciated however that the type of regression formula applied and the values of the constants used in those regression formulae will be dependent upon the historically recorded ES profile, or the profile of any other suitable pregnancy indicator, that has been developed for a particular herd, breed or type of ruminant.

At step 128, the number of days pregnant, as determined in step 126, is then deducted from the date at which the particular sample in question was collected in order to derive an ECD for each cow. Similarly, in an alternative embodiment it would be appreciated that a similar forward calculation could be done to derive an estimated calving date for example, knowing the length of cow's gestation to be 282 days. At step 130, the ECD is stored in the database 40. It may be that multiple eligible samples exist for each cow. If this is determined to be the case at step 132, then each of the stored ECD values may be averaged at step 134 in order to improve the accuracy of the stored ECD value.

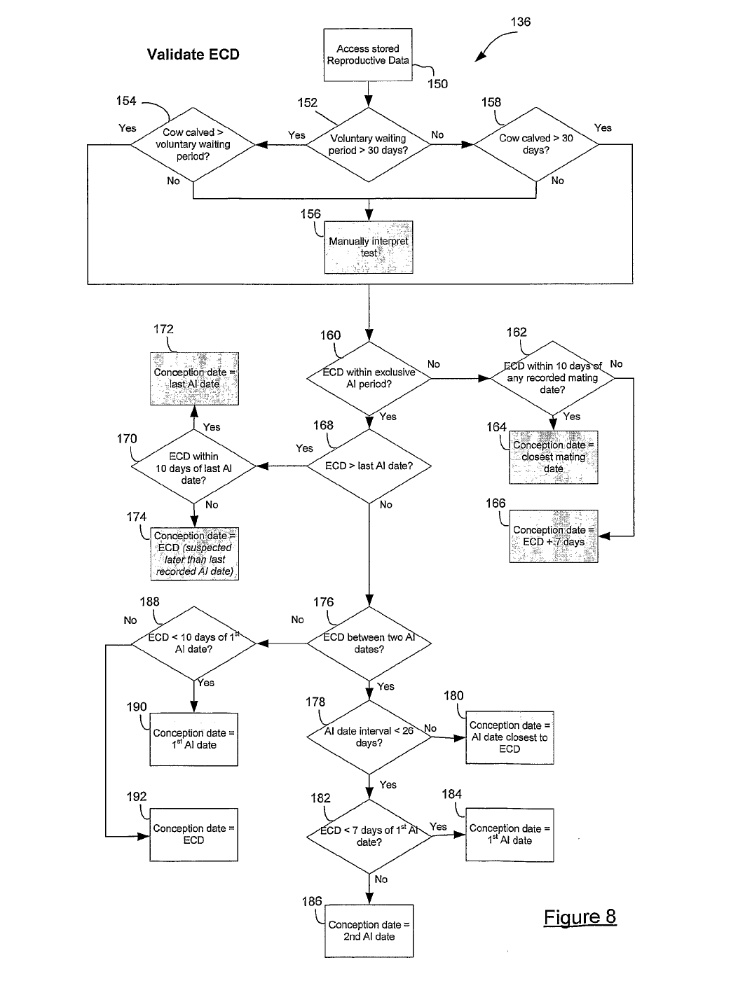

The ECD value determined by the process 118 may be validated in the process 136 shown in FIG. 8. This step is particularly preferable for ECDs determined with the assistance of a regression formula that was applied to sample data that did not have an upper limit to the value.

This validation process relies upon reproductive data, typically provided by the farmer to the management server 36, such as a date of last calving of each cow, one or more dates of artificial insemination, for the cow and the herd as a whole, a period of exclusive use of artificial insemination, one or more known mating dates for each cow and a nominated voluntary waiting period for the cow to recover from a previous pregnancy. The validation process 136 shown in FIG. 8 uses the reproductive data provided by the farmer for example to make some adjustments to the ECD value calculated by the management server 36.

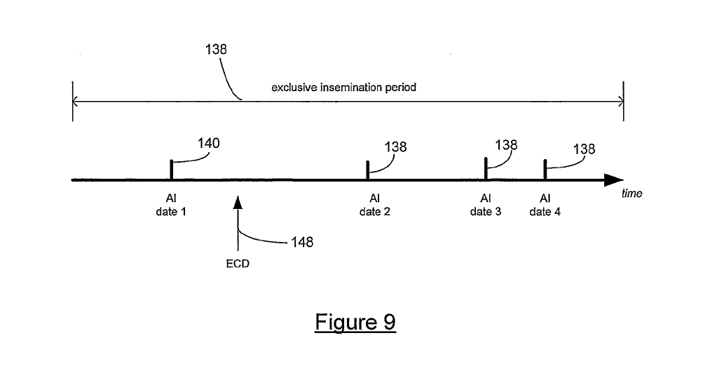

FIG. 9 illustrates an example of the nature of exclusive use of artificial insemination reproductive data. For example, during an exclusive artificial insemination period 138, it may be that each cow was artificially inseminated at known artificial insemination dates 140 to 146 and that the ECD falls on or between one of these dates. It may also be that the ECD value determined by the process 118 illustrated in FIG. 7 results in a value that does not correspond to any of the artificial insemination dates. Accordingly, at step 150, the reproductive data 42 is accessed.

In order to more accurately validate the ECD with reproductive data, the ECD cannot be accurate when too close to the date of a previous calving, as the pregnancy indicator levels may still be artificially high from the previous pregnancy. The process therefore includes steps 152 to 158 to check that the cow has either calved more than 30 days from the ECD, or more than the voluntary waiting period (that a farmer nominates as the number of days before a cow is to be either mated or artificially inseminated post-calving), whichever is greater. If a sample is available from a cow that does not satisfy these time periods, then the ECD determined in the process illustrated in FIG. 7 has to be manually interpreted.

For example, if the voluntary waiting period at step 152 is 32 days, and a determination is made at step 154 that the cow calved more than 32 days ago, then the process 136 to validate the ECD may be carried out. If the cow only calved 30 days ago, then the ECD determined by the process needs to be manually interpreted at step 156. This may be required particularly when sample data from a cow has not been through the process illustrated in FIG. 6 to confirm pregnancy, yet has an ES value that equates to a possibly pregnancy and has had an ECD determined.

When interpreting data manually, confirmation as to the accuracy of the dates provided by the farmer will either categorise the cow as not being pregnant and therefore ignoring the data, or indicate that an unplanned event has occurred that the farmer is not aware of, such as a bull having access to the cow. Similarly, if the voluntary waiting period at step 152 is 28 days, and a determination is made at step 158 that the cow calved more than 28 days ago, then the process 136 to validate the ECD may be carried out. If the cow only calved 26 days ago, then the ECD needs to be manually interpreted at step 156.

If however, the cow has not calved too recently, then the validation and possible adjustment of the ECD value may be carried out. Initially, at step 160, an assessment is made as to whether the ECD value occurred within a period of exclusive artificial insemination, 138. If this was not the case, then an assessment is made at step 162 as to whether the ECD value was within a predetermined period, such as 10 days, of any mating date recorded in the reproductive data 42. If this was the case, then the ECD is validated at step 164 to be the closest recorded mating date. Otherwise, the ECD of the cow is validated at step 166 to be the ECD value plus a safety period of, for example, about 7 days.

If the ECD value is within the exclusive artificial insemination period 138, then at step 168, a determination is made as to whether the ECD value was after the last artificial insemination date in the recorded reproductive data 42. If this is the case, then another determination is made at step 170 as to whether the ECD was within a predetermined period such as 14 days of that last artificial insemination date. If this is the case, then at step 172 the ECD of the cow is validated to be the last artificial insemination date. Otherwise, the ECD is validated at step 174 to be the ECD value. However, in this latter case, the farmer is alerted to the fact that the reliability of the ECD is not high and there is a strong possibility that the conception date may be after the last recorded artificial insemination date.

If it is determined at step 176 that the ECD value was between two artificial insemination dates, then a determination is made at step 178 as to whether the interval between the two artificial insemination dates was less than a predetermined period, such as 26 days. If this is not the case, then the ECD is validated at step 180 to correspond to the artificial insemination date closest to the ECD value. Otherwise, a further determination is made at step 182 as to whether the ECD value was within a predetermined period, such as seven days of the first artificial insemination date. If so, then the ECD is validated at step 184 to be the first artificial insemination date. Otherwise, the ECD is validated at step 186 to correspond to the second artificial insemination date.

If the ECD value is not between two recorded artificial insemination dates, as determined by step 176, then a determination is made at step 188 as to whether the ECD value is within a predetermined period, such as 10 days, from the first artificial insemination date. If so, then the ECD is validated at step 190 to correspond to the first artificial insemination date. Otherwise, the ECD is validated at step 192 to correspond to the ECD value.

Each of the ECDs, as determined in steps 172, 164, 166, 174, 190, 192, 180, 184 and 186 may be notified to the farmer via the user terminal 44, mobile communication device 46 or display 54 of the computing device 52.

Finally, it is to be understood that various modifications and/or additions may be made to the above described method and system without departing from the spirit or ambit of the present invention. For example, in some instances, the farmer may wish to rely upon the reproductive data to determine the estimated time elapsed within the gestation period of the pregnant or potentially pregnant ruminant rather than using the regression formula described here above. In such cases, the time elapsed of the pregnant ruminant may be confirmed by determining that the ES value in a sample from the pregnant ruminant exceeds a predetermined threshold, such as the predetermined lower value limit. Having categorised the pregnant state of the ruminants on this basis, the reproductive data gathered by the farmer, including known mating dates, may be used to determine the estimated time elapsed of the ruminant during the gestation period.

### Example 1

A small scale trial of 180 cows was undertaken to assess the sensitivity and specificity and therefore suitability of the ES assay to be utilised in the present invention (Table 1). “Sensitivity” is defined to be the number of cows determined by the test to be pregnant compared to the “gold standard” manual pregnancy diagnosis. “Specificity” is defined to be the number of cows determined by the test to not be pregnant compared to manual pregnancy diagnosis.

TABLE 1

| | Milk ES assay | Manual Veterinary |
|---|---|---|
| | pregnancy test | pregnancy test |
| Pregnant | 104 | 103 |
| Not pregnant | 76 | 77 |
| TOTAL | 180 | 180 |
| False Positive* | 1 | 0 |
| False Negative | 0 | 0 |
| Sensitivity | 100% | 100% |
| Specificity | 99% | 100% |

*Assumption - veterinary diagnosis is correct one

180 cows, all of which would have been more than 120 days pregnant if they were pregnant, had 3 milk samples tested for ES. Of the 103 cows determined to be pregnant by manual pregnancy diagnosis, the ES results also indicated that all 103 cows were pregnant, i.e., 100% sensitivity. Of the 77 not detectably pregnant by manual methods, the ES results only indicated that one of those cows was pregnant, i.e., 98.7% specificity.

### Example 2

A further larger scale trial on 593 cows confirmed the initial findings that an assay to detect a pregnancy specific indicator such as ES is a suitable assay for utilisation in the present invention (Table 2).

TABLE 2

| | | Estrone sulphate result | | | | |
|---|---|---|---|---|---|---|
| | | | Not confirmed | Probably | Confirmed | |
| Manual Result | | | pregnant | pregnant | Pregnant | |
| | Total | No diagnosis | (<100 pg/ml) | (100-150 pg/ml) | (>150 pg/ml) | Total |
| Pregnant | 593 | 1 | 16* | 14\hat{ } | 562 | 593 |
| Not | 115 | 1 | 88 | 17 | 9** | 115 |
| Detectably | | | | | | |
| Pregnant | | | | | | |
| | | 2 | 104 | 31 | 571 | 708 |
| Total | 708 | | | | | |

*only 8 > 120 days
\hat{ }only 4 > 120 days

Manual palpitation/ultrasound concluded 593 cows tested were pregnant and 115 cows were not. Of the 593 cows concluded to be pregnant, the ES assay results indicated that 16 were not pregnant; 14 were probably pregnant; and 462 were pregnant. It was not possible to get a result on one sample.

Of the 115 cows concluded not be pregnant, the ES assay results indicated that 88 were not pregnant; 17 were probably pregnant; and 9 were pregnant. It was not possible to get a result on one sample.

The ES assay results therefore were in 97% agreement (576 out of 593 cows) with the manual test as to how many cows were pregnant or probably pregnant. The ES assay results however were only in 90% agreement (104 out of 115 cows) with the manual test as to how many cows were not pregnant.

Once calving data became available however, the sensitivity and specificity of the ES assay was shown to be better than predicted when only compared to the manual test. For example, of 9 cows that were manually determined to be not pregnant, at least 4 of them all went on to calve. The status of the other 5 cows was not available as they had been sold on.

### Example 3

A further trial was conducted on 200 cows known to not be pregnant or very early pregnant to further assess the specificity of ES testing. That is, to assess whether determining the value of ES from a sample is an accurate means of correctly categorising cows as not pregnant.

Based on a cut-off level of 150 pg/mL of ES as being indicative of pregnancy, the accuracy of the ES assay in diagnosing non-pregnant cows was 99.5%, being 199 cows out of 200 correctly categorised as not confirmed pregnant (Table 3).

TABLE 3

| Levels of ES (pg/mL) | No. of cows |
|---|---|
| 0-20 | 136 |
| 21-60 | 37 |
| 61-100 | 23 |
| 101-140 | 2 |
| 141-150 | 1 (150 pg/ml) |
| Over 150 | 0 |
| TOTAL | 199 |

### Example 4

The following examples include data collected from 513 cows (out of 708 enrolled) that had a calving date to confirm the estimated date obtained by practicing the current invention.

A summary of the accuracy of the estimates using the methodologies of the invention (1) and manual methods (2) is provided below (Table 4).

TABLE 4

| i. | ES and formula estimation | Total | | |
|---|---|---|---|---|
| | Estimation OK | 442 | 86% | |
| | Estimation too early (1 cycle) | 20 | 4% | |
| | Estimation too early (intermediate) | 10 | 2% | |
| | Estimation too early (2 cycles) | 6 | 1% | ≈7% |
| | Estimation Late (1 cycle) | 5 | 1% | |
| | Estimation Late (Intermediate) | 6 | 1% | |
| | Estimation Late (2+ cycles) | 13 | 3% | ≈5% |
| | Pregnant but unable to date | 11 | 2% | |
| | Total | 513 | | |
| ii. | Manual Estimation | Total | | |
| | Estimation OK | 410 | 80% | |
| | Estimation too early (1 cycle) | 20 | 4% | |
| | Estimation too early (intermediate) | 10 | 2% | |
| | Estimation too early (2+ cycles) | 6 | 1% | ≈7% |
| | Estimation late (1 cycle) | 16 | 3% | |
| | Estimation late (intermediate) | 6 | 1% | |
| | Estimation late (2+ cycles) | 4 | 1% | ≈5% |
| | Mis-diagnosis as empty | 41 | 8% | |
| | Total | 513 | | |

The ECDs are categorised as being “OK”, early or late. When the ECD is early or late, how early or late is classified in relation to the cow's estrous cycle, which is typically 21 days.

A more detailed summary of the differences between the ECDs determined by the methods of the invention compared with the manual method is provided in Table 2. The “Expected conception date” is based on the actual calving date i.e., 282 days earlier (the standard gestation period for a cow). The ECDs derived from the manual method (Manual ECD) and the method of the invention (ES ECD), and the difference between the two dates is also shown. For example, the manual ECD for cow 90 was 36 days earlier i.e., −36 than the expected conception date; in contrast the ES ECD was 4 days later i.e., +4 than the expected date.

The “Code” column indicates a qualifying comment relevant to the ES ECDs. The codes are:
A: Additional quality control check: too great an increase in ES value from the 1st to the 2nd sample to be a suitable sample for use in the method.
B: Sample was too high to be able to date, so presume last mating date was day of conception.
C: Mistake in dating from the logic.
D: Additional logic: where an estimate suggests a bull mating but a sample is also taken “off scale” then the estimate should be overruled in favour of the last known mating date.
E: Estimated date corrected to last known mating date as the estimate is too close to the last day of A1.

F: Late pregnancy estimate, so estimated month rather than date.

TABLE 5

| | | Analysis of conception date | | | | | |
|---|---|---|---|---|---|---|---|
| | | Expected | | | | | |
| | Calving | conception | Manual | | | Difference (days) | |
| Cow # | Date | date | ECD | ES ECD | Code | Manual | ES |
| 517 | 10/09/06 | 2/12/05 | 11/10/05 | 02/12/05 | | −52 | 0 |
| 63 | 6/10/06 | 28/12/05 | 22/11/05 | 6/12/05 | E | −36 | −22 |
| 84 | 20/10/06 | 11/01/06 | 6/12/05 | 1/01/06 | F | −36 | −10 |
| 90 | 6/10/06 | 28/12/05 | 22/11/05 | 1/01/06 | | −36 | 4 |
| 134 | 6/10/06 | 28/12/05 | 22/11/05 | 8/01/06 | | −36 | 11 |
| 93 | 19/10/06 | 10/01/06 | 6/12/05 | 1/01/06 | F | −35 | −9 |
| 433 | 29/09/06 | 21/12/05 | 17/11/05 | 28/11/05 | E | −34 | −23 |
| 217 | 5/10/06 | 27/12/05 | 24/11/05 | 19/12/05 | | −33 | −8 |
| 77 | 1/10/06 | 23/12/05 | 22/11/05 | 20/11/05 | E | −31 | −33 |
| 716 | 2/10/06 | 24/12/05 | 23/11/05 | 12/12/05 | | −31 | −12 |
| 120 | 7/10/06 | 29/12/05 | 29/11/05 | 26/11/05 | E | −30 | −33 |
| 791 | 23/09/06 | 15/12/05 | 16/11/05 | 18/11/05 | E | −29 | −27 |
| 687 | 20/09/06 | 12/12/05 | 15/11/05 | 17/11/05 | B | −27 | −25 |
| 105 | 27/09/06 | 19/12/05 | 22/11/05 | | A | −27 | |
| 796 | 4/10/06 | 26/12/05 | 30/11/05 | 28/11/05 | E | −26 | −28 |
| 80 | 3/10/06 | 25/12/05 | 29/11/05 | 6/12/05 | | −26 | −19 |
| 764 | 26/09/06 | 18/12/05 | 23/11/05 | 25/11/05 | E | −25 | −23 |
| 765 | 26/09/06 | 18/12/05 | 23/11/05 | 13/12/05 | | −25 | −5 |
| 115 | 8/10/06 | 30/12/05 | 6/12/05 | 1/01/06 | F | −24 | 2 |
| 460 | 17/09/06 | 9/12/05 | 15/11/05 | 23/12/05 | | −24 | 14 |
| 497 | 5/10/06 | 27/12/05 | 4/12/05 | 17/11/05 | B | −23 | −40 |
| 457 | 22/09/06 | 14/12/05 | 21/11/05 | 18/11/05 | B | −23 | −26 |
| 740 | 17/09/06 | 9/12/05 | 16/11/05 | 13/12/05 | | −23 | 4 |
| 426 | 2/10/06 | 24/12/05 | 1/12/05 | 29/12/05 | | −23 | 5 |
| 132 | 6/10/06 | 28/12/05 | 6/12/05 | 14/12/05 | | −22 | −14 |
| 723 | 30/09/06 | 22/12/05 | 30/11/05 | 12/12/05 | B | −22 | −10 |
| 793 | 21/09/06 | 13/12/05 | 23/11/05 | 20/11/05 | | −20 | −23 |
| 795 | 14/09/06 | 6/12/05 | 16/11/05 | 12/12/05 | B | −20 | 6 |
| 480 | 18/09/06 | 10/12/05 | 21/11/05 | 21/01/06 | | −19 | 42 |
| 571 | 18/09/06 | 10/12/05 | 22/11/05 | 21/11/05 | B | −18 | −19 |
| 127 | 16/10/06 | 7/01/06 | 20/12/05 | | A | −18 | |
| 559 | 8/10/06 | 30/12/05 | 13/12/05 | 12/01/06 | | −17 | 13 |
| 562 | 7/10/06 | 29/12/05 | 13/12/05 | 22/11/05 | E | −16 | −37 |
| 798 | 24/09/06 | 16/12/05 | 30/11/05 | 2/01/06 | A | −16 | 17 |
| 71 | 9/09/06 | 1/12/05 | 15/11/05 | 29/01/06 | | −16 | 59 |
| 372 | 25/09/06 | 17/12/05 | 1/12/05 | | A | −16 | |
| 772 | 9/09/06 | 1/12/05 | 16/11/05 | 19/11/05 | B | −15 | −12 |
| 124 | 15/09/06 | 7/12/05 | 22/11/05 | | A | −15 | |
| 102 | 5/10/06 | 27/12/05 | 13/12/05 | 1/01/06 | F | −14 | 5 |
| 510 | 6/09/06 | 28/11/05 | 15/11/05 | 21/11/05 | | −13 | −7 |
| 59 | 11/10/06 | 2/01/06 | 20/12/05 | 1/01/06 | F | −13 | −1 |
| 487 | 26/08/06 | 17/11/05 | 4/11/05 | 22/11/05 | | −13 | 5 |
| 807 | 24/08/06 | 15/11/05 | 2/11/05 | 24/11/05 | B | −13 | 9 |
| 461 | 17/09/06 | 9/12/05 | 27/11/05 | 21/11/05 | B | −12 | −18 |
| 778 | 6/09/06 | 28/11/05 | 16/11/05 | 18/11/05 | B | −12 | −10 |
| 508 | 5/09/06 | 27/11/05 | 15/11/05 | 21/11/05 | B | −12 | −6 |
| 492 | 4/09/06 | 26/11/05 | 14/11/05 | 21/11/05 | B | −12 | −5 |
| 109 | 12/09/06 | 4/12/05 | 22/11/05 | 1/01/06 | F | −12 | 28 |
| 410 | 6/09/06 | 28/11/05 | 17/11/05 | 18/11/05 | | −11 | −10 |
| 337 | 15/09/06 | 7/12/05 | 26/11/05 | 27/11/05 | | −11 | −10 |
| 484 | 9/09/06 | 1/12/05 | 20/11/05 | 21/11/05 | B | −11 | −10 |
| 810 | 19/09/06 | 11/12/05 | 30/11/05 | 13/12/05 | B | −11 | 2 |
| 379 | 27/09/06 | 19/12/05 | 8/12/05 | 8/01/06 | | −11 | 20 |
| 408 | 4/10/06 | 26/12/05 | 15/12/05 | | A | −11 | |
| 502 | 1/10/06 | 23/12/05 | 13/12/05 | 21/11/05 | E | −10 | −32 |
| 347 | 14/09/06 | 6/12/05 | 26/11/05 | 27/11/05 | | −10 | −9 |
| 737 | 18/09/06 | 10/12/05 | 30/11/05 | 13/12/05 | | −10 | 3 |
| 425 | 2/10/06 | 24/12/05 | 15/12/05 | 25/11/05 | E | −9 | −29 |
| 269 | 11/09/06 | 3/12/05 | 24/11/05 | 22/11/05 | B | −9 | −11 |
| 368 | 4/09/06 | 26/11/05 | 17/11/05 | 17/11/05 | B | −9 | −9 |
| 362 | 13/09/06 | 5/12/05 | 26/11/05 | 27/11/05 | | −9 | −8 |
| 67 | 7/10/06 | 29/12/05 | 20/12/05 | | A | −9 | |
| 302 | 1/10/06 | 23/12/05 | 15/12/05 | 18/11/05 | B | −8 | −35 |
| 288 | 10/09/06 | 2/12/05 | 24/11/05 | 23/11/05 | B | −8 | −9 |
| 311 | 12/09/06 | 4/12/05 | 26/11/05 | 27/11/05 | | −8 | −7 |
| 112 | 8/09/06 | 30/11/05 | 22/11/05 | 23/11/05 | | −8 | −7 |
| 450 | 3/09/06 | 25/11/05 | 17/11/05 | 18/11/05 | | −8 | −7 |
| 320 | 12/09/06 | 4/12/05 | 26/11/05 | 27/11/05 | B | −8 | −7 |
| 661 | 1/09/06 | 23/11/05 | 15/11/05 | 21/11/05 | | −8 | −2 |
| 135 | 1/09/06 | 23/11/05 | 15/11/05 | 21/11/05 | D | −8 | −2 |
| 441 | 17/09/06 | 9/12/05 | 1/12/05 | 1/01/06 | F | −8 | 23 |
| 453 | 5/09/06 | 27/11/05 | 20/11/05 | 21/11/05 | B | −7 | −6 |
| 705 | 7/09/06 | 29/11/05 | 22/11/05 | 23/11/05 | B | −7 | −6 |
| 324 | 11/09/06 | 3/12/05 | 26/11/05 | 27/11/05 | A | −7 | −6 |
| 125 | 19/10/06 | 10/01/06 | 3/01/06 | | A | −7 | |
| 123 | 12/10/06 | 3/01/06 | 27/12/05 | | A | −7 | |
| 676 | 6/09/06 | 28/11/05 | 22/11/05 | 21/11/05 | B | −6 | −7 |
| 237 | 8/09/06 | 30/11/05 | 24/11/05 | 23/11/05 | B | −6 | −7 |
| 246 | 8/09/06 | 30/11/05 | 24/11/05 | 23/11/05 | B | −6 | −7 |
| 755 | 7/09/06 | 29/11/05 | 23/11/05 | 23/11/05 | B | −6 | −6 |
| 381 | 1/09/06 | 23/11/05 | 17/11/05 | 18/11/05 | B | −6 | −5 |
| 430 | 1/09/06 | 23/11/05 | 17/11/05 | 18/11/05 | B | −6 | −5 |
| 36 | 6/09/06 | 28/11/05 | 22/11/05 | 23/11/05 | B | −6 | −5 |
| 330 | 11/09/06 | 3/12/05 | 27/11/05 | 28/11/05 | B | −6 | −5 |
| 387 | 15/09/06 | 7/12/05 | 1/12/05 | 3/12/05 | | −6 | −4 |
| 554 | 30/08/06 | 21/11/05 | 15/11/05 | 17/11/05 | B | −6 | −4 |
| 713 | 30/08/06 | 21/11/05 | 15/11/05 | 17/11/05 | B | −6 | −4 |
| 385 | 1/09/06 | 23/11/05 | 17/11/05 | 19/11/05 | B | −6 | −4 |
| 483 | 29/08/06 | 20/11/05 | 14/11/05 | 17/11/05 | B | −6 | −3 |
| 133 | 4/10/06 | 26/12/05 | 20/12/05 | 1/01/06 | F | −6 | 6 |
| 495 | 4/10/06 | 26/12/05 | 20/12/05 | 1/01/06 | | −6 | 6 |
| 45 | 5/09/06 | 27/11/05 | 22/11/05 | 19/11/05 | B | −5 | −8 |
| 527 | 6/09/06 | 28/11/05 | 23/11/05 | 22/11/05 | | −5 | −6 |
| 572 | 5/09/06 | 27/11/05 | 22/11/05 | 21/11/05 | B | −5 | −6 |
| 466 | 4/09/06 | 26/11/05 | 21/11/05 | 22/11/05 | | −5 | −4 |
| 39 | 5/09/06 | 27/11/05 | 22/11/05 | 23/11/05 | | −5 | −4 |
| 307 | 9/09/06 | 1/12/05 | 26/11/05 | 27/11/05 | | −5 | −4 |
| 400 | 31/08/06 | 22/11/05 | 17/11/05 | 18/11/05 | B | −5 | −4 |
| 821 | 30/08/06 | 21/11/05 | 16/11/05 | 18/11/05 | | −5 | −3 |
| 506 | 29/08/06 | 20/11/05 | 15/11/05 | 17/11/05 | B | −5 | −3 |
| 730 | 30/08/06 | 21/11/05 | 16/11/05 | 19/11/05 | B | −5 | −2 |
| 596 | 6/09/06 | 28/11/05 | 23/11/05 | 26/11/05 | B | −5 | −2 |
| 568 | 3/10/06 | 25/12/05 | 20/12/05 | 4/01/06 | | −5 | 10 |
| 72 | 10/10/06 | 1/01/06 | 27/12/05 | | A | −5 | |
| 615 | 25/09/06 | 17/12/05 | 13/12/05 | 21/11/05 | E | −4 | −26 |
| 22 | 17/10/06 | 8/01/06 | 4/01/06 | 15/12/05 | | −4 | −24 |
| 272 | 6/09/06 | 28/11/05 | 24/11/05 | 22/11/05 | B | −4 | −6 |
| 234 | 6/09/06 | 28/11/05 | 24/11/05 | 23/11/05 | B | −4 | −5 |
| 481 | 4/09/06 | 26/11/05 | 22/11/05 | 22/11/05 | | −4 | −4 |
| 358 | 8/09/06 | 30/11/05 | 26/11/05 | 27/11/05 | | −4 | −3 |
| 359 | 8/09/06 | 30/11/05 | 26/11/05 | 27/11/05 | | −4 | −3 |
| 526 | 4/09/06 | 26/11/05 | 22/11/05 | 23/11/05 | B | −4 | −3 |
| 318 | 8/09/06 | 30/11/05 | 26/11/05 | 27/11/05 | B | −4 | −3 |
| 336 | 8/09/06 | 30/11/05 | 26/11/05 | 27/11/05 | B | −4 | −3 |
| 334 | 8/09/06 | 30/11/05 | 26/11/05 | 27/11/05 | A | −4 | −3 |
| 447 | 13/09/06 | 5/12/05 | 1/12/05 | 4/12/05 | | −4 | −1 |
| 456 | 26/08/06 | 17/11/05 | 13/11/05 | 17/11/05 | B | −4 | 0 |
| 567 | 8/10/06 | 30/12/05 | 27/12/05 | 28/11/05 | E | −3 | −32 |
| 643 | 1/10/06 | 23/12/05 | 20/12/05 | 29/11/05 | E | −3 | −24 |
| 14 | 1/10/06 | 23/12/05 | 20/12/05 | 30/11/05 | | −3 | −23 |
| 130 | 24/09/06 | 16/12/05 | 13/12/05 | 10/12/05 | | −3 | −6 |
| 91 | 10/09/06 | 2/12/05 | 29/11/05 | 27/11/05 | | −3 | −5 |
| 666 | 3/09/06 | 25/11/05 | 22/11/05 | 20/11/05 | | −3 | −5 |
| 222 | 5/09/06 | 27/11/05 | 24/11/05 | 22/11/05 | B | −3 | −5 |
| 50 | 24/09/06 | 16/12/05 | 13/12/05 | 11/12/05 | B | −3 | −5 |
| 779 | 11/09/06 | 3/12/05 | 30/11/05 | 29/11/05 | | −3 | −4 |
| 575 | 10/09/06 | 2/12/05 | 29/11/05 | 28/11/05 | B | −3 | −4 |
| 647 | 3/09/06 | 25/11/05 | 22/11/05 | 22/11/05 | | −3 | −3 |
| 630 | 3/09/06 | 25/11/05 | 22/11/05 | 22/11/05 | B | −3 | −3 |
| 275 | 26/09/06 | 18/12/05 | 15/12/05 | 15/12/05 | | −3 | −3 |
| 316 | 7/09/06 | 29/11/05 | 26/11/05 | 27/11/05 | | −3 | −2 |
| 340 | 7/09/06 | 29/11/05 | 26/11/05 | 27/11/05 | | −3 | −2 |
| 335 | 7/09/06 | 29/11/05 | 26/11/05 | 27/11/05 | | −3 | −2 |
| 317 | 28/08/06 | 19/11/05 | 16/11/05 | 17/11/05 | B | −3 | −2 |
| 326 | 28/08/06 | 19/11/05 | 16/11/05 | 17/11/05 | B | −3 | −2 |
| 773 | 28/08/06 | 19/11/05 | 16/11/05 | 18/11/05 | | −3 | −1 |
| 68 | 10/09/06 | 2/12/05 | 29/11/05 | 1/12/05 | | −3 | −1 |
| 126 | 10/09/06 | 2/12/05 | 29/11/05 | 1/12/05 | | −3 | −1 |
| 445 | 19/09/06 | 11/12/05 | 8/12/05 | 10/12/05 | D | −3 | −1 |
| 284 | 29/08/06 | 20/11/05 | 17/11/05 | 20/11/05 | B | −3 | 0 |
| 290 | 26/09/06 | 18/12/05 | 15/12/05 | 21/12/05 | | −3 | 3 |
| 427 | 22/08/06 | 13/11/05 | 10/11/05 | 18/11/05 | | −3 | 5 |
| 735 | 21/08/06 | 12/11/05 | 9/11/05 | 20/11/05 | B | −3 | 8 |
| 758 | 1/10/06 | 23/12/05 | 21/12/05 | 18/11/05 | E | −2 | −35 |
| 629 | 23/09/06 | 15/12/05 | 13/12/05 | 23/11/05 | B | −2 | −22 |
| 285 | 2/10/06 | 24/12/05 | 22/12/05 | 17/12/05 | | −2 | −7 |
| 521 | 9/09/06 | 1/12/05 | 29/11/05 | 26/11/05 | B | −2 | −5 |
| 229 | 2/10/06 | 24/12/05 | 22/12/05 | 19/12/05 | | −2 | −5 |
| 41 | 16/09/06 | 8/12/05 | 6/12/05 | 4/12/05 | | −2 | −4 |
| 53 | 9/09/06 | 1/12/05 | 29/11/05 | 28/11/05 | | −2 | −3 |
| 680 | 9/09/06 | 1/12/05 | 29/11/05 | 28/11/05 | | −2 | −3 |
| 706 | 2/09/06 | 24/11/05 | 22/11/05 | 21/11/05 | | −2 | −3 |
| 640 | 2/09/06 | 24/11/05 | 22/11/05 | 21/11/05 | | −2 | −3 |
| 227 | 4/09/06 | 26/11/05 | 24/11/05 | 23/11/05 | B | −2 | −3 |
| 9 | 2/09/06 | 24/11/05 | 22/11/05 | 22/11/05 | B | −2 | −2 |
| 342 | 11/09/06 | 3/12/05 | 1/12/05 | 2/12/05 | | −2 | −1 |
| 343 | 6/09/06 | 28/11/05 | 26/11/05 | 27/11/05 | | −2 | −1 |
| 312 | 6/09/06 | 28/11/05 | 26/11/05 | 27/11/05 | | −2 | −1 |
| 329 | 6/09/06 | 28/11/05 | 26/11/05 | 27/11/05 | | −2 | −1 |
| 603 | 3/09/06 | 25/11/05 | 23/11/05 | 24/11/05 | | −2 | −1 |
| 346 | 6/09/06 | 28/11/05 | 26/11/05 | 27/11/05 | | −2 | −1 |
| 820 | 27/08/06 | 18/11/05 | 16/11/05 | 17/11/05 | B | −2 | −1 |
| 403 | 28/08/06 | 19/11/05 | 17/11/05 | 18/11/05 | B | −2 | −1 |
| 404 | 28/08/06 | 19/11/05 | 17/11/05 | 18/11/05 | B | −2 | −1 |
| 550 | 2/09/06 | 24/11/05 | 22/11/05 | 23/11/05 | B | −2 | −1 |
| 678 | 2/09/06 | 24/11/05 | 22/11/05 | 23/11/05 | B | −2 | −1 |
| 310 | 6/09/06 | 28/11/05 | 26/11/05 | 27/11/05 | B | −2 | −1 |
| 348 | 6/09/06 | 28/11/05 | 26/11/05 | 27/11/05 | B | −2 | −1 |
| 81 | 9/09/06 | 1/12/05 | 29/11/05 | 30/11/05 | B | −2 | −1 |
| 770 | 27/08/06 | 18/11/05 | 16/11/05 | 18/11/05 | | −2 | 0 |
| 753 | 27/08/06 | 18/11/05 | 16/11/05 | 18/11/05 | B | −2 | 0 |
| 519 | 2/09/06 | 24/11/05 | 22/11/05 | 24/11/05 | B | −2 | 0 |
| 794 | 27/08/06 | 18/11/05 | 16/11/05 | 19/11/05 | B | −2 | 1 |
| 283 | 2/10/06 | 24/12/05 | 22/12/05 | 28/12/05 | | −2 | 4 |
| 243 | 24/09/06 | 16/12/05 | 15/12/05 | 23/11/05 | B | −1 | −23 |
| 303 | 24/09/06 | 16/12/05 | 15/12/05 | 24/11/05 | | −1 | −22 |
| 57 | 29/09/06 | 21/12/05 | 20/12/05 | 4/12/05 | | −1 | −17 |
| 518 | 1/09/06 | 23/11/05 | 22/11/05 | 18/11/05 | B | −1 | −5 |
| 388 | 10/09/06 | 2/12/05 | 1/12/05 | 28/11/05 | B | −1 | −4 |
| 503 | 1/09/06 | 23/11/05 | 22/11/05 | 20/11/05 | | −1 | −3 |
| 278 | 3/09/06 | 25/11/05 | 24/11/05 | 22/11/05 | B | −1 | −3 |
| 106 | 1/09/06 | 23/11/05 | 22/11/05 | 21/11/05 | | −1 | −2 |
| 528 | 1/09/06 | 23/11/05 | 22/11/05 | 21/11/05 | B | −1 | −2 |
| 19 | 15/09/06 | 7/12/05 | 6/12/05 | 5/12/05 | B | −1 | −2 |
| 436 | 17/09/06 | 9/12/05 | 8/12/05 | 7/12/05 | B | −1 | −2 |
| 110 | 1/09/06 | 23/11/05 | 22/11/05 | 22/11/05 | | −1 | −1 |
| 470 | 31/08/06 | 22/11/05 | 21/11/05 | 21/11/05 | B | −1 | −1 |
| 20 | 1/09/06 | 23/11/05 | 22/11/05 | 22/11/05 | B | −1 | −1 |
| 486 | 1/09/06 | 23/11/05 | 22/11/05 | 22/11/05 | B | −1 | −1 |
| 338 | 5/09/06 | 27/11/05 | 26/11/05 | 27/11/05 | | −1 | 0 |
| 6 | 15/09/06 | 7/12/05 | 6/12/05 | 7/12/05 | | −1 | 0 |
| 191 | 22/09/06 | 14/12/05 | 13/12/05 | 14/12/05 | | −1 | 0 |
| 333 | 5/09/06 | 27/11/05 | 26/11/05 | 27/11/05 | | −1 | 0 |
| 384 | 27/08/06 | 18/11/05 | 17/11/05 | 18/11/05 | | −1 | 0 |
| 315 | 27/08/06 | 18/11/05 | 17/11/05 | 18/11/05 | | −1 | 0 |
| 386 | 27/08/06 | 18/11/05 | 17/11/05 | 18/11/05 | | −1 | 0 |
| 355 | 26/08/06 | 17/11/05 | 16/11/05 | 17/11/05 | B | −1 | 0 |
| 446 | 27/08/06 | 18/11/05 | 17/11/05 | 18/11/05 | B | −1 | 0 |
| 108 | 1/09/06 | 23/11/05 | 22/11/05 | 23/11/05 | B | −1 | 0 |
| 656 | 1/09/06 | 23/11/05 | 22/11/05 | 23/11/05 | B | −1 | 0 |
| 306 | 5/09/06 | 27/11/05 | 26/11/05 | 27/11/05 | B | −1 | 0 |
| 113 | 1/09/06 | 23/11/05 | 22/11/05 | 24/11/05 | | −1 | 1 |
| 686 | 1/09/06 | 23/11/05 | 22/11/05 | 24/11/05 | B | −1 | 1 |
| 409 | 27/08/06 | 18/11/05 | 17/11/05 | 20/11/05 | | −1 | 2 |
| 830 | 26/08/06 | 17/11/05 | 16/11/05 | 19/11/05 | | −1 | 2 |
| 726 | 26/08/06 | 17/11/05 | 16/11/05 | 19/11/05 | | −1 | 2 |
| 709 | 5/10/06 | 27/12/05 | 27/12/05 | 28/11/05 | | 0 | −29 |
| 390 | 30/09/06 | 22/12/05 | 22/12/05 | 29/11/05 | E | 0 | −23 |
| 689 | 28/09/06 | 20/12/05 | 20/12/05 | 1/12/05 | E | 0 | −19 |
| 668 | 14/09/06 | 6/12/05 | 6/12/05 | 4/12/05 | | 0 | −2 |
| 540 | 12/10/06 | 3/01/06 | 3/01/06 | 1/01/06 | F | 0 | −2 |
| 507 | 7/09/06 | 29/11/05 | 29/11/05 | 27/11/05 | B | 0 | −2 |
| 669 | 15/09/06 | 7/12/05 | 7/12/05 | 5/12/05 | B | 0 | −2 |
| 95 | 7/09/06 | 29/11/05 | 29/11/05 | 27/11/05 | A | 0 | −2 |
| 609 | 31/08/06 | 22/11/05 | 22/11/05 | 21/11/05 | | 0 | −1 |
| 605 | 1/09/06 | 23/11/05 | 23/11/05 | 22/11/05 | | 0 | −1 |
| 673 | 1/09/06 | 23/11/05 | 23/11/05 | 22/11/05 | | 0 | −1 |
| 667 | 31/08/06 | 22/11/05 | 22/11/05 | 21/11/05 | B | 0 | −1 |
| 511 | 31/08/06 | 22/11/05 | 22/11/05 | 22/11/05 | | 0 | 0 |
| 582 | 31/08/06 | 22/11/05 | 22/11/05 | 22/11/05 | B | 0 | 0 |
| 627 | 14/09/06 | 6/12/05 | 6/12/05 | 7/12/05 | | 0 | 1 |
| 350 | 4/09/06 | 26/11/05 | 26/11/05 | 27/11/05 | | 0 | 1 |
| 397 | 26/08/06 | 17/11/05 | 17/11/05 | 18/11/05 | | 0 | 1 |
| 398 | 26/08/06 | 17/11/05 | 17/11/05 | 18/11/05 | B | 0 | 1 |
| 683 | 31/08/06 | 22/11/05 | 22/11/05 | 23/11/05 | B | 0 | 1 |
| 34 | 14/09/06 | 6/12/05 | 6/12/05 | 7/12/05 | B | 0 | 1 |
| 87 | 24/08/06 | 15/11/05 | 15/11/05 | 17/11/05 | | 0 | 2 |
| 832 | 25/08/06 | 16/11/05 | 16/11/05 | 18/11/05 | | 0 | 2 |
| 664 | 24/08/06 | 15/11/05 | 15/11/05 | 17/11/05 | B | 0 | 2 |
| 693 | 24/08/06 | 15/11/05 | 15/11/05 | 17/11/05 | B | 0 | 2 |
| 674 | 31/08/06 | 22/11/05 | 22/11/05 | 24/11/05 | B | 0 | 2 |
| 103 | 14/09/06 | 6/12/05 | 6/12/05 | 9/12/05 | D | 0 | 3 |
| 777 | 25/08/06 | 16/11/05 | 16/11/05 | 19/11/05 | | 0 | 3 |
| 803 | 1/09/06 | 23/11/05 | 23/11/05 | 26/11/05 | D | 0 | 3 |
| 608 | 24/08/06 | 15/11/05 | 15/11/05 | 20/11/05 | B | 0 | 5 |
| 580 | 28/09/06 | 20/12/05 | 20/12/05 | 30/12/05 | | 0 | 10 |
| 122 | 14/09/06 | 6/12/05 | 6/12/05 | 1/01/06 | F | 0 | 26 |
| 242 | 22/09/06 | 14/12/05 | 15/12/05 | 22/11/05 | B | 1 | −22 |
| 129 | 18/10/06 | 9/01/06 | 10/01/06 | 1/01/06 | F | 1 | −8 |
| 710 | 20/09/06 | 12/12/05 | 13/12/05 | 10/12/05 | | 1 | −2 |
| 690 | 30/08/06 | 21/11/05 | 22/11/05 | 19/11/05 | B | 1 | −2 |
| 653 | 30/08/06 | 21/11/05 | 22/11/05 | 20/11/05 | | 1 | −1 |
| 1 | 13/09/06 | 5/12/05 | 6/12/05 | 4/12/05 | | 1 | −1 |
| 520 | 30/08/06 | 21/11/05 | 22/11/05 | 20/11/05 | B | 1 | −1 |
| 223 | 1/09/06 | 23/11/05 | 24/11/05 | 22/11/05 | B | 1 | −1 |
| 228 | 1/09/06 | 23/11/05 | 24/11/05 | 22/11/05 | B | 1 | −1 |
| 651 | 30/08/06 | 21/11/05 | 22/11/05 | 21/11/05 | | 1 | 0 |
| 659 | 30/08/06 | 21/11/05 | 22/11/05 | 21/11/05 | | 1 | 0 |
| 469 | 28/08/06 | 19/11/05 | 20/11/05 | 19/11/05 | B | 1 | 0 |
| 491 | 28/08/06 | 19/11/05 | 20/11/05 | 19/11/05 | B | 1 | 0 |
| 241 | 1/09/06 | 23/11/05 | 24/11/05 | 23/11/05 | B | 1 | 0 |
| 394 | 25/08/06 | 16/11/05 | 17/11/05 | 17/11/05 | | 1 | 1 |
| 522 | 30/08/06 | 21/11/05 | 22/11/05 | 22/11/05 | B | 1 | 1 |
| 529 | 30/08/06 | 21/11/05 | 22/11/05 | 22/11/05 | B | 1 | 1 |
| 574 | 30/08/06 | 21/11/05 | 22/11/05 | 22/11/05 | B | 1 | 1 |
| 421 | 6/10/06 | 28/12/05 | 29/12/05 | 29/12/05 | | 1 | 1 |
| 405 | 8/09/06 | 30/11/05 | 1/12/05 | 2/12/05 | | 1 | 2 |
| 190 | 26/08/06 | 17/11/05 | 18/11/05 | 19/11/05 | B | 1 | 2 |
| 114 | 30/08/06 | 21/11/05 | 22/11/05 | 23/11/05 | B | 1 | 2 |
| 672 | 30/08/06 | 21/11/05 | 22/11/05 | 23/11/05 | B | 1 | 2 |
| 293 | 1/09/06 | 23/11/05 | 24/11/05 | 25/11/05 | B | 1 | 2 |
| 332 | 3/09/06 | 25/11/05 | 26/11/05 | 27/11/05 | B | 1 | 2 |
| 339 | 7/09/06 | 29/11/05 | 30/11/05 | 1/12/05 | B | 1 | 2 |
| 473 | 26/09/06 | 18/12/05 | 19/12/05 | 20/12/05 | | 1 | 2 |
| 119 | 30/08/06 | 21/11/05 | 22/11/05 | 24/11/05 | | 1 | 3 |
| 29 | 23/08/06 | 14/11/05 | 15/11/05 | 17/11/05 | B | 1 | 3 |
| 576 | 30/08/06 | 21/11/05 | 22/11/05 | 24/11/05 | B | 1 | 3 |
| 21 | 6/09/06 | 28/11/05 | 29/11/05 | 1/12/05 | B | 1 | 3 |
| 784 | 24/08/06 | 15/11/05 | 16/11/05 | 19/11/05 | B | 1 | 4 |
| 702 | 4/10/06 | 26/12/05 | 27/12/05 | 6/01/06 | | 1 | 11 |
| 70 | 12/09/06 | 4/12/05 | 6/12/05 | 1/12/05 | A | 2 | −3 |
| 31 | 12/09/06 | 4/12/05 | 6/12/05 | 2/12/05 | | 2 | −2 |
| 12 | 19/09/06 | 11/12/05 | 13/12/05 | 9/12/05 | | 2 | −2 |
| 515 | 29/08/06 | 20/11/05 | 22/11/05 | 18/11/05 | | 2 | −2 |
| 23 | 5/09/06 | 27/11/05 | 29/11/05 | 25/11/05 | B | 2 | −2 |
| 729 | 30/08/06 | 21/11/05 | 23/11/05 | 20/11/05 | B | 2 | −1 |
| 448 | 21/09/06 | 13/12/05 | 15/12/05 | 13/12/05 | | 2 | 0 |
| 444 | 7/09/06 | 29/11/05 | 1/12/05 | 29/11/05 | B | 2 | 0 |
| 745 | 20/09/06 | 12/12/05 | 14/12/05 | 12/12/05 | B | 2 | 0 |
| 612 | 29/08/06 | 20/11/05 | 22/11/05 | 21/11/05 | | 2 | 1 |
| 671 | 29/08/06 | 20/11/05 | 22/11/05 | 21/11/05 | B | 2 | 1 |
| 685 | 29/08/06 | 20/11/05 | 22/11/05 | 21/11/05 | B | 2 | 1 |
| 698 | 29/08/06 | 20/11/05 | 22/11/05 | 21/11/05 | B | 2 | 1 |
| 704 | 29/08/06 | 20/11/05 | 22/11/05 | 21/11/05 | B | 2 | 1 |
| 646 | 12/09/06 | 4/12/05 | 6/12/05 | 6/12/05 | | 2 | 2 |
| 513 | 29/08/06 | 20/11/05 | 22/11/05 | 22/11/05 | B | 2 | 2 |
| 377 | 24/08/06 | 15/11/05 | 17/11/05 | 18/11/05 | | 2 | 3 |
| 193 | 5/09/06 | 27/11/05 | 29/11/05 | 30/11/05 | | 2 | 3 |
| 361 | 2/09/06 | 24/11/05 | 26/11/05 | 27/11/05 | | 2 | 3 |
| 322 | 7/09/06 | 29/11/05 | 1/12/05 | 2/12/05 | | 2 | 3 |
| 797 | 23/08/06 | 14/11/05 | 16/11/05 | 17/11/05 | | 2 | 3 |
| 382 | 24/08/06 | 15/11/05 | 17/11/05 | 18/11/05 | B | 2 | 3 |
| 432 | 24/08/06 | 15/11/05 | 17/11/05 | 18/11/05 | B | 2 | 3 |
| 584 | 29/08/06 | 20/11/05 | 22/11/05 | 23/11/05 | B | 2 | 3 |
| 525 | 5/09/06 | 27/11/05 | 29/11/05 | 30/11/05 | B | 2 | 3 |
| 728 | 23/08/06 | 14/11/05 | 16/11/05 | 18/11/05 | B | 2 | 4 |
| 429 | 24/08/06 | 15/11/05 | 17/11/05 | 19/11/05 | B | 2 | 4 |
| 26 | 29/08/06 | 20/11/05 | 22/11/05 | 24/11/05 | B | 2 | 4 |
| 818 | 30/08/06 | 21/11/05 | 23/11/05 | 26/11/05 | | 2 | 5 |
| 655 | 29/08/06 | 20/11/05 | 22/11/05 | 13/01/06 | C | 2 | 54 |
| 691 | 11/09/06 | 3/12/05 | 6/12/05 | 28/11/05 | | 3 | −5 |
| 670 | 28/08/06 | 19/11/05 | 22/11/05 | 19/11/05 | B | 3 | 0 |
| 552 | 4/09/06 | 26/11/05 | 29/11/05 | 27/11/05 | | 3 | 1 |
| 531 | 28/08/06 | 19/11/05 | 22/11/05 | 20/11/05 | B | 3 | 1 |
| 714 | 28/08/06 | 19/11/05 | 22/11/05 | 20/11/05 | B | 3 | 1 |
| 555 | 29/08/06 | 20/11/05 | 23/11/05 | 21/11/05 | B | 3 | 1 |
| 262 | 30/08/06 | 21/11/05 | 24/11/05 | 22/11/05 | B | 3 | 1 |
| 300 | 30/08/06 | 21/11/05 | 24/11/05 | 22/11/05 | B | 3 | 1 |
| 51 | 4/09/06 | 26/11/05 | 29/11/05 | 27/11/05 | B | 3 | 1 |
| 383 | 6/09/06 | 28/11/05 | 1/12/05 | 29/11/05 | B | 3 | 1 |
| 788 | 19/09/06 | 11/12/05 | 14/12/05 | 12/12/05 | B | 3 | 1 |
| 566 | 28/08/06 | 19/11/05 | 22/11/05 | 21/11/05 | | 3 | 2 |
| 504 | 28/08/06 | 19/11/05 | 22/11/05 | 21/11/05 | B | 3 | 2 |
| 420 | 23/08/06 | 14/11/05 | 17/11/05 | 17/11/05 | | 3 | 3 |
| 578 | 28/08/06 | 19/11/05 | 22/11/05 | 22/11/05 | B | 3 | 3 |
| 581 | 28/08/06 | 19/11/05 | 22/11/05 | 22/11/05 | B | 3 | 3 |
| 583 | 28/08/06 | 19/11/05 | 22/11/05 | 22/11/05 | B | 3 | 3 |
| 742 | 22/08/06 | 13/11/05 | 16/11/05 | 17/11/05 | B | 3 | 4 |
| 370 | 23/08/06 | 14/11/05 | 17/11/05 | 18/11/05 | B | 3 | 4 |
| 662 | 28/08/06 | 19/11/05 | 22/11/05 | 23/11/05 | B | 3 | 4 |
| 675 | 28/08/06 | 19/11/05 | 22/11/05 | 23/11/05 | B | 3 | 4 |
| 313 | 1/09/06 | 23/11/05 | 26/11/05 | 27/11/05 | B | 3 | 4 |
| 732 | 22/08/06 | 13/11/05 | 16/11/05 | 18/11/05 | B | 3 | 5 |
| 407 | 23/08/06 | 14/11/05 | 17/11/05 | 19/11/05 | B | 3 | 5 |
| 74 | 25/09/06 | 17/12/05 | 20/12/05 | | A | 3 | |
| 289 | 19/09/06 | 11/12/05 | 15/12/05 | 21/11/05 | B | 4 | −20 |
| 677 | 3/09/06 | 25/11/05 | 29/11/05 | 24/11/05 | B | 4 | −1 |
| 695 | 27/08/06 | 18/11/05 | 22/11/05 | 18/11/05 | B | 4 | 0 |
| 64 | 3/09/06 | 25/11/05 | 29/11/05 | 26/11/05 | | 4 | 1 |
| 631 | 3/09/06 | 25/11/05 | 29/11/05 | 26/11/05 | | 4 | 1 |
| 607 | 27/08/06 | 18/11/05 | 22/11/05 | 19/11/05 | | 4 | 1 |
| 638 | 10/09/06 | 2/12/05 | 6/12/05 | 3/12/05 | B | 4 | 1 |
| 636 | 27/08/06 | 18/11/05 | 22/11/05 | 20/11/05 | | 4 | 2 |
| 828 | 28/08/06 | 19/11/05 | 23/11/05 | 21/11/05 | B | 4 | 2 |
| 292 | 29/08/06 | 20/11/05 | 24/11/05 | 22/11/05 | B | 4 | 2 |
| 505 | 3/09/06 | 25/11/05 | 29/11/05 | 28/11/05 | | 4 | 3 |
| 635 | 27/08/06 | 18/11/05 | 22/11/05 | 21/11/05 | | 4 | 3 |
| 524 | 27/08/06 | 18/11/05 | 22/11/05 | 21/11/05 | B | 4 | 3 |
| 577 | 27/08/06 | 18/11/05 | 22/11/05 | 21/11/05 | B | 4 | 3 |
| 658 | 27/08/06 | 18/11/05 | 22/11/05 | 21/11/05 | B | 4 | 3 |
| 225 | 29/08/06 | 20/11/05 | 24/11/05 | 23/11/05 | B | 4 | 3 |
| 254 | 29/08/06 | 20/11/05 | 24/11/05 | 23/11/05 | B | 4 | 3 |
| 587 | 3/09/06 | 25/11/05 | 29/11/05 | 28/11/05 | B | 4 | 3 |
| 220 | 29/08/06 | 20/11/05 | 24/11/05 | 24/11/05 | | 4 | 4 |
| 756 | 4/09/06 | 26/11/05 | 30/11/05 | 30/11/05 | | 4 | 4 |
| 85 | 10/09/06 | 2/12/05 | 6/12/05 | 6/12/05 | | 4 | 4 |
| 97 | 10/09/06 | 2/12/05 | 6/12/05 | 6/12/05 | | 4 | 4 |
| 586 | 27/08/06 | 18/11/05 | 22/11/05 | 22/11/05 | B | 4 | 4 |
| 696 | 27/08/06 | 18/11/05 | 22/11/05 | 22/11/05 | B | 4 | 4 |
| 763 | 28/08/06 | 19/11/05 | 23/11/05 | 23/11/05 | B | 4 | 4 |
| 440 | 22/08/06 | 13/11/05 | 17/11/05 | 18/11/05 | | 4 | 5 |
| 731 | 21/08/06 | 12/11/05 | 16/11/05 | 17/11/05 | B | 4 | 5 |
| 815 | 21/08/06 | 12/11/05 | 16/11/05 | 17/11/05 | B | 4 | 5 |
| 418 | 22/08/06 | 13/11/05 | 17/11/05 | 18/11/05 | B | 4 | 5 |
| 621 | 20/08/06 | 11/11/05 | 15/11/05 | 17/11/05 | B | 4 | 6 |
| 684 | 20/08/06 | 11/11/05 | 15/11/05 | 17/11/05 | B | 4 | 6 |
| 639 | 27/08/06 | 18/11/05 | 22/11/05 | 1/01/06 | F | 4 | 44 |
| 614 | 23/09/06 | 15/12/05 | 20/12/05 | 27/11/05 | B | 5 | −18 |
| 652 | 26/08/06 | 17/11/05 | 22/11/05 | 18/11/05 | | 5 | 1 |
| 692 | 26/08/06 | 17/11/05 | 22/11/05 | 18/11/05 | B | 5 | 1 |
| 32 | 9/09/06 | 1/12/05 | 6/12/05 | 2/12/05 | B | 5 | 1 |
| 747 | 27/08/06 | 18/11/05 | 23/11/05 | 20/11/05 | | 5 | 2 |
| 641 | 9/09/06 | 1/12/05 | 6/12/05 | 3/12/05 | | 5 | 2 |
| 665 | 16/09/06 | 8/12/05 | 13/12/05 | 10/12/05 | | 5 | 2 |
| 401 | 18/09/06 | 10/12/05 | 15/12/05 | 12/12/05 | | 5 | 2 |
| 542 | 8/10/06 | 30/12/05 | 4/01/06 | 1/01/06 | F | 5 | 2 |
| 535 | 2/09/06 | 24/11/05 | 29/11/05 | 26/11/05 | B | 5 | 2 |
| 782 | 3/09/06 | 25/11/05 | 30/11/05 | 27/11/05 | B | 5 | 2 |
| 633 | 26/08/06 | 17/11/05 | 22/11/05 | 20/11/05 | | 5 | 3 |
| 560 | 26/08/06 | 17/11/05 | 22/11/05 | 20/11/05 | B | 5 | 3 |
| 606 | 2/09/06 | 24/11/05 | 29/11/05 | 27/11/05 | B | 5 | 3 |
| 73 | 26/08/06 | 17/11/05 | 22/11/05 | 21/11/05 | | 5 | 4 |
| 700 | 26/08/06 | 17/11/05 | 22/11/05 | 21/11/05 | B | 5 | 4 |
| 351 | 30/08/06 | 21/11/05 | 26/11/05 | 27/11/05 | | 5 | 6 |
| 373 | 21/08/06 | 12/11/05 | 17/11/05 | 18/11/05 | | 5 | 6 |
| 308 | 20/08/06 | 11/11/05 | 16/11/05 | 17/11/05 | B | 5 | 6 |
| 354 | 2/10/06 | 24/12/05 | 29/12/05 | 31/12/05 | | 5 | 7 |
| 563 | 19/08/06 | 10/11/05 | 15/11/05 | 17/11/05 | B | 5 | 7 |
| 663 | 26/08/06 | 17/11/05 | 22/11/05 | 24/11/05 | B | 5 | 7 |
| 766 | 24/09/06 | 16/12/05 | 21/12/05 | | A | 5 | |
| 767 | 2/09/06 | 24/11/05 | 30/11/05 | 19/11/05 | | 6 | −5 |
| 88 | 1/09/06 | 23/11/05 | 29/11/05 | 26/11/05 | | 6 | 3 |
| 618 | 25/08/06 | 16/11/05 | 22/11/05 | 19/11/05 | B | 6 | 3 |
| 805 | 26/08/06 | 17/11/05 | 23/11/05 | 20/11/05 | B | 6 | 3 |
| 829 | 26/08/06 | 17/11/05 | 23/11/05 | 20/11/05 | B | 6 | 3 |
| 78 | 6/10/06 | 28/12/05 | 3/01/06 | 1/01/06 | F | 6 | 4 |
| 719 | 16/09/06 | 8/12/05 | 14/12/05 | 12/12/05 | B | 6 | 4 |
| 715 | 1/09/06 | 23/11/05 | 29/11/05 | 28/11/05 | | 6 | 5 |
| 611 | 25/08/06 | 16/11/05 | 22/11/05 | 22/11/05 | | 6 | 6 |
| 660 | 25/08/06 | 16/11/05 | 22/11/05 | 22/11/05 | B | 6 | 6 |
| 808 | 19/08/06 | 10/11/05 | 16/11/05 | 17/11/05 | | 6 | 7 |
| 760 | 19/08/06 | 10/11/05 | 16/11/05 | 17/11/05 | B | 6 | 7 |
| 314 | 7/09/06 | 29/11/05 | 5/12/05 | 6/12/05 | B | 6 | 7 |
| 744 | 22/09/06 | 14/12/05 | 21/12/05 | 13/12/05 | | 7 | −1 |
| 532 | 24/08/06 | 15/11/05 | 22/11/05 | 18/11/05 | B | 7 | 3 |
| 707 | 24/08/06 | 15/11/05 | 22/11/05 | 18/11/05 | B | 7 | 3 |
| 2 | 24/08/06 | 15/11/05 | 22/11/05 | 19/11/05 | B | 7 | 4 |
| 579 | 24/08/06 | 15/11/05 | 22/11/05 | 19/11/05 | B | 7 | 4 |
| 649 | 24/08/06 | 15/11/05 | 22/11/05 | 19/11/05 | B | 7 | 4 |
| 423 | 26/08/06 | 17/11/05 | 24/11/05 | 21/11/05 | B | 7 | 4 |
| 654 | 24/08/06 | 15/11/05 | 22/11/05 | 20/11/05 | | 7 | 5 |
| 749 | 15/09/06 | 7/12/05 | 14/12/05 | 12/12/05 | B | 7 | 5 |
| 835 | 25/08/06 | 16/11/05 | 23/11/05 | 22/11/05 | | 7 | 6 |
| 467 | 23/08/06 | 14/11/05 | 21/11/05 | 20/11/05 | B | 7 | 6 |
| 610 | 24/08/06 | 15/11/05 | 22/11/05 | 22/11/05 | B | 7 | 7 |
| 722 | 18/08/06 | 9/11/05 | 16/11/05 | 17/11/05 | | 7 | 8 |
| 823 | 25/08/06 | 16/11/05 | 23/11/05 | 24/11/05 | | 7 | 8 |
| 37 | 24/08/06 | 15/11/05 | 22/11/05 | 23/11/05 | B | 7 | 8 |
| 496 | 15/08/06 | 6/11/05 | 13/11/05 | 17/11/05 | B | 7 | 11 |
| 195 | 2/09/06 | 24/11/05 | 1/12/05 | 6/01/06 | C | 7 | 43 |
| 802 | 14/09/06 | 6/12/05 | 14/12/05 | 2/12/05 | | 8 | −4 |
| 790 | 24/08/06 | 15/11/05 | 23/11/05 | 20/11/05 | B | 8 | 5 |
| 117 | 23/08/06 | 14/11/05 | 22/11/05 | 20/11/05 | | 8 | 6 |
| 650 | 23/08/06 | 14/11/05 | 22/11/05 | 21/11/05 | B | 8 | 7 |
| 301 | 1/09/06 | 23/11/05 | 1/12/05 | 30/11/05 | B | 8 | 7 |
| 632 | 23/08/06 | 14/11/05 | 22/11/05 | 22/11/05 | | 8 | 8 |
| 833 | 30/08/06 | 21/11/05 | 30/11/05 | 18/11/05 | B | 9 | −3 |
| 500 | 27/08/06 | 18/11/05 | 27/11/05 | 20/11/05 | B | 9 | 2 |
| 46 | 29/08/06 | 20/11/05 | 29/11/05 | 25/11/05 | B | 9 | 5 |
| 721 | 23/08/06 | 14/11/05 | 23/11/05 | 20/11/05 | B | 9 | 6 |
| 751 | 23/08/06 | 14/11/05 | 23/11/05 | 20/11/05 | B | 9 | 6 |
| 783 | 23/08/06 | 14/11/05 | 23/11/05 | 20/11/05 | B | 9 | 6 |
| 734 | 13/09/06 | 5/12/05 | 14/12/05 | 12/12/05 | B | 9 | 7 |
| 360 | 26/08/06 | 17/11/05 | 26/11/05 | 27/11/05 | B | 9 | 10 |
| 455 | 9/10/06 | 31/12/05 | 10/01/06 | 19/11/05 | B | 10 | −42 |
| 746 | 19/09/06 | 11/12/05 | 21/12/05 | 13/12/05 | B | 10 | 2 |
| 25 | 21/08/06 | 12/11/05 | 22/11/05 | 18/11/05 | | 10 | 6 |
| 711 | 21/08/06 | 12/11/05 | 22/11/05 | 19/11/05 | B | 10 | 7 |
| 679 | 21/08/06 | 12/11/05 | 22/11/05 | 20/11/05 | | 10 | 8 |
| 681 | 21/08/06 | 12/11/05 | 22/11/05 | 20/11/05 | B | 10 | 8 |
| 52 | 4/09/06 | 26/11/05 | 6/12/05 | 7/12/05 | | 10 | 11 |
| 703 | 21/08/06 | 12/11/05 | 22/11/05 | 8/12/05 | | 10 | 26 |
| 642 | 20/08/06 | 11/11/05 | 22/11/05 | 18/11/05 | | 11 | 7 |
| 396 | 3/10/06 | 25/12/05 | 5/01/06 | 1/01/06 | | 11 | 7 |
| 15 | 27/08/06 | 18/11/05 | 29/11/05 | 26/11/05 | | 11 | 8 |
| 464 | 1/09/06 | 23/11/05 | 5/12/05 | 21/11/05 | B | 12 | −2 |
| 61 | 7/10/06 | 29/12/05 | 10/01/06 | 1/01/06 | F | 12 | 3 |
| 812 | 20/08/06 | 11/11/05 | 23/11/05 | 20/11/05 | B | 12 | 9 |
| 471 | 12/10/06 | 3/01/06 | 16/01/06 | 1/01/06 | F | 13 | −2 |
| 493 | 23/08/06 | 14/11/05 | 27/11/05 | 18/11/05 | B | 13 | 4 |
| 452 | 23/08/06 | 14/11/05 | 27/11/05 | 20/11/05 | B | 13 | 6 |
| 701 | 1/09/06 | 23/11/05 | 6/12/05 | 6/12/05 | B | 13 | 13 |
| 277 | 2/09/06 | 24/11/05 | 8/12/05 | 22/11/05 | | 14 | −2 |
| 232 | 1/09/06 | 23/11/05 | 8/12/05 | 20/11/05 | B | 15 | −3 |
| 489 | 18/09/06 | 10/12/05 | 25/12/05 | 21/12/05 | | 15 | 11 |
| 344 | 20/08/06 | 11/11/05 | 26/11/05 | 27/11/05 | | 15 | 16 |
| 814 | 23/08/06 | 14/11/05 | 30/11/05 | 17/11/05 | B | 16 | 3 |
| 76 | 26/09/06 | 18/12/05 | 3/01/06 | 21/01/06 | | 16 | 34 |
| 428 | 30/08/06 | 21/11/05 | 8/12/05 | 18/11/05 | B | 17 | −3 |
| 688 | 13/08/06 | 4/11/05 | 22/11/05 | 18/12/05 | | 18 | 44 |
| 419 | 28/08/06 | 19/11/05 | 8/12/05 | 25/11/05 | B | 19 | 6 |
| 309 | 16/08/06 | 7/11/05 | 26/11/05 | 15/12/05 | | 19 | 38 |
| 49 | 11/08/06 | 2/11/05 | 22/11/05 | 10/12/05 | B | 20 | 38 |
| 512 | 1/09/06 | 23/11/05 | 13/12/05 | 1/01/06 | F | 20 | 39 |
| 725 | 25/08/06 | 16/11/05 | 7/12/05 | 21/11/05 | B | 21 | 5 |
| 121 | 30/08/06 | 21/11/05 | 13/12/05 | 17/11/05 | | 22 | −4 |
| 443 | 25/08/06 | 16/11/05 | 8/12/05 | 17/11/05 | B | 22 | 1 |
| 634 | 9/08/06 | 31/10/05 | 22/11/05 | 26/12/05 | | 22 | 56 |
| 393 | 24/08/06 | 15/11/05 | 8/12/05 | 17/11/05 | B | 23 | 2 |
| 708 | 28/08/06 | 19/11/05 | 13/12/05 | 19/11/05 | B | 24 | 0 |
| 616 | 27/08/06 | 18/11/05 | 13/12/05 | 22/11/05 | | 25 | 4 |
| 48 | 20/08/06 | 11/11/05 | 6/12/05 | 5/12/05 | B | 25 | 24 |
| 759 | 27/08/06 | 18/11/05 | 14/12/05 | 19/11/05 | B | 26 | 1 |
| 569 | 26/08/06 | 17/11/05 | 13/12/05 | 19/11/05 | B | 26 | 2 |
| 221 | 29/07/06 | 20/10/05 | 17/11/05 | 16/12/05 | | 28 | 57 |
| 694 | 2/08/06 | 24/10/05 | 22/11/05 | 22/11/05 | B | 29 | 29 |
| 465 | 10/10/06 | 1/01/06 | 31/01/06 | 21/11/05 | B | 30 | −41 |
| 458 | 22/08/06 | 13/11/05 | 18/12/05 | 18/11/05 | B | 35 | 5 |
| 501 | 25/08/06 | 16/11/05 | 28/12/05 | 21/11/05 | B | 42 | 5 |
| 595 | 2/08/06 | 24/10/05 | 13/12/05 | 24/11/05 | | 50 | 31 |
| 297 | 8/09/06 | 30/11/05 | 19/01/06 | 24/01/06 | | 50 | 55 |
| 380 | 1/09/06 | 23/11/05 | 19/01/06 | 1/01/06 | F | 57 | 39 |
| 111 | 27/09/06 | 19/12/05 | | 9/12/05 | | | −10 |
| 378 | 11/09/06 | 3/12/05 | | 24/11/05 | | | −9 |
| 137 | 4/09/06 | 26/11/05 | | 18/11/05 | B | | −8 |
| 186 | 26/09/06 | 18/12/05 | | 11/12/05 | | | −7 |
| 158 | 3/09/06 | 25/11/05 | | 18/11/05 | B | | −7 |
| 648 | 5/09/06 | 27/11/05 | | 21/11/05 | | | −6 |
| 182 | 3/09/06 | 25/11/05 | | 19/11/05 | B | | −6 |
| 167 | 17/09/06 | 9/12/05 | | 5/12/05 | B | | −4 |
| 152 | 17/09/06 | 9/12/05 | | 6/12/05 | | | −3 |
| 204 | 23/09/06 | 15/12/05 | | 12/12/05 | | | −3 |
| 196 | 3/09/06 | 25/11/05 | | 22/11/05 | | | −3 |
| 203 | 25/09/06 | 17/12/05 | | 14/12/05 | B | | −3 |
| 171 | 28/08/06 | 19/11/05 | | 17/11/05 | B | | −2 |
| 170 | 31/08/06 | 22/11/05 | | 20/11/05 | B | | −2 |
| 164 | 10/09/06 | 2/12/05 | | 30/11/05 | B | | −2 |
| 188 | 27/08/06 | 18/11/05 | | 17/11/05 | B | | −1 |
| 392 | 28/08/06 | 19/11/05 | | 18/11/05 | B | | −1 |
| 184 | 29/08/06 | 20/11/05 | | 19/11/05 | B | | −1 |
| 198 | 29/08/06 | 20/11/05 | | 19/11/05 | B | | −1 |
| 154 | 26/08/06 | 17/11/05 | | 17/11/05 | B | | 0 |
| 145 | 28/08/06 | 19/11/05 | | 19/11/05 | B | | 0 |
| 175 | 28/08/06 | 19/11/05 | | 19/11/05 | B | | 0 |
| 177 | 11/09/06 | 3/12/05 | | 3/12/05 | B | | 0 |
| 172 | 25/08/06 | 16/11/05 | | 17/11/05 | B | | 1 |
| 148 | 26/08/06 | 17/11/05 | | 18/11/05 | B | | 1 |
| 139 | 29/08/06 | 20/11/05 | | 21/11/05 | B | | 1 |
| 153 | 26/08/06 | 17/11/05 | | 19/11/05 | | | 2 |
| 147 | 24/08/06 | 15/11/05 | | 17/11/05 | B | | 2 |
| 570 | 29/08/06 | 20/11/05 | | 22/11/05 | B | | 2 |
| 173 | 26/08/06 | 17/11/05 | | 20/11/05 | | | 3 |
| 144 | 24/08/06 | 15/11/05 | | 18/11/05 | B | | 3 |
| 209 | 24/08/06 | 15/11/05 | | 18/11/05 | B | | 3 |
| 187 | 27/08/06 | 18/11/05 | | 21/11/05 | B | | 3 |
| 174 | 20/09/06 | 12/12/05 | | 15/12/05 | B | | 3 |
| 194 | 17/09/06 | 9/12/05 | | 13/12/05 | | | 4 |
| 142 | 22/08/06 | 13/11/05 | | 18/11/05 | B | | 5 |
| 150 | 21/08/06 | 12/11/05 | | 18/11/05 | B | | 6 |
| 138 | 25/08/06 | 16/11/05 | | 22/11/05 | B | | 6 |
| 146 | 29/08/06 | 20/11/05 | | 27/11/05 | B | | 7 |
| 168 | 30/08/06 | 21/11/05 | | 30/11/05 | | | 9 |
| 202 | 27/08/06 | 18/11/05 | | 27/11/05 | B | | 9 |
| 739 | 1/09/06 | 23/11/05 | 8/02/06 | | | | |
| 544 | 15/09/06 | 7/12/05 | | | | | |
| 645 | 25/09/06 | 17/12/05 | 13/12/05 | | | | |
| 83 | 26/09/06 | 18/12/05 | 13/12/05 | | | | |
| 99 | 27/09/06 | 19/12/05 | 29/11/05 | | | | |
| 100 | 2/10/06 | 24/12/05 | 20/12/05 | | | | |
| 104 | 5/10/06 | 27/12/05 | 20/12/05 | | | | |
| 143 | 9/10/06 | 31/12/05 | | | | | |
| 69 | 11/10/06 | 2/01/06 | 6/12/05 | | | | |
| 197 | 14/10/06 | 5/01/06 | 19/11/05 | | | | |
| 472 | 14/11/06 | 5/02/06 | 27/11/05 | | | | |

### Working Examples

Table 6 includes the raw data on which the summary in Table 5 is based.

| | | First Estrone Sulfate Test | | | | | |
|---|---|---|---|---|---|---|---|
| Cow | Calving | Test | ES | | Weeks | | Validated |
| ID | Date | Date | pg/mL | Diagnosis | pregnant | ECD | ECD |
| 517 | 10/09/06 | 11/04/06 | 300 | Pregnant | 17.799 | 7/12/05 | 2/12/05 |
| 63 | 6/10/06 | 5/04/06 | 140 | Probably | 14.86871 | 21/12/05 | 21/12/05 |
| 84 | 20/10/06 | 5/04/06 | 20 | Not confirmed | | | |
| 90 | 6/10/06 | 5/04/06 | 140 | Probably | 14.86871 | 21/12/05 | 21/12/05 |
| 134 | 6/10/06 | 5/04/06 | 100 | Probably | 14.13614 | 27/12/05 | 27/12/05 |
| 93 | 19/10/06 | 5/04/06 | 40 | Not confirmed | | | |
| 433 | 29/09/06 | 10/04/06 | 170 | Pregnant | 15.41814 | 23/12/05 | 23/12/05 |
| 217 | 5/10/06 | 6/04/06 | 170 | Pregnant | 15.41814 | 19/12/05 | 19/12/05 |
| 77 | 1/10/06 | 5/04/06 | 130 | Probably | 14.68557 | 23/12/05 | 23/12/05 |
| 716 | 2/10/06 | 11/04/06 | 150 | Pregnant | 15.05186 | 26/12/05 | 12/12/05 |
| 120 | 7/10/06 | 5/04/06 | 110 | Probably | 14.31929 | 25/12/05 | 25/12/05 |
| 791 | 23/09/06 | 11/04/06 | 210 | Pregnant | 16.15071 | 18/12/05 | 18/12/05 |
| 687 | 20/09/06 | 11/04/06 | 700 | Pregnant | | | 17/11/05 |
| 105 | 27/09/06 | 5/04/06 | 70 | Not confirmed | | | |
| 796 | 4/10/06 | 11/04/06 | 200 | Pregnant | 15.96757 | 20/12/05 | 20/12/05 |
| 80 | 3/10/06 | 5/04/06 | 250 | Pregnant | 16.88329 | 7/12/05 | 6/12/05 |
| 764 | 26/09/06 | 11/04/06 | 150 | Pregnant | 15.05186 | 26/12/05 | 26/12/05 |
| 765 | 26/09/06 | 11/04/06 | 190 | Pregnant | 15.78443 | 21/12/05 | 13/12/05 |
| 115 | 8/10/06 | 5/04/06 | 70 | Not confirmed | | | |
| 460 | 17/09/06 | 10/04/06 | 170 | Pregnant | 15.41814 | 23/12/05 | 23/12/05 |
| 497 | 5/10/06 | 10/04/06 | 600 | Pregnant | | | 17/11/05 |
| 457 | 22/09/06 | 10/04/06 | 500 | Pregnant | | | 18/11/05 |
| 740 | 17/09/06 | 11/04/06 | 170 | Pregnant | 15.41814 | 24/12/05 | 13/12/05 |
| 426 | 2/10/06 | 10/04/06 | 120 | Probably | 14.50243 | 29/12/05 | 29/12/05 |
| 132 | 6/10/06 | 5/04/06 | 130 | Probably | 14.68557 | 23/12/05 | 14/12/05 |
| 723 | 30/09/06 | 11/04/06 | 400 | Pregnant | | | 12/12/05 |
| 793 | 21/09/06 | 11/04/06 | 140 | Probably | 14.86871 | 27/12/05 | 27/12/05 |
| 795 | 14/09/06 | 11/04/06 | 900 | Pregnant | | | 12/12/05 |
| 480 | 18/09/06 | 10/04/06 | 70 | Not confirmed | | | |
| 571 | 18/09/06 | 11/04/06 | 500 | Pregnant | | | 21/11/05 |
| 127 | 16/10/06 | 5/04/06 | 20 | Not confirmed | | | |
| 559 | 8/10/06 | 11/04/06 | 110 | Probably | 14.31929 | 31/12/05 | 31/12/05 |
| 562 | 7/10/06 | 11/04/06 | 180 | Pregnant | 15.60129 | 22/12/05 | 22/12/05 |
| 798 | 24/09/06 | 11/04/06 | 100 | Probably | 14.13614 | 2/01/06 | 2/01/06 |
| 71 | 9/09/06 | 5/04/06 | 50 | Not confirmed | | | |
| 372 | 25/09/06 | 10/04/06 | 90 | Not confirmed | | | |
| 772 | 9/09/06 | 11/04/06 | 400 | Pregnant | | | 19/11/05 |
| 124 | 15/09/06 | 5/04/06 | 90 | Not confirmed | | | |
| 102 | 5/10/06 | 5/04/06 | 40 | Not confirmed | | | |
| 510 | 6/09/06 | 11/04/06 | 300 | Pregnant | 17.799 | 7/12/05 | 21/11/05 |
| 59 | 11/10/06 | 5/04/06 | 20 | Not confirmed | | | |
| 487 | 26/08/06 | 10/04/06 | 210 | Pregnant | 16.15071 | 17/12/05 | 17/12/05 |
| 807 | 24/08/06 | 11/04/06 | 700 | Pregnant | | | 24/11/05 |
| 461 | 17/09/06 | 10/04/06 | 500 | Pregnant | | | 21/11/05 |
| 778 | 6/09/06 | 11/04/06 | 1000 | Pregnant | | | 18/11/05 |
| 508 | 5/09/06 | 11/04/06 | 700 | Pregnant | | | 21/11/05 |
| 492 | 4/09/06 | 10/04/06 | 600 | Pregnant | | | 21/11/05 |
| 109 | 12/09/06 | 5/04/06 | 70 | Not confirmed | | | |
| 410 | 6/09/06 | 10/04/06 | 180 | Pregnant | 15.60129 | 21/12/05 | 21/12/05 |
| 337 | 15/09/06 | 9/04/06 | 130 | Probably | 14.68557 | 27/12/05 | 27/11/05 |
| 484 | 9/09/06 | 10/04/06 | 900 | Pregnant | | | 21/11/05 |
| 810 | 19/09/06 | 11/04/06 | 500 | Pregnant | | | 13/12/05 |
| 379 | 27/09/06 | 10/04/06 | 110 | Probably | 14.31929 | 30/12/05 | 30/12/05 |
| 408 | 4/10/06 | 10/04/06 | 90 | Not confirmed | | | |
| 502 | 1/10/06 | 11/04/06 | 220 | Pregnant | 16.33386 | 17/12/05 | 17/12/05 |
| 347 | 14/09/06 | 9/04/06 | 150 | Pregnant | 15.05186 | 24/12/05 | 24/12/05 |
| 737 | 18/09/06 | 11/04/06 | 180 | Pregnant | 15.60129 | 22/12/05 | 13/12/05 |
| 425 | 2/10/06 | 10/04/06 | 200 | Pregnant | 15.96757 | 19/12/05 | 19/12/05 |
| 269 | 11/09/06 | 6/04/06 | 600 | Pregnant | | | 22/11/05 |
| 368 | 4/09/06 | 10/04/06 | 600 | Pregnant | | | 17/11/05 |
| 362 | 13/09/06 | 9/04/06 | 250 | Pregnant | 16.88329 | 11/12/05 | 27/11/05 |
| 67 | 7/10/06 | 5/04/06 | 80 | Not confirmed | | | |
| 302 | 1/10/06 | 6/04/06 | 500 | Pregnant | | | 18/11/05 |
| 288 | 10/09/06 | 6/04/06 | 900 | Pregnant | | | 23/11/05 |
| 311 | 12/09/06 | 9/04/06 | 220 | Pregnant | 16.33386 | 15/12/05 | 15/12/05 |
| 112 | 8/09/06 | 5/04/06 | 190 | Pregnant | 15.78443 | 15/12/05 | 15/12/05 |
| 450 | 3/09/06 | 10/04/06 | 250 | Pregnant | 16.88329 | 12/12/05 | 12/12/05 |
| 320 | 12/09/06 | 9/04/06 | 500 | Pregnant | | | 27/11/05 |
| 661 | 1/09/06 | 11/04/06 | 200 | Pregnant | 15.96757 | 20/12/05 | 20/12/05 |
| 135 | 1/09/06 | 5/04/06 | 130 | Probably | 14.68557 | 23/12/05 | 23/12/05 |
| 441 | 17/09/06 | 10/04/06 | 90 | Not confirmed | | | |
| 453 | 5/09/06 | 10/04/06 | 700 | Pregnant | | | 21/11/05 |
| 705 | 7/09/06 | 11/04/06 | 700 | Pregnant | | | 23/11/05 |
| 324 | 11/09/06 | 9/04/06 | 80 | Not confirmed | | | |
| 125 | 19/10/06 | 5/04/06 | 20 | Not confirmed | | | |
| 123 | 12/10/06 | 5/04/06 | 90 | Not confirmed | | | |
| 676 | 6/09/06 | 11/04/06 | 600 | Pregnant | | | 21/11/05 |
| 237 | 8/09/06 | 6/04/06 | 700 | Pregnant | | | 23/11/05 |
| 246 | 8/09/06 | 6/04/06 | 400 | Pregnant | | | 23/11/05 |
| 755 | 7/09/06 | 11/04/06 | 800 | Pregnant | | | 23/11/05 |
| 381 | 1/09/06 | 10/04/06 | 400 | Pregnant | | | 18/11/05 |
| 430 | 1/09/06 | 10/04/06 | 400 | Pregnant | | | 18/11/05 |
| 36 | 6/09/06 | 4/04/06 | 400 | Pregnant | | | 23/11/05 |
| 330 | 11/09/06 | 9/04/06 | 800 | Pregnant | | | 28/11/05 |
| 387 | 15/09/06 | 10/04/06 | 150 | Pregnant | 15.05186 | 25/12/05 | 25/12/05 |
| 554 | 30/08/06 | 11/04/06 | 700 | Pregnant | | | 17/11/05 |
| 713 | 30/08/06 | 11/04/06 | 400 | Pregnant | | | 17/11/05 |
| 385 | 1/09/06 | 10/04/06 | 600 | Pregnant | | | 19/11/05 |
| 483 | 29/08/06 | 10/04/06 | 600 | Pregnant | | | 17/11/05 |
| 133 | 4/10/06 | 5/04/06 | 70 | Not confirmed | | | |
| 495 | 4/10/06 | 10/04/06 | 100 | Probably | 14.13614 | 1/01/06 | 1/01/06 |
| 45 | 5/09/06 | 4/04/06 | 900 | Pregnant | | | 19/11/05 |
| 527 | 6/09/06 | 11/04/06 | 180 | Pregnant | 15.60129 | 22/12/05 | 22/12/05 |
| 572 | 5/09/06 | 11/04/06 | 400 | Pregnant | | | 21/11/05 |
| 466 | 4/09/06 | 10/04/06 | 300 | Pregnant | 17.799 | 6/12/05 | 22/11/05 |
| 39 | 5/09/06 | 4/04/06 | 250 | Pregnant | 16.88329 | 6/12/05 | 23/11/05 |
| 307 | 9/09/06 | 9/04/06 | 210 | Pregnant | 16.15071 | 16/12/05 | 16/12/05 |
| 400 | 31/08/06 | 10/04/06 | 700 | Pregnant | | | 18/11/05 |
| 821 | 30/08/06 | 11/04/06 | 170 | Pregnant | 15.41814 | 24/12/05 | 24/12/05 |
| 506 | 29/08/06 | 11/04/06 | 500 | Pregnant | | | 17/11/05 |
| 730 | 30/08/06 | 11/04/06 | 400 | Pregnant | | | 19/11/05 |
| 596 | 6/09/06 | 11/04/06 | 800 | Pregnant | | | 26/11/05 |
| 568 | 3/10/06 | 11/04/06 | 140 | Probably | 14.86871 | 27/12/05 | 27/12/05 |
| 72 | 10/10/06 | 5/04/06 | 80 | Not confirmed | | | |
| 615 | 25/09/06 | 11/04/06 | 150 | Pregnant | 15.05186 | 26/12/05 | 26/12/05 |
| 22 | 17/10/06 | 4/04/06 | 180 | Pregnant | 15.60129 | 15/12/05 | 15/12/05 |
| 272 | 6/09/06 | 6/04/06 | 1000 | Pregnant | | | 22/11/05 |
| 234 | 6/09/06 | 6/04/06 | 900 | Pregnant | | | 23/11/05 |
| 481 | 4/09/06 | 10/04/06 | 300 | Pregnant | 17.799 | 6/12/05 | 22/11/05 |
| 358 | 8/09/06 | 9/04/06 | 190 | Pregnant | 15.78443 | 19/12/05 | 19/12/05 |
| 359 | 8/09/06 | 9/04/06 | 130 | Probably | 14.68557 | 27/12/05 | 27/11/05 |
| 526 | 4/09/06 | 11/04/06 | 500 | Pregnant | | | 23/11/05 |
| 318 | 8/09/06 | 9/04/06 | 600 | Pregnant | | | 27/11/05 |
| 336 | 8/09/06 | 9/04/06 | 600 | Pregnant | | | 27/11/05 |
| 334 | 8/09/06 | 9/04/06 | 90 | Not confirmed | | | |
| 447 | 13/09/06 | 10/04/06 | 250 | Pregnant | 16.88329 | 12/12/05 | 4/12/05 |
| 456 | 26/08/06 | 10/04/06 | 800 | Pregnant | | | 17/11/05 |
| 567 | 8/10/06 | 11/04/06 | 160 | Pregnant | 15.235 | 25/12/05 | 25/12/05 |
| 643 | 1/10/06 | 11/04/06 | 200 | Pregnant | 15.96757 | 20/12/05 | 20/12/05 |
| 14 | 1/10/06 | 4/04/06 | 170 | Pregnant | 15.41814 | 17/12/05 | 30/11/05 |
| 130 | 24/09/06 | 5/04/06 | 190 | Pregnant | 15.78443 | 15/12/05 | 10/12/05 |
| 91 | 10/09/06 | 5/04/06 | 210 | Pregnant | 16.15071 | 12/12/05 | 27/11/05 |
| 666 | 3/09/06 | 11/04/06 | 140 | Probably | 14.86871 | 27/12/05 | 27/12/05 |
| 222 | 5/09/06 | 6/04/06 | 600 | Pregnant | | | 22/11/05 |
| 50 | 24/09/06 | 4/04/06 | 700 | Pregnant | | | 11/12/05 |
| 779 | 11/09/06 | 11/04/06 | 190 | Pregnant | 15.78443 | 21/12/05 | 21/12/05 |
| 575 | 10/09/06 | 11/04/06 | 500 | Pregnant | | | 28/11/05 |
| 647 | 3/09/06 | 11/04/06 | 150 | Pregnant | 15.05186 | 26/12/05 | 22/11/05 |
| 630 | 3/09/06 | 11/04/06 | 700 | Pregnant | | | 22/11/05 |
| 275 | 26/09/06 | 6/04/06 | 200 | Pregnant | 15.96757 | 15/12/05 | 15/12/05 |
| 316 | 7/09/06 | 9/04/06 | 190 | Pregnant | 15.78443 | 19/12/05 | 19/12/05 |
| 340 | 7/09/06 | 9/04/06 | 190 | Pregnant | 15.78443 | 19/12/05 | 19/12/05 |
| 335 | 7/09/06 | 9/04/06 | 160 | Pregnant | 15.235 | 23/12/05 | 23/12/05 |
| 317 | 28/08/06 | 9/04/06 | 400 | Pregnant | | | 17/11/05 |
| 326 | 28/08/06 | 9/04/06 | 600 | Pregnant | | | 17/11/05 |
| 773 | 28/08/06 | 11/04/06 | 400 | Pregnant | | | 18/11/05 |
| 68 | 10/09/06 | 5/04/06 | 190 | Pregnant | 15.78443 | 15/12/05 | 1/12/05 |
| 126 | 10/09/06 | 5/04/06 | 180 | Pregnant | 15.60129 | 16/12/05 | 1/12/05 |
| 445 | 19/09/06 | 10/04/06 | 130 | Probably | 14.68557 | 28/12/05 | 28/12/05 |
| 284 | 29/08/06 | 6/04/06 | 800 | Pregnant | | | 20/11/05 |
| 290 | 26/09/06 | 6/04/06 | 150 | Pregnant | 15.05186 | 21/12/05 | 21/12/05 |
| 427 | 22/08/06 | 10/04/06 | 300 | Pregnant | 17.799 | 6/12/05 | 18/11/05 |
| 735 | 21/08/06 | 11/04/06 | 400 | Pregnant | | | 20/11/05 |
| 758 | 1/10/06 | 11/04/06 | 150 | Pregnant | 15.05186 | 26/12/05 | 26/12/05 |
| 629 | 23/09/06 | 11/04/06 | 500 | Pregnant | | | 23/11/05 |
| 285 | 2/10/06 | 6/04/06 | 180 | Pregnant | 15.60129 | 17/12/05 | 17/12/05 |
| 521 | 9/09/06 | 11/04/06 | 600 | Pregnant | | | 26/11/05 |
| 229 | 2/10/06 | 6/04/06 | 170 | Pregnant | 15.41814 | 19/12/05 | 19/12/05 |
| 41 | 16/09/06 | 4/04/06 | 250 | Pregnant | 16.88329 | 6/12/05 | 4/12/05 |
| 53 | 9/09/06 | 4/04/06 | 250 | Pregnant | 16.88329 | 6/12/05 | 28/11/05 |
| 680 | 9/09/06 | 11/04/06 | 250 | Pregnant | 16.88329 | 13/12/05 | 28/11/05 |
| 706 | 2/09/06 | 11/04/06 | 190 | Pregnant | 15.78443 | 21/12/05 | 21/12/05 |
| 640 | 2/09/06 | 11/04/06 | 180 | Pregnant | 15.60129 | 22/12/05 | 22/12/05 |
| 227 | 4/09/06 | 6/04/06 | 800 | Pregnant | | | 23/11/05 |
| 9 | 2/09/06 | 4/04/06 | 900 | Pregnant | | | 22/11/05 |
| 342 | 11/09/06 | 9/04/06 | 200 | Pregnant | 15.96757 | 18/12/05 | 18/12/05 |
| 343 | 6/09/06 | 9/04/06 | 200 | Pregnant | 15.96757 | 18/12/05 | 18/12/05 |
| 312 | 6/09/06 | 9/04/06 | 180 | Pregnant | 15.60129 | 20/12/05 | 20/12/05 |
| 329 | 6/09/06 | 9/04/06 | 160 | Pregnant | 15.235 | 23/12/05 | 23/12/05 |
| 603 | 3/09/06 | 11/04/06 | 170 | Pregnant | 15.41814 | 24/12/05 | 24/12/05 |
| 346 | 6/09/06 | 9/04/06 | 130 | Probably | 14.68557 | 27/12/05 | 27/11/05 |
| 820 | 27/08/06 | 11/04/06 | 500 | Pregnant | | | 17/11/05 |
| 403 | 28/08/06 | 10/04/06 | 500 | Pregnant | | | 18/11/05 |
| 404 | 28/08/06 | 10/04/06 | 400 | Pregnant | | | 18/11/05 |
| 550 | 2/09/06 | 11/04/06 | 700 | Pregnant | | | 23/11/05 |
| 678 | 2/09/06 | 11/04/06 | 600 | Pregnant | | | 23/11/05 |
| 310 | 6/09/06 | 9/04/06 | 500 | Pregnant | | | 27/11/05 |
| 348 | 6/09/06 | 9/04/06 | 600 | Pregnant | | | 27/11/05 |
| 81 | 9/09/06 | 5/04/06 | 500 | Pregnant | | | 30/11/05 |
| 770 | 27/08/06 | 11/04/06 | 300 | Pregnant | 17.799 | 7/12/05 | 18/11/05 |
| 753 | 27/08/06 | 11/04/06 | 700 | Pregnant | | | 18/11/05 |
| 519 | 2/09/06 | 11/04/06 | 500 | Pregnant | | | 24/11/05 |
| 794 | 27/08/06 | 11/04/06 | 600 | Pregnant | | | 19/11/05 |
| 283 | 2/10/06 | 6/04/06 | 100 | Probably | 14.13614 | 28/12/05 | 28/12/05 |
| 243 | 24/09/06 | 6/04/06 | 700 | Pregnant | | | 23/11/05 |
| 303 | 24/09/06 | 6/04/06 | 250 | Pregnant | 16.88329 | 8/12/05 | 24/11/05 |
| 57 | 29/09/06 | 5/04/06 | 160 | Pregnant | 15.235 | 19/12/05 | 4/12/05 |
| 518 | 1/09/06 | 11/04/06 | 500 | Pregnant | | | 18/11/05 |
| 388 | 10/09/06 | 10/04/06 | 700 | Pregnant | | | 28/11/05 |
| 503 | 1/09/06 | 11/04/06 | 300 | Pregnant | 17.799 | 7/12/05 | 20/11/05 |
| 278 | 3/09/06 | 6/04/06 | 600 | Pregnant | | | 22/11/05 |
| 106 | 1/09/06 | 5/04/06 | 200 | Pregnant | 15.96757 | 14/12/05 | 14/12/05 |
| 528 | 1/09/06 | 11/04/06 | 500 | Pregnant | | | 21/11/05 |
| 19 | 15/09/06 | 4/04/06 | 400 | Pregnant | | | 5/12/05 |
| 436 | 17/09/06 | 10/04/06 | 400 | Pregnant | | | 7/12/05 |
| 110 | 1/09/06 | 5/04/06 | 170 | Pregnant | 15.41814 | 18/12/05 | 18/12/05 |
| 470 | 31/08/06 | 10/04/06 | 900 | Pregnant | | | 21/11/05 |
| 20 | 1/09/06 | 4/04/06 | 1000 | Pregnant | | | 22/11/05 |
| 486 | 1/09/06 | 10/04/06 | 700 | Pregnant | | | 22/11/05 |
| 338 | 5/09/06 | 9/04/06 | 300 | Pregnant | 17.799 | 5/12/05 | 27/11/05 |
| 6 | 15/09/06 | 4/04/06 | 300 | Pregnant | 17.799 | 30/11/05 | 7/12/05 |
| 191 | 22/09/06 | 5/04/06 | 180 | Pregnant | 15.60129 | 16/12/05 | 14/12/05 |
| 333 | 5/09/06 | 9/04/06 | 220 | Pregnant | 16.33386 | 15/12/05 | 15/12/05 |
| 384 | 27/08/06 | 10/04/06 | 190 | Pregnant | 15.78443 | 20/12/05 | 20/12/05 |
| 315 | 27/08/06 | 9/04/06 | 170 | Pregnant | 15.41814 | 22/12/05 | 22/12/05 |
| 386 | 27/08/06 | 10/04/06 | 160 | Pregnant | 15.235 | 24/12/05 | 24/12/05 |
| 355 | 26/08/06 | 9/04/06 | 900 | Pregnant | | | 17/11/05 |
| 446 | 27/08/06 | 10/04/06 | 400 | Pregnant | | | 18/11/05 |
| 108 | 1/09/06 | 5/04/06 | 400 | Pregnant | | | 23/11/05 |
| 656 | 1/09/06 | 11/04/06 | 400 | Pregnant | | | 23/11/05 |
| 306 | 5/09/06 | 9/04/06 | 500 | Pregnant | | | 27/11/05 |
| 113 | 1/09/06 | 5/04/06 | 130 | Probably | 14.68557 | 23/12/05 | 23/12/05 |
| 686 | 1/09/06 | 11/04/06 | 700 | Pregnant | | | 24/11/05 |
| 409 | 27/08/06 | 10/04/06 | 250 | Pregnant | 16.88329 | 12/12/05 | 16/12/05 |
| 830 | 26/08/06 | 11/04/06 | 200 | Pregnant | 15.96757 | 20/12/05 | 20/12/05 |
| 726 | 26/08/06 | 11/04/06 | 180 | Pregnant | 15.60129 | 22/12/05 | 22/12/05 |
| 709 | 5/10/06 | 11/04/06 | 300 | Pregnant | 17.799 | 7/12/05 | 28/11/05 |
| 390 | 30/09/06 | 10/04/06 | 170 | Pregnant | 15.41814 | 23/12/05 | 23/12/05 |
| 689 | 28/09/06 | 11/04/06 | 170 | Pregnant | 15.41814 | 24/12/05 | 24/12/05 |
| 668 | 14/09/06 | 11/04/06 | 300 | Pregnant | 17.799 | 7/12/05 | 4/12/05 |
| 540 | 12/10/06 | 11/04/06 | 30 | Not confirmed | | | |
| 507 | 7/09/06 | 11/04/06 | 700 | Pregnant | | | 27/11/05 |
| 669 | 15/09/06 | 11/04/06 | 800 | Pregnant | | | 5/12/05 |
| 95 | 7/09/06 | 5/04/06 | 70 | Not confirmed | | | |
| 609 | 31/08/06 | 11/04/06 | 180 | Pregnant | 15.60129 | 22/12/05 | 22/12/05 |
| 605 | 1/09/06 | 11/04/06 | 160 | Pregnant | 15.235 | 25/12/05 | 25/12/05 |
| 673 | 1/09/06 | 11/04/06 | 150 | Pregnant | 15.05186 | 26/12/05 | 26/12/05 |
| 667 | 31/08/06 | 11/04/06 | 600 | Pregnant | | | 21/11/05 |
| 511 | 31/08/06 | 11/04/06 | 190 | Pregnant | 15.78443 | 21/12/05 | 21/12/05 |
| 582 | 31/08/06 | 11/04/06 | 900 | Pregnant | | | 22/11/05 |
| 627 | 14/09/06 | 11/04/06 | 190 | Pregnant | 15.78443 | 21/12/05 | 7/12/05 |
| 350 | 4/09/06 | 9/04/06 | 150 | Pregnant | 15.05186 | 24/12/05 | 24/12/05 |
| 397 | 26/08/06 | 10/04/06 | 200 | Pregnant | 15.96757 | 19/12/05 | 19/12/05 |
| 398 | 26/08/06 | 10/04/06 | 1000 | Pregnant | | | 18/11/05 |
| 683 | 31/08/06 | 11/04/06 | 500 | Pregnant | | | 23/11/05 |
| 34 | 14/09/06 | 4/04/06 | 400 | Pregnant | | | 7/12/05 |
| 87 | 24/08/06 | 5/04/06 | 190 | Pregnant | 15.78443 | 15/12/05 | 15/12/05 |
| 832 | 25/08/06 | 11/04/06 | 200 | Pregnant | 15.96757 | 20/12/05 | 20/12/05 |
| 664 | 24/08/06 | 11/04/06 | 400 | Pregnant | | | 17/11/05 |
| 693 | 24/08/06 | 11/04/06 | 600 | Pregnant | | | 17/11/05 |
| 674 | 31/08/06 | 11/04/06 | 400 | Pregnant | | | 24/11/05 |
| 103 | 14/09/06 | 5/04/06 | 110 | Probably | 14.31929 | 25/12/05 | 25/12/05 |
| 777 | 25/08/06 | 11/04/06 | 250 | Pregnant | 16.88329 | 13/12/05 | 17/12/05 |
| 803 | 1/09/06 | 11/04/06 | 100 | Probably | 14.13614 | 2/01/06 | 2/01/06 |
| 608 | 24/08/06 | 11/04/06 | 800 | Pregnant | | | 20/11/05 |
| 580 | 28/09/06 | 11/04/06 | 120 | Probably | 14.50243 | 30/12/05 | 30/12/05 |
| 122 | 14/09/06 | 5/04/06 | 60 | Not confirmed | | | |
| 242 | 22/09/06 | 6/04/06 | 400 | Pregnant | | | 22/11/05 |
| 129 | 18/10/06 | 5/04/06 | 20 | Not confirmed | | | |
| 710 | 20/09/06 | 11/04/06 | 300 | Pregnant | 17.799 | 7/12/05 | 10/12/05 |
| 690 | 30/08/06 | 11/04/06 | 600 | Pregnant | | | 19/11/05 |
| 653 | 30/08/06 | 11/04/06 | 300 | Pregnant | 17.799 | 7/12/05 | 20/11/05 |
| 1 | 13/09/06 | 4/04/06 | 300 | Pregnant | 17.799 | 30/11/05 | 4/12/05 |
| 520 | 30/08/06 | 11/04/06 | 600 | Pregnant | | | 20/11/05 |
| 223 | 1/09/06 | 6/04/06 | 1000 | Pregnant | | | 22/11/05 |
| 228 | 1/09/06 | 6/04/06 | 600 | Pregnant | | | 22/11/05 |
| 651 | 30/08/06 | 11/04/06 | 180 | Pregnant | 15.60129 | 22/12/05 | 22/12/05 |
| 659 | 30/08/06 | 11/04/06 | 170 | Pregnant | 15.41814 | 24/12/05 | 24/12/05 |
| 469 | 28/08/06 | 10/04/06 | 600 | Pregnant | | | 19/11/05 |
| 491 | 28/08/06 | 10/04/06 | 900 | Pregnant | | | 19/11/05 |
| 241 | 1/09/06 | 6/04/06 | 1000 | Pregnant | | | 23/11/05 |
| 394 | 25/08/06 | 10/04/06 | 300 | Pregnant | 17.799 | 6/12/05 | 17/11/05 |
| 522 | 30/08/06 | 11/04/06 | 600 | Pregnant | | | 22/11/05 |
| 529 | 30/08/06 | 11/04/06 | 600 | Pregnant | | | 22/11/05 |
| 574 | 30/08/06 | 11/04/06 | 800 | Pregnant | | | 22/11/05 |
| 421 | 6/10/06 | 10/04/06 | 120 | Probably | 14.50243 | 29/12/05 | 29/12/05 |
| 405 | 8/09/06 | 10/04/06 | 190 | Pregnant | 15.78443 | 20/12/05 | 20/12/05 |
| 190 | 26/08/06 | 5/04/06 | 1000 | Pregnant | | | 19/11/05 |
| 114 | 30/08/06 | 5/04/06 | 700 | Pregnant | | | 23/11/05 |
| 672 | 30/08/06 | 11/04/06 | 400 | Pregnant | | | 23/11/05 |
| 293 | 1/09/06 | 6/04/06 | 900 | Pregnant | | | 25/11/05 |
| 332 | 3/09/06 | 9/04/06 | 700 | Pregnant | | | 27/11/05 |
| 339 | 7/09/06 | 9/04/06 | 700 | Pregnant | | | 1/12/05 |
| 473 | 26/09/06 | 10/04/06 | 190 | Pregnant | 15.78443 | 20/12/05 | 20/12/05 |
| 119 | 30/08/06 | 5/04/06 | 200 | Pregnant | 15.96757 | 14/12/05 | 14/12/05 |
| 29 | 23/08/06 | 4/04/06 | 500 | Pregnant | | | 17/11/05 |
| 576 | 30/08/06 | 11/04/06 | 500 | Pregnant | | | 24/11/05 |
| 21 | 6/09/06 | 4/04/06 | 600 | Pregnant | | | 1/12/05 |
| 784 | 24/08/06 | 11/04/06 | 900 | Pregnant | | | 19/11/05 |
| 702 | 4/10/06 | 11/04/06 | 110 | Probably | 14.31929 | 31/12/05 | 31/12/05 |
| 70 | 12/09/06 | 5/04/06 | 70 | Not confirmed | | | |
| 31 | 12/09/06 | 4/04/06 | 160 | Pregnant | 15.235 | 18/12/05 | 2/12/05 |
| 12 | 19/09/06 | 4/04/06 | 160 | Pregnant | 15.235 | 18/12/05 | 9/12/05 |
| 515 | 29/08/06 | 11/04/06 | 250 | Pregnant | 16.88329 | 13/12/05 | 15/12/05 |
| 23 | 5/09/06 | 4/04/06 | 1000 | Pregnant | | | 25/11/05 |
| 729 | 30/08/06 | 11/04/06 | 800 | Pregnant | | | 20/11/05 |
| 448 | 21/09/06 | 10/04/06 | 150 | Pregnant | 15.05186 | 25/12/05 | 13/12/05 |
| 444 | 7/09/06 | 10/04/06 | 500 | Pregnant | | | 29/11/05 |
| 745 | 20/09/06 | 11/04/06 | 700 | Pregnant | | | 12/12/05 |
| 612 | 29/08/06 | 11/04/06 | 190 | Pregnant | 15.78443 | 21/12/05 | 21/12/05 |
| 671 | 29/08/06 | 11/04/06 | 1000 | Pregnant | | | 21/11/05 |
| 685 | 29/08/06 | 11/04/06 | 400 | Pregnant | | | 21/11/05 |
| 698 | 29/08/06 | 11/04/06 | 500 | Pregnant | | | 21/11/05 |
| 704 | 29/08/06 | 11/04/06 | 700 | Pregnant | | | 21/11/05 |
| 646 | 12/09/06 | 11/04/06 | 300 | Pregnant | 17.799 | 7/12/05 | 6/12/05 |
| 513 | 29/08/06 | 11/04/06 | 400 | Pregnant | | | 22/11/05 |
| 377 | 24/08/06 | 10/04/06 | 300 | Pregnant | 17.799 | 6/12/05 | 18/11/05 |
| 193 | 5/09/06 | 5/04/06 | 300 | Pregnant | 17.799 | 1/12/05 | 30/11/05 |
| 361 | 2/09/06 | 9/04/06 | 150 | Pregnant | 15.05186 | 24/12/05 | 24/12/05 |
| 322 | 7/09/06 | 9/04/06 | 130 | Probably | 14.68557 | 27/12/05 | 2/12/05 |
| 797 | 23/08/06 | 11/04/06 | 160 | Pregnant | 15.235 | 25/12/05 | 25/12/05 |
| 382 | 24/08/06 | 10/04/06 | 400 | Pregnant | | | 18/11/05 |
| 432 | 24/08/06 | 10/04/06 | 400 | Pregnant | | | 18/11/05 |
| 584 | 29/08/06 | 11/04/06 | 900 | Pregnant | | | 23/11/05 |
| 525 | 5/09/06 | 11/04/06 | 400 | Pregnant | | | 30/11/05 |
| 728 | 23/08/06 | 11/04/06 | 700 | Pregnant | | | 18/11/05 |
| 429 | 24/08/06 | 10/04/06 | 1000 | Pregnant | | | 19/11/05 |
| 26 | 29/08/06 | 4/04/06 | 800 | Pregnant | | | 24/11/05 |
| 818 | 30/08/06 | 11/04/06 | 180 | Pregnant | 15.60129 | 22/12/05 | 22/12/05 |
| 655 | 29/08/06 | 11/04/06 | 110 | Probably | 14.31929 | 31/12/05 | 31/12/05 |
| 691 | 11/09/06 | 11/04/06 | 200 | Pregnant | 15.96757 | 20/12/05 | 20/12/05 |
| 670 | 28/08/06 | 11/04/06 | 400 | Pregnant | | | 19/11/05 |
| 552 | 4/09/06 | 11/04/06 | 180 | Pregnant | 15.60129 | 22/12/05 | 22/12/05 |
| 531 | 28/08/06 | 11/04/06 | 500 | Pregnant | | | 20/11/05 |
| 714 | 28/08/06 | 11/04/06 | 800 | Pregnant | | | 20/11/05 |
| 555 | 29/08/06 | 11/04/06 | 900 | Pregnant | | | 21/11/05 |
| 262 | 30/08/06 | 6/04/06 | 900 | Pregnant | | | 22/11/05 |
| 300 | 30/08/06 | 6/04/06 | 500 | Pregnant | | | 22/11/05 |
| 51 | 4/09/06 | 4/04/06 | 700 | Pregnant | | | 27/11/05 |
| 383 | 6/09/06 | 10/04/06 | 500 | Pregnant | | | 29/11/05 |
| 788 | 19/09/06 | 11/04/06 | 700 | Pregnant | | | 12/12/05 |
| 566 | 28/08/06 | 11/04/06 | 200 | Pregnant | 15.96757 | 20/12/05 | 20/12/05 |
| 504 | 28/08/06 | 11/04/06 | 500 | Pregnant | | | 21/11/05 |
| 420 | 23/08/06 | 10/04/06 | 160 | Pregnant | 15.235 | 24/12/05 | 24/12/05 |
| 578 | 28/08/06 | 11/04/06 | 700 | Pregnant | | | 22/11/05 |
| 581 | 28/08/06 | 11/04/06 | 1000 | Pregnant | | | 22/11/05 |
| 583 | 28/08/06 | 11/04/06 | 600 | Pregnant | | | 22/11/05 |
| 742 | 22/08/06 | 11/04/06 | 400 | Pregnant | | | 17/11/05 |
| 370 | 23/08/06 | 10/04/06 | 400 | Pregnant | | | 18/11/05 |
| 662 | 28/08/06 | 11/04/06 | 1000 | Pregnant | | | 23/11/05 |
| 675 | 28/08/06 | 11/04/06 | 700 | Pregnant | | | 23/11/05 |
| 313 | 1/09/06 | 9/04/06 | 400 | Pregnant | | | 27/11/05 |
| 732 | 22/08/06 | 11/04/06 | 500 | Pregnant | | | 18/11/05 |
| 407 | 23/08/06 | 10/04/06 | 700 | Pregnant | | | 19/11/05 |
| 74 | 25/09/06 | 5/04/06 | 90 | Not confirmed | | | |
| 289 | 19/09/06 | 6/04/06 | 600 | Pregnant | | | 21/11/05 |
| 677 | 3/09/06 | 11/04/06 | 600 | Pregnant | | | 24/11/05 |
| 695 | 27/08/06 | 11/04/06 | 500 | Pregnant | | | 18/11/05 |
| 64 | 3/09/06 | 5/04/06 | 190 | Pregnant | 15.78443 | 15/12/05 | 15/12/05 |
| 631 | 3/09/06 | 11/04/06 | 170 | Pregnant | 15.41814 | 24/12/05 | 24/12/05 |
| 607 | 27/08/06 | 11/04/06 | 150 | Pregnant | 15.05186 | 26/12/05 | 26/12/05 |
| 638 | 10/09/06 | 11/04/06 | 500 | Pregnant | | | 3/12/05 |
| 636 | 27/08/06 | 11/04/06 | 250 | Pregnant | 16.88329 | 13/12/05 | 15/12/05 |
| 828 | 28/08/06 | 11/04/06 | 600 | Pregnant | | | 21/11/05 |
| 292 | 29/08/06 | 6/04/06 | 800 | Pregnant | | | 22/11/05 |
| 505 | 3/09/06 | 11/04/06 | 220 | Pregnant | 16.33386 | 17/12/05 | 17/12/05 |
| 635 | 27/08/06 | 11/04/06 | 250 | Pregnant | 16.88329 | 13/12/05 | 15/12/05 |
| 524 | 27/08/06 | 11/04/06 | 800 | Pregnant | | | 21/11/05 |
| 577 | 27/08/06 | 11/04/06 | 600 | Pregnant | | | 21/11/05 |
| 658 | 27/08/06 | 11/04/06 | 500 | Pregnant | | | 21/11/05 |
| 225 | 29/08/06 | 6/04/06 | 800 | Pregnant | | | 23/11/05 |
| 254 | 29/08/06 | 6/04/06 | 600 | Pregnant | | | 23/11/05 |
| 587 | 3/09/06 | 11/04/06 | 500 | Pregnant | | | 28/11/05 |
| 220 | 29/08/06 | 6/04/06 | 300 | Pregnant | 17.799 | 2/12/05 | 24/11/05 |
| 756 | 4/09/06 | 11/04/06 | 300 | Pregnant | 17.799 | 7/12/05 | 30/11/05 |
| 85 | 10/09/06 | 5/04/06 | 120 | Probably | 14.50243 | 24/12/05 | 24/12/05 |
| 97 | 10/09/06 | 5/04/06 | 120 | Probably | 14.50243 | 24/12/05 | 24/12/05 |
| 586 | 27/08/06 | 11/04/06 | 500 | Pregnant | | | 22/11/05 |
| 696 | 27/08/06 | 11/04/06 | 1000 | Pregnant | | | 22/11/05 |
| 763 | 28/08/06 | 11/04/06 | 800 | Pregnant | | | 23/11/05 |
| 440 | 22/08/06 | 10/04/06 | 180 | Pregnant | 15.60129 | 21/12/05 | 21/12/05 |
| 731 | 21/08/06 | 11/04/06 | 400 | Pregnant | | | 17/11/05 |
| 815 | 21/08/06 | 11/04/06 | 500 | Pregnant | | | 17/11/05 |
| 418 | 22/08/06 | 10/04/06 | 600 | Pregnant | | | 18/11/05 |
| 621 | 20/08/06 | 11/04/06 | 400 | Pregnant | | | 17/11/05 |
| 684 | 20/08/06 | 11/04/06 | 700 | Pregnant | | | 17/11/05 |
| 639 | 27/08/06 | 11/04/06 | 50 | Not confirmed | | | |
| 614 | 23/09/06 | 11/04/06 | 400 | Pregnant | | | 27/11/05 |
| 652 | 26/08/06 | 11/04/06 | 140 | Probably | 14.86871 | 27/12/05 | 27/12/05 |
| 692 | 26/08/06 | 11/04/06 | 400 | Pregnant | | | 18/11/05 |
| 32 | 9/09/06 | 4/04/06 | 600 | Pregnant | | | 2/12/05 |
| 747 | 27/08/06 | 11/04/06 | 300 | Pregnant | 17.799 | 7/12/05 | 20/11/05 |
| 641 | 9/09/06 | 11/04/06 | 250 | Pregnant | 16.88329 | 13/12/05 | 3/12/05 |
| 665 | 16/09/06 | 11/04/06 | 150 | Pregnant | 15.05186 | 26/12/05 | 10/12/05 |
| 401 | 18/09/06 | 10/04/06 | 200 | Pregnant | 15.96757 | 19/12/05 | 12/12/05 |
| 542 | 8/10/06 | 11/04/06 | 70 | Not confirmed | | | |
| 535 | 2/09/06 | 11/04/06 | 600 | Pregnant | | | 26/11/05 |
| 782 | 3/09/06 | 11/04/06 | 600 | Pregnant | | | 27/11/05 |
| 633 | 26/08/06 | 11/04/06 | 300 | Pregnant | 17.799 | 7/12/05 | 20/11/05 |
| 560 | 26/08/06 | 11/04/06 | 700 | Pregnant | | | 20/11/05 |
| 606 | 2/09/06 | 11/04/06 | 400 | Pregnant | | | 27/11/05 |
| 73 | 26/08/06 | 5/04/06 | 150 | Pregnant | 15.05186 | 20/12/05 | 20/12/05 |
| 700 | 26/08/06 | 11/04/06 | 600 | Pregnant | | | 21/11/05 |
| 351 | 30/08/06 | 9/04/06 | 150 | Pregnant | 15.05186 | 24/12/05 | 24/12/05 |
| 373 | 21/08/06 | 10/04/06 | 190 | Pregnant | 15.78443 | 20/12/05 | 20/12/05 |
| 308 | 20/08/06 | 9/04/06 | 700 | Pregnant | | | 17/11/05 |
| 354 | 2/10/06 | 9/04/06 | 100 | Probably | 14.13614 | 31/12/05 | 30/12/05 |
| 563 | 19/08/06 | 11/04/06 | 800 | Pregnant | | | 17/11/05 |
| 663 | 26/08/06 | 11/04/06 | 400 | Pregnant | | | 24/11/05 |
| 766 | 24/09/06 | 11/04/06 | 90 | Not confirmed | | | |
| 767 | 2/09/06 | 11/04/06 | 220 | Pregnant | 16.33386 | 17/12/05 | 17/12/05 |
| 88 | 1/09/06 | 5/04/06 | 300 | Pregnant | 17.799 | 1/12/05 | 26/11/05 |
| 618 | 25/08/06 | 11/04/06 | 500 | Pregnant | | | 19/11/05 |
| 805 | 26/08/06 | 11/04/06 | 500 | Pregnant | | | 20/11/05 |
| 829 | 26/08/06 | 11/04/06 | 500 | Pregnant | | | 20/11/05 |
| 78 | 6/10/06 | 5/04/06 | 70 | Not confirmed | | | |
| 719 | 16/09/06 | 11/04/06 | 500 | Pregnant | | | 12/12/05 |
| 715 | 1/09/06 | 11/04/06 | 140 | Probably | 14.86871 | 27/12/05 | 27/12/05 |
| 611 | 25/08/06 | 11/04/06 | 300 | Pregnant | 17.799 | 7/12/05 | 22/11/05 |
| 660 | 25/08/06 | 11/04/06 | 400 | Pregnant | | | 22/11/05 |
| 808 | 19/08/06 | 11/04/06 | 300 | Pregnant | 17.799 | 7/12/05 | 17/11/05 |
| 760 | 19/08/06 | 11/04/06 | 700 | Pregnant | | | 17/11/05 |
| 314 | 7/09/06 | 9/04/06 | 600 | Pregnant | | | 6/12/05 |
| 744 | 22/09/06 | 11/04/06 | 180 | Pregnant | 15.60129 | 22/12/05 | 13/12/05 |
| 532 | 24/08/06 | 11/04/06 | 700 | Pregnant | | | 18/11/05 |
| 707 | 24/08/06 | 11/04/06 | 700 | Pregnant | | | 18/11/05 |
| 2 | 24/08/06 | 4/04/06 | 700 | Pregnant | | | 19/11/05 |
| 579 | 24/08/06 | 11/04/06 | 600 | Pregnant | | | 19/11/05 |
| 649 | 24/08/06 | 11/04/06 | 400 | Pregnant | | | 19/11/05 |
| 423 | 26/08/06 | 10/04/06 | 700 | Pregnant | | | 21/11/05 |
| 654 | 24/08/06 | 11/04/06 | 150 | Pregnant | 15.05186 | 26/12/05 | 26/12/05 |
| 749 | 15/09/06 | 11/04/06 | 800 | Pregnant | | | 12/12/05 |
| 835 | 25/08/06 | 11/04/06 | 160 | Pregnant | 15.235 | 25/12/05 | 25/12/05 |
| 467 | 23/08/06 | 10/04/06 | 1000 | Pregnant | | | 20/11/05 |
| 610 | 24/08/06 | 11/04/06 | 700 | Pregnant | | | 22/11/05 |
| 722 | 18/08/06 | 11/04/06 | 300 | Pregnant | 17.799 | 7/12/05 | 17/11/05 |
| 823 | 25/08/06 | 11/04/06 | 700 | Pregnant | | | 24/11/05 |
| 37 | 24/08/06 | 4/04/06 | 700 | Pregnant | | | 23/11/05 |
| 496 | 15/08/06 | 10/04/06 | 600 | Pregnant | | | 17/11/05 |
| 195 | 2/09/06 | 5/04/06 | 120 | Probably | 14.50243 | 24/12/05 | 24/12/05 |
| 802 | 14/09/06 | 11/04/06 | 110 | Probably | 14.31929 | 31/12/05 | 31/12/05 |
| 790 | 24/08/06 | 11/04/06 | 1000 | Pregnant | | | 20/11/05 |
| 117 | 23/08/06 | 5/04/06 | 180 | Pregnant | 15.60129 | 16/12/05 | 16/12/05 |
| 650 | 23/08/06 | 11/04/06 | 600 | Pregnant | | | 21/11/05 |
| 301 | 1/09/06 | 6/04/06 | 500 | Pregnant | | | 30/11/05 |
| 632 | 23/08/06 | 11/04/06 | 190 | Pregnant | 15.78443 | 21/12/05 | 21/12/05 |
| 833 | 30/08/06 | 11/04/06 | 400 | Pregnant | | | 18/11/05 |
| 500 | 27/08/06 | 10/04/06 | 400 | Pregnant | | | 20/11/05 |
| 46 | 29/08/06 | 4/04/06 | 400 | Pregnant | | | 25/11/05 |
| 721 | 23/08/06 | 11/04/06 | 1000 | Pregnant | | | 20/11/05 |
| 751 | 23/08/06 | 11/04/06 | 1000 | Pregnant | | | 20/11/05 |
| 783 | 23/08/06 | 11/04/06 | 400 | Pregnant | | | 20/11/05 |
| 734 | 13/09/06 | 11/04/06 | 500 | Pregnant | | | 12/12/05 |
| 360 | 26/08/06 | 9/04/06 | 600 | Pregnant | | | 27/11/05 |
| 455 | 9/10/06 | 10/04/06 | 700 | Pregnant | | | 19/11/05 |
| 746 | 19/09/06 | 11/04/06 | 400 | Pregnant | | | 13/12/05 |
| 25 | 21/08/06 | 4/04/06 | 180 | Pregnant | 15.60129 | 15/12/05 | 15/12/05 |
| 711 | 21/08/06 | 11/04/06 | 400 | Pregnant | | | 19/11/05 |
| 679 | 21/08/06 | 11/04/06 | 250 | Pregnant | 16.88329 | 13/12/05 | 15/12/05 |
| 681 | 21/08/06 | 11/04/06 | 500 | Pregnant | | | 20/11/05 |
| 52 | 4/09/06 | 4/04/06 | 150 | Pregnant | 15.05186 | 19/12/05 | 7/12/05 |
| 703 | 21/08/06 | 11/04/06 | 300 | Pregnant | 17.799 | 7/12/05 | 8/12/05 |
| 642 | 20/08/06 | 11/04/06 | 200 | Pregnant | 15.96757 | 20/12/05 | 20/12/05 |
| 396 | 3/10/06 | 10/04/06 | 100 | Probably | 14.13614 | 1/01/06 | 1/01/06 |
| 15 | 27/08/06 | 4/04/06 | 250 | Pregnant | 16.88329 | 6/12/05 | 26/11/05 |
| 464 | 1/09/06 | 10/04/06 | 1000 | Pregnant | | | 21/11/05 |
| 61 | 7/10/06 | 5/04/06 | 20 | Not confirmed | | | |
| 812 | 20/08/06 | 11/04/06 | 800 | Pregnant | | | 20/11/05 |
| 471 | 12/10/06 | 10/04/06 | 50 | Not confirmed | | | |
| 493 | 23/08/06 | 10/04/06 | 1000 | Pregnant | | | 18/11/05 |
| 452 | 23/08/06 | 10/04/06 | 400 | Pregnant | | | 20/11/05 |
| 701 | 1/09/06 | 11/04/06 | 600 | Pregnant | | | 6/12/05 |
| 277 | 2/09/06 | 6/04/06 | 250 | Pregnant | 16.88329 | 8/12/05 | 22/11/05 |
| 232 | 1/09/06 | 6/04/06 | 500 | Pregnant | | | 20/11/05 |
| 489 | 18/09/06 | 10/04/06 | 180 | Pregnant | 15.60129 | 21/12/05 | 21/12/05 |
| 344 | 20/08/06 | 9/04/06 | 250 | Pregnant | 16.88329 | 11/12/05 | 27/11/05 |
| 814 | 23/08/06 | 11/04/06 | 800 | Pregnant | | | 17/11/05 |
| 76 | 26/09/06 | 5/04/06 | 70 | Not confirmed | | | |
| 428 | 30/08/06 | 10/04/06 | 500 | Pregnant | | | 18/11/05 |
| 688 | 13/08/06 | 11/04/06 | 210 | Pregnant | 16.15071 | 18/12/05 | 18/12/05 |
| 419 | 28/08/06 | 10/04/06 | 800 | Pregnant | | | 25/11/05 |
| 309 | 16/08/06 | 9/04/06 | 220 | Pregnant | 16.33386 | 15/12/05 | 15/12/05 |
| 49 | 11/08/06 | 4/04/06 | 400 | Pregnant | | | 10/12/05 |
| 512 | 1/09/06 | 11/04/06 | 30 | Not confirmed | | | |
| 725 | 25/08/06 | 11/04/06 | 800 | Pregnant | | | 21/11/05 |
| 121 | 30/08/06 | 5/04/06 | 160 | Pregnant | 15.235 | 19/12/05 | 19/12/05 |
| 443 | 25/08/06 | 10/04/06 | 400 | Pregnant | | | 17/11/05 |
| 634 | 9/08/06 | 11/04/06 | 150 | Pregnant | 15.05186 | 26/12/05 | 26/12/05 |
| 393 | 24/08/06 | 10/04/06 | 800 | Pregnant | | | 17/11/05 |
| 708 | 28/08/06 | 11/04/06 | 600 | Pregnant | | | 19/11/05 |
| 616 | 27/08/06 | 11/04/06 | 300 | Pregnant | 17.799 | 7/12/05 | 22/11/05 |
| 48 | 20/08/06 | 4/04/06 | 800 | Pregnant | | | 5/12/05 |
| 759 | 27/08/06 | 11/04/06 | 800 | Pregnant | | | 19/11/05 |
| 569 | 26/08/06 | 11/04/06 | 800 | Pregnant | | | 19/11/05 |
| 221 | 29/07/06 | 6/04/06 | 190 | Pregnant | 15.78443 | 16/12/05 | 16/12/05 |
| 694 | 2/08/06 | 11/04/06 | 700 | Pregnant | | | 22/11/05 |
| 465 | 10/10/06 | 10/04/06 | 500 | Pregnant | | | 21/11/05 |
| 458 | 22/08/06 | 10/04/06 | 1000 | Pregnant | | | 18/11/05 |
| 501 | 25/08/06 | 11/04/06 | 500 | Pregnant | | | 21/11/05 |
| 595 | 2/08/06 | 11/04/06 | 300 | Pregnant | 17.799 | 7/12/05 | 24/11/05 |
| 297 | 8/09/06 | 6/04/06 | 20 | Not confirmed | | | |
| 380 | 1/09/06 | 10/04/06 | 50 | Not confirmed | | | |
| 111 | 27/09/06 | 5/04/06 | 140 | Probably | 14.86871 | 21/12/05 | 9/12/05 |
| 378 | 11/09/06 | 10/04/06 | 170 | Pregnant | 15.41814 | 23/12/05 | 23/12/05 |
| 137 | 4/09/06 | 5/04/06 | 700 | Pregnant | | | 18/11/05 |
| 186 | 26/09/06 | 5/04/06 | 140 | Probably | 14.86871 | 21/12/05 | 11/12/05 |
| 158 | 3/09/06 | 5/04/06 | 1000 | Pregnant | | | 18/11/05 |
| 648 | 5/09/06 | 11/04/06 | 190 | Pregnant | 15.78443 | 21/12/05 | 21/12/05 |
| 182 | 3/09/06 | 5/04/06 | 900 | Pregnant | | | 19/11/05 |
| 167 | 17/09/06 | 5/04/06 | 700 | Pregnant | | | 5/12/05 |
| 152 | 17/09/06 | 5/04/06 | 170 | Pregnant | 15.41814 | 18/12/05 | 6/12/05 |
| 204 | 23/09/06 | 5/04/06 | 110 | Probably | 14.31929 | 25/12/05 | 12/12/05 |
| 196 | 3/09/06 | 5/04/06 | 190 | Pregnant | 15.78443 | 15/12/05 | 15/12/05 |
| 203 | 25/09/06 | 5/04/06 | 1000 | Pregnant | | | 14/12/05 |
| 171 | 28/08/06 | 5/04/06 | 1000 | Pregnant | | | 17/11/05 |
| 170 | 31/08/06 | 5/04/06 | 400 | Pregnant | | | 20/11/05 |
| 164 | 10/09/06 | 5/04/06 | 600 | Pregnant | | | 30/11/05 |
| 188 | 27/08/06 | 5/04/06 | 1000 | Pregnant | | | 17/11/05 |
| 392 | 28/08/06 | 10/04/06 | 300 | Pregnant | 17.799 | 6/12/05 | 18/11/05 |
| 184 | 29/08/06 | 5/04/06 | 500 | Pregnant | | | 19/11/05 |
| 198 | 29/08/06 | 5/04/06 | 500 | Pregnant | | | 19/11/05 |
| 154 | 26/08/06 | 5/04/06 | 400 | Pregnant | | | 17/11/05 |
| 145 | 28/08/06 | 5/04/06 | 1000 | Pregnant | | | 19/11/05 |
| 175 | 28/08/06 | 5/04/06 | 600 | Pregnant | | | 19/11/05 |
| 177 | 11/09/06 | 5/04/06 | 700 | Pregnant | | | 3/12/05 |
| 172 | 25/08/06 | 5/04/06 | 1000 | Pregnant | | | 17/11/05 |
| 148 | 26/08/06 | 5/04/06 | 900 | Pregnant | | | 18/11/05 |
| 139 | 29/08/06 | 5/04/06 | 700 | Pregnant | | | 21/11/05 |
| 153 | 26/08/06 | 5/04/06 | 300 | Pregnant | 17.799 | 1/12/05 | 19/11/05 |
| 147 | 24/08/06 | 5/04/06 | 400 | Pregnant | | | 17/11/05 |
| 570 | 29/08/06 | 11/04/06 | 900 | Pregnant | | | 22/11/05 |
| 173 | 26/08/06 | 5/04/06 | 300 | Pregnant | 17.799 | 1/12/05 | 20/11/05 |
| 144 | 24/08/06 | 5/04/06 | 1000 | Pregnant | | | 18/11/05 |
| 209 | 24/08/06 | 5/04/06 | 900 | Pregnant | | | 18/11/05 |
| 187 | 27/08/06 | 5/04/06 | 800 | Pregnant | | | 21/11/05 |
| 174 | 20/09/06 | 5/04/06 | 700 | Pregnant | | | 15/12/05 |
| 194 | 17/09/06 | 5/04/06 | 180 | Pregnant | 15.60129 | 16/12/05 | 13/12/05 |
| 142 | 22/08/06 | 5/04/06 | 600 | Pregnant | | | 18/11/05 |
| 150 | 21/08/06 | 5/04/06 | 700 | Pregnant | | | 18/11/05 |
| 138 | 25/08/06 | 5/04/06 | 800 | Pregnant | | | 22/11/05 |
| 146 | 29/08/06 | 5/04/06 | 800 | Pregnant | | | 27/11/05 |
| 168 | 30/08/06 | 5/04/06 | 300 | Pregnant | 17.799 | 1/12/05 | 30/11/05 |
| 202 | 27/08/06 | 5/04/06 | 500 | Pregnant | | | 27/11/05 |
| 739 | 1/09/06 | 11/04/06 | 20 | Not confirmed | | | |
| 544 | 15/09/06 | 11/04/06 | 20 | Not confirmed | | | |
| 645 | 25/09/06 | 11/04/06 | 120 | Probably | 14.50243 | 30/12/05 | 30/12/05 |
| 83 | 26/09/06 | 5/04/06 | 20 | Not confirmed | | | |
| 99 | 27/09/06 | 5/04/06 | 20 | Not confirmed | | | |
| 100 | 2/10/06 | 5/04/06 | 20 | Not confirmed | | | |
| 104 | 5/10/06 | 5/04/06 | 50 | Not confirmed | | | |
| 143 | 9/10/06 | 5/04/06 | 70 | Not confirmed | | | |
| 69 | 11/10/06 | 5/04/06 | 90 | Not confirmed | | | |
| 197 | 14/10/06 | 5/04/06 | 70 | Not confirmed | | | |
| 472 | 14/11/06 | 10/04/06 | 70 | Not confirmed | | | |

| | Second Estrone Sulfate Test | | | | | Mating details | |
|---|---|---|---|---|---|---|---|
| Cow | Test | ES | | Weeks | | Last | Herd |
| ID | Date | pg/mL | Diagnosis | Pregnant | ECD | Mating | Last Al |
| 517 | | | Pregnant | | | 2/12/05 | 14/12/05 |
| 63 | 11/05/06 | 500 | Pregnant | | | 6/12/05 | 14/12/05 |
| 84 | 11/05/06 | 170 | Pregnant | 15.41814 | 23/01/06 | 5/12/05 | 14/12/05 |
| 90 | 11/05/06 | 250 | Pregnant | 16.88329 | 12/01/06 | 25/11/05 | 14/12/05 |
| 134 | 11/05/06 | 180 | Pregnant | 15.60129 | 21/01/06 | 28/11/05 | 14/12/05 |
| 93 | 11/05/06 | 160 | Pregnant | 15.235 | 24/01/06 | 3/12/05 | 14/12/05 |
| 433 | | | Pregnant | | | 28/11/05 | 15/12/05 |
| 217 | | | Pregnant | | | 23/11/05 | 30/11/05 |
| 77 | 11/05/06 | 800 | Pregnant | | | 20/11/05 | 14/12/05 |
| 716 | | | Pregnant | | | 12/12/05 | 16/12/05 |
| 120 | 11/05/06 | 500 | Pregnant | | | 26/11/05 | 14/12/05 |
| 791 | | | Pregnant | | | 18/11/05 | 16/12/05 |
| 687 | | | Pregnant | | | 17/11/05 | 14/12/05 |
| 105 | 11/05/06 | 600 | Pregnant | | | 22/11/05 | 14/12/05 |
| 796 | | | Pregnant | | | 28/11/05 | 16/12/05 |
| 80 | | | Pregnant | | | 6/12/05 | 14/12/05 |
| 764 | | | Pregnant | | | 25/11/05 | 16/12/05 |
| 765 | | | Pregnant | | | 13/12/05 | 16/12/05 |
| 115 | 11/05/06 | 250 | Pregnant | 16.88329 | 12/01/06 | 3/12/05 | 14/12/05 |
| 460 | | | Pregnant | | | 17/11/05 | 23/11/05 |
| 497 | | | Pregnant | | | 17/11/05 | 23/11/05 |
| 457 | | | Pregnant | | | 18/11/05 | 23/11/05 |
| 740 | | | Pregnant | | | 13/12/05 | 16/12/05 |
| 426 | 10/05/06 | 600 | Pregnant | | | 1/12/05 | 15/12/05 |
| 132 | | | Probably | | | 14/12/05 | 14/12/05 |
| 723 | | | Pregnant | | | 12/12/05 | 16/12/05 |
| 793 | 9/05/06 | 700 | Pregnant | | | 20/11/05 | 16/12/05 |
| 795 | | | Pregnant | | | 12/12/05 | 16/12/05 |
| 480 | 11/05/06 | 180 | Pregnant | 15.60129 | 21/01/06 | 17/11/05 | 23/11/05 |
| 571 | | | Pregnant | | | 21/11/05 | 14/12/05 |
| 127 | 11/05/06 | 400 | Pregnant | | | 19/11/05 | 14/12/05 |
| 559 | 16/05/06 | 200 | Pregnant | 15.96757 | 24/01/06 | 22/11/05 | 14/12/05 |
| 562 | | | Pregnant | | | 22/11/05 | 14/12/05 |
| 798 | 9/05/06 | 600 | Pregnant | | | 12/12/05 | 16/12/05 |
| 71 | 11/05/06 | 120 | Probably | 14.50243 | 29/01/06 | 18/11/05 | 14/12/05 |
| 372 | 10/05/06 | 400 | Pregnant | | | 28/11/05 | 15/12/05 |
| 772 | | | Pregnant | | | 19/11/05 | 16/12/05 |
| 124 | 11/05/06 | 800 | Pregnant | | | 21/11/05 | 14/12/05 |
| 102 | 11/05/06 | 160 | Pregnant | 15.235 | 24/01/06 | 11/12/05 | 14/12/05 |
| 510 | | | Pregnant | | | 21/11/05 | 14/12/05 |
| 59 | 11/05/06 | 190 | Pregnant | 15.78443 | 20/01/06 | 6/12/05 | 14/12/05 |
| 487 | | | Pregnant | | | 22/11/05 | 23/11/05 |
| 807 | | | Pregnant | | | 24/11/05 | 16/12/05 |
| 461 | | | Pregnant | | | 21/11/05 | 23/11/05 |
| 778 | | | Pregnant | | | 18/11/05 | 16/12/05 |
| 508 | | | Pregnant | | | 21/11/05 | 14/12/05 |
| 492 | | | Pregnant | | | 21/11/05 | 23/11/05 |
| 109 | 11/05/06 | 180 | Pregnant | 15.60129 | 21/01/06 | 24/11/05 | 14/12/05 |
| 410 | | | Pregnant | | | 18/11/05 | 15/12/05 |
| 337 | 9/05/06 | 190 | Pregnant | 15.78443 | 18/01/06 | 27/11/05 | 16/01/06 |
| 484 | | | Pregnant | | | 21/11/05 | 23/11/05 |
| 810 | | | Pregnant | | | 13/12/05 | 16/12/05 |
| 379 | 10/05/06 | 200 | Pregnant | 15.96757 | 18/01/06 | 5/12/05 | 15/12/05 |
| 408 | 10/05/06 | 400 | Pregnant | | | 12/12/05 | 15/12/05 |
| 502 | | | Pregnant | | | 21/11/05 | 14/12/05 |
| 347 | | | Pregnant | | | 27/11/05 | 16/01/06 |
| 737 | | | Pregnant | | | 13/12/05 | 16/12/05 |
| 425 | | | Pregnant | | | 25/11/05 | 15/12/05 |
| 269 | | | Pregnant | | | 22/11/05 | 30/11/05 |
| 368 | | | Pregnant | | | 17/11/05 | 15/12/05 |
| 362 | | | Pregnant | | | 27/11/05 | 16/01/06 |
| 67 | 11/05/06 | 500 | Pregnant | | | 1/12/05 | 14/12/05 |
| 302 | | | Pregnant | | | 18/11/05 | 30/11/05 |
| 288 | | | Pregnant | | | 23/11/05 | 30/11/05 |
| 311 | | | Pregnant | | | 27/11/05 | 16/01/06 |
| 112 | | | Pregnant | | | 23/11/05 | 14/12/05 |
| 450 | | | Pregnant | | | 18/11/05 | 15/12/05 |
| 320 | | | Pregnant | | | 27/11/05 | 16/01/06 |
| 661 | | | Pregnant | | | 21/11/05 | 14/12/05 |
| 135 | 11/05/06 | 300 | Pregnant | 17.799 | 6/01/06 | 21/11/05 | 14/12/05 |
| 441 | 10/05/06 | 170 | Pregnant | 15.41814 | 22/01/06 | 4/12/05 | 15/12/05 |
| 453 | | | Pregnant | | | 21/11/05 | 23/11/05 |
| 705 | | | Pregnant | | | 23/11/05 | 14/12/05 |
| 324 | 9/05/06 | 500 | Pregnant | | | 27/11/05 | 16/01/06 |
| 125 | 11/05/06 | 400 | Pregnant | | | 23/11/05 | 14/12/05 |
| 123 | 11/05/06 | 700 | Pregnant | | | 22/11/05 | 14/12/05 |
| 676 | | | Pregnant | | | 21/11/05 | 14/12/05 |
| 237 | | | Pregnant | | | 23/11/05 | 30/11/05 |
| 246 | | | Pregnant | | | 23/11/05 | 30/11/05 |
| 755 | | | Pregnant | | | 23/11/05 | 16/12/05 |
| 381 | | | Pregnant | | | 18/11/05 | 15/12/05 |
| 430 | | | Pregnant | | | 18/11/05 | 15/12/05 |
| 36 | | | Pregnant | | | 23/11/05 | 13/12/05 |
| 330 | | | Pregnant | | | 28/11/05 | 16/01/06 |
| 387 | | | Pregnant | | | 3/12/05 | 15/12/05 |
| 554 | | | Pregnant | | | 17/11/05 | 14/12/05 |
| 713 | | | Pregnant | | | 17/11/05 | 14/12/05 |
| 385 | | | Pregnant | | | 19/11/05 | 15/12/05 |
| 483 | | | Pregnant | | | 17/11/05 | 23/11/05 |
| 133 | 11/05/06 | 190 | Pregnant | 15.78443 | 20/01/06 | 7/12/05 | 14/12/05 |
| 495 | 11/05/06 | 600 | Pregnant | | | 21/11/05 | 23/11/05 |
| 45 | | | Pregnant | | | 19/11/05 | 13/12/05 |
| 527 | | | Pregnant | | | 22/11/05 | 14/12/05 |
| 572 | | | Pregnant | | | 21/11/05 | 14/12/05 |
| 466 | | | Pregnant | | | 22/11/05 | 23/11/05 |
| 39 | | | Pregnant | | | 23/11/05 | 13/12/05 |
| 307 | | | Pregnant | | | 27/11/05 | 16/01/06 |
| 400 | | | Pregnant | | | 18/11/05 | 15/12/05 |
| 821 | | | Pregnant | | | 18/11/05 | 16/12/05 |
| 506 | | | Pregnant | | | 17/11/05 | 14/12/05 |
| 730 | | | Pregnant | | | 19/11/05 | 16/12/05 |
| 596 | | | Pregnant | | | 26/11/05 | 14/12/05 |
| 568 | 16/05/06 | 300 | Pregnant | 17.799 | 11/01/06 | 30/11/05 | 14/12/05 |
| 72 | 11/05/06 | 700 | Pregnant | | | 4/12/05 | 14/12/05 |
| 615 | | | Pregnant | | | 21/11/05 | 14/12/05 |
| 22 | | | Pregnant | | | 21/11/05 | 13/12/05 |
| 272 | | | Pregnant | | | 22/11/05 | 30/11/05 |
| 234 | | | Pregnant | | | 23/11/05 | 30/11/05 |
| 481 | | | Pregnant | | | 22/11/05 | 23/11/05 |
| 358 | | | Pregnant | | | 27/11/05 | 16/01/06 |
| 359 | 9/05/06 | 600 | Pregnant | | | 27/11/05 | 16/01/06 |
| 526 | | | Pregnant | | | 23/11/05 | 14/12/05 |
| 318 | | | Pregnant | | | 27/11/05 | 16/01/06 |
| 336 | | | Pregnant | | | 27/11/05 | 16/01/06 |
| 334 | 9/05/06 | 600 | Pregnant | | | 27/11/05 | 16/01/06 |
| 447 | | | Pregnant | | | 4/12/05 | 15/12/05 |
| 456 | | | Pregnant | | | 17/11/05 | 23/11/05 |
| 567 | | | Pregnant | | | 28/11/05 | 14/12/05 |
| 643 | | | Pregnant | | | 29/11/05 | 14/12/05 |
| 14 | | | Pregnant | | | 30/11/05 | 13/12/05 |
| 130 | | | Pregnant | | | 10/12/05 | 14/12/05 |
| 91 | | | Pregnant | | | 27/11/05 | 14/12/05 |
| 666 | 16/05/06 | 600 | Pregnant | | | 20/11/05 | 14/12/05 |
| 222 | | | Pregnant | | | 22/11/05 | 30/11/05 |
| 50 | | | Pregnant | | | 11/12/05 | 13/12/05 |
| 779 | | | Pregnant | | | 29/11/05 | 16/12/05 |
| 575 | | | Pregnant | | | 28/11/05 | 14/12/05 |
| 647 | | | Pregnant | | | 22/11/05 | 14/12/05 |
| 630 | | | Pregnant | | | 22/11/05 | 14/12/05 |
| 275 | | | Pregnant | | | 22/11/05 | 30/11/05 |
| 316 | | | Pregnant | | | 27/11/05 | 16/01/06 |
| 340 | | | Pregnant | | | 27/11/05 | 16/01/06 |
| 335 | | | Pregnant | | | 27/11/05 | 16/01/06 |
| 317 | | | Pregnant | | | 17/11/05 | 16/01/06 |
| 326 | | | Pregnant | | | 17/11/05 | 16/01/06 |
| 773 | | | Pregnant | | | 18/11/05 | 16/12/05 |
| 68 | | | Pregnant | | | 1/12/05 | 14/12/05 |
| 126 | | | Pregnant | | | 1/12/05 | 14/12/05 |
| 445 | 10/05/06 | 300 | Pregnant | 17.799 | 5/01/06 | 10/12/05 | 15/12/05 |
| 284 | | | Pregnant | | | 20/11/05 | 30/11/05 |
| 290 | | | Pregnant | | | 22/11/05 | 30/11/05 |
| 427 | | | Pregnant | | | 18/11/05 | 15/12/05 |
| 735 | | | Pregnant | | | 20/11/05 | 16/12/05 |
| 758 | | | Pregnant | | | 18/11/05 | 16/12/05 |
| 629 | | | Pregnant | | | 23/11/05 | 14/12/05 |
| 285 | | | Pregnant | | | 22/11/05 | 30/11/05 |
| 521 | | | Pregnant | | | 26/11/05 | 14/12/05 |
| 229 | | | Pregnant | | | 25/11/05 | 30/11/05 |
| 41 | | | Pregnant | | | 4/12/05 | 13/12/05 |
| 53 | | | Pregnant | | | 28/11/05 | 13/12/05 |
| 680 | | | Pregnant | | | 28/11/05 | 14/12/05 |
| 706 | | | Pregnant | | | 21/11/05 | 14/12/05 |
| 640 | | | Pregnant | | | 21/11/05 | 14/12/05 |
| 227 | | | Pregnant | | | 23/11/05 | 30/11/05 |
| 9 | | | Pregnant | | | 22/11/05 | 13/12/05 |
| 342 | | | Pregnant | | | 2/12/05 | 16/01/06 |
| 343 | | | Pregnant | | | 27/11/05 | 16/01/06 |
| 312 | | | Pregnant | | | 27/11/05 | 16/01/06 |
| 329 | | | Pregnant | | | 27/11/05 | 16/01/06 |
| 603 | | | Pregnant | | | 24/11/05 | 14/12/05 |
| 346 | 9/05/06 | 600 | Pregnant | | | 27/11/05 | 16/01/06 |
| 820 | | | Pregnant | | | 17/11/05 | 16/12/05 |
| 403 | | | Pregnant | | | 18/11/05 | 15/12/05 |
| 404 | | | Pregnant | | | 18/11/05 | 15/12/05 |
| 550 | | | Pregnant | | | 23/11/05 | 14/12/05 |
| 678 | | | Pregnant | | | 23/11/05 | 14/12/05 |
| 310 | | | Pregnant | | | 27/11/05 | 16/01/06 |
| 348 | | | Pregnant | | | 27/11/05 | 16/01/06 |
| 81 | | | Pregnant | | | 30/11/05 | 14/12/05 |
| 770 | | | Pregnant | | | 18/11/05 | 16/12/05 |
| 753 | | | Pregnant | | | 18/11/05 | 16/12/05 |
| 519 | | | Pregnant | | | 24/11/05 | 14/12/05 |
| 794 | | | Pregnant | | | 19/11/05 | 16/12/05 |
| 283 | 9/05/06 | 700 | Pregnant | | | 23/11/05 | 30/11/05 |
| 243 | | | Pregnant | | | 23/11/05 | 30/11/05 |
| 303 | | | Pregnant | | | 24/11/05 | 30/11/05 |
| 57 | | | Pregnant | | | 4/12/05 | 14/12/05 |
| 518 | | | Pregnant | | | 18/11/05 | 14/12/05 |
| 388 | | | Pregnant | | | 28/11/05 | 15/12/05 |
| 503 | | | Pregnant | | | 20/11/05 | 14/12/05 |
| 278 | | | Pregnant | | | 22/11/05 | 30/11/05 |
| 106 | | | Pregnant | | | 21/11/05 | 14/12/05 |
| 528 | | | Pregnant | | | 21/11/05 | 14/12/05 |
| 19 | | | Pregnant | | | 5/12/05 | 13/12/05 |
| 436 | | | Pregnant | | | 7/12/05 | 15/12/05 |
| 110 | | | Pregnant | | | 22/11/05 | 14/12/05 |
| 470 | | | Pregnant | | | 21/11/05 | 23/11/05 |
| 20 | | | Pregnant | | | 22/11/05 | 13/12/05 |
| 486 | | | Pregnant | | | 22/11/05 | 23/11/05 |
| 338 | | | Pregnant | | | 27/11/05 | 16/01/06 |
| 6 | | | Pregnant | | | 7/12/05 | 13/12/05 |
| 191 | | | Pregnant | | | 14/12/05 | 15/12/05 |
| 333 | | | Pregnant | | | 27/11/05 | 16/01/06 |
| 384 | | | Pregnant | | | 18/11/05 | 15/12/05 |
| 315 | | | Pregnant | | | 18/11/05 | 16/01/06 |
| 386 | | | Pregnant | | | 18/11/05 | 15/12/05 |
| 355 | | | Pregnant | | | 17/11/05 | 16/01/06 |
| 446 | | | Pregnant | | | 18/11/05 | 15/12/05 |
| 108 | | | Pregnant | | | 23/11/05 | 14/12/05 |
| 656 | | | Pregnant | | | 23/11/05 | 14/12/05 |
| 306 | | | Pregnant | | | 27/11/05 | 16/01/06 |
| 113 | 11/05/06 | 600 | Pregnant | | | 24/11/05 | 14/12/05 |
| 686 | | | Pregnant | | | 24/11/05 | 14/12/05 |
| 409 | | | Pregnant | | | 20/11/05 | 15/12/05 |
| 830 | | | Pregnant | | | 19/11/05 | 16/12/05 |
| 726 | | | Pregnant | | | 19/11/05 | 16/12/05 |
| 709 | | | Pregnant | | | 28/11/05 | 14/12/05 |
| 390 | | | Pregnant | | | 29/11/05 | 15/12/05 |
| 689 | | | Pregnant | | | 1/12/05 | 14/12/05 |
| 668 | | | Pregnant | | | 4/12/05 | 14/12/05 |
| 540 | 16/05/06 | 250 | Pregnant | 16.88329 | 17/01/06 | 23/11/05 | 14/12/05 |
| 507 | | | Pregnant | | | 27/11/05 | 14/12/05 |
| 669 | | | Pregnant | | | 5/12/05 | 14/12/05 |
| 95 | 11/05/06 | 500 | Pregnant | | | 27/11/05 | 14/12/05 |
| 609 | | | Pregnant | | | 21/11/05 | 14/12/05 |
| 605 | | | Pregnant | | | 22/11/05 | 14/12/05 |
| 673 | | | Pregnant | | | 22/11/05 | 14/12/05 |
| 667 | | | Pregnant | | | 21/11/05 | 14/12/05 |
| 511 | | | Pregnant | | | 22/11/05 | 14/12/05 |
| 582 | | | Pregnant | | | 22/11/05 | 14/12/05 |
| 627 | | | Pregnant | | | 7/12/05 | 14/12/05 |
| 350 | | | Pregnant | | | 27/11/05 | 16/01/06 |
| 397 | | | Pregnant | | | 18/11/05 | 15/12/05 |
| 398 | | | Pregnant | | | 18/11/05 | 15/12/05 |
| 683 | | | Pregnant | | | 23/11/05 | 14/12/05 |
| 34 | | | Pregnant | | | 7/12/05 | 13/12/05 |
| 87 | | | Pregnant | | | 17/11/05 | 14/12/05 |
| 832 | | | Pregnant | | | 18/11/05 | 16/12/05 |
| 664 | | | Pregnant | | | 17/11/05 | 14/12/05 |
| 693 | | | Pregnant | | | 17/11/05 | 14/12/05 |
| 674 | | | Pregnant | | | 24/11/05 | 14/12/05 |
| 103 | 11/05/06 | 300 | Pregnant | 17.799 | 6/01/06 | 9/12/05 | 14/12/05 |
| 777 | | | Pregnant | | | 19/11/05 | 16/12/05 |
| 803 | 9/05/06 | 300 | Pregnant | 17.799 | 4/01/06 | 26/11/05 | 16/12/05 |
| 608 | | | Pregnant | | | 20/11/05 | 14/12/05 |
| 580 | 16/05/06 | 500 | Pregnant | | | 27/11/05 | 14/12/05 |
| 122 | 11/05/06 | 160 | Pregnant | 15.235 | 24/01/06 | 4/12/05 | 14/12/05 |
| 242 | | | Pregnant | | | 22/11/05 | 30/11/05 |
| 129 | 11/05/06 | 140 | Probably | 14.86871 | 26/01/06 | 27/11/05 | 14/12/05 |
| 710 | | | Pregnant | | | 10/12/05 | 14/12/05 |
| 690 | | | Pregnant | | | 19/11/05 | 14/12/05 |
| 653 | | | Pregnant | | | 20/11/05 | 14/12/05 |
| 1 | | | Pregnant | | | 4/12/05 | 13/12/05 |
| 520 | | | Pregnant | | | 20/11/05 | 14/12/05 |
| 223 | | | Pregnant | | | 22/11/05 | 30/11/05 |
| 228 | | | Pregnant | | | 22/11/05 | 30/11/05 |
| 651 | | | Pregnant | | | 21/11/05 | 14/12/05 |
| 659 | | | Pregnant | | | 21/11/05 | 14/12/05 |
| 469 | | | Pregnant | | | 19/11/05 | 23/11/05 |
| 491 | | | Pregnant | | | 19/11/05 | 23/11/05 |
| 241 | | | Pregnant | | | 23/11/05 | 30/11/05 |
| 394 | | | Pregnant | | | 17/11/05 | 15/12/05 |
| 522 | | | Pregnant | | | 22/11/05 | 14/12/05 |
| 529 | | | Pregnant | | | 22/11/05 | 14/12/05 |
| 574 | | | Pregnant | | | 22/11/05 | 14/12/05 |
| 421 | 10/05/06 | 500 | Pregnant | | | 8/12/05 | 15/12/05 |
| 405 | | | Pregnant | | | 2/12/05 | 15/12/05 |
| 190 | | | Pregnant | | | 19/11/05 | 15/12/05 |
| 114 | | | Pregnant | | | 23/11/05 | 14/12/05 |
| 672 | | | Pregnant | | | 23/11/05 | 14/12/05 |
| 293 | | | Pregnant | | | 25/11/05 | 30/11/05 |
| 332 | | | Pregnant | | | 27/11/05 | 16/01/06 |
| 339 | | | Pregnant | | | 1/12/05 | 16/01/06 |
| 473 | | | Pregnant | | | 23/11/05 | 23/11/05 |
| 119 | | | Pregnant | | | 24/11/05 | 14/12/05 |
| 29 | | | Pregnant | | | 17/11/05 | 13/12/05 |
| 576 | | | Pregnant | | | 24/11/05 | 14/12/05 |
| 21 | | | Pregnant | | | 1/12/05 | 13/12/05 |
| 784 | | | Pregnant | | | 19/11/05 | 16/12/05 |
| 702 | 16/05/06 | 300 | Pregnant | 17.799 | 11/01/06 | 2/12/05 | 14/12/05 |
| 70 | 11/05/06 | 700 | Pregnant | | | 1/12/05 | 14/12/05 |
| 31 | | | Pregnant | | | 2/12/05 | 13/12/05 |
| 12 | | | Pregnant | | | 9/12/05 | 13/12/05 |
| 515 | | | Pregnant | | | 18/11/05 | 14/12/05 |
| 23 | | | Pregnant | | | 25/11/05 | 13/12/05 |
| 729 | | | Pregnant | | | 20/11/05 | 16/12/05 |
| 448 | | | Pregnant | | | 13/12/05 | 15/12/05 |
| 444 | | | Pregnant | | | 29/11/05 | 15/12/05 |
| 745 | | | Pregnant | | | 12/12/05 | 16/12/05 |
| 612 | | | Pregnant | | | 21/11/05 | 14/12/05 |
| 671 | | | Pregnant | | | 21/11/05 | 14/12/05 |
| 685 | | | Pregnant | | | 21/11/05 | 14/12/05 |
| 698 | | | Pregnant | | | 21/11/05 | 14/12/05 |
| 704 | | | Pregnant | | | 21/11/05 | 14/12/05 |
| 646 | | | Pregnant | | | 6/12/05 | 14/12/05 |
| 513 | | | Pregnant | | | 22/11/05 | 14/12/05 |
| 377 | | | Pregnant | | | 18/11/05 | 15/12/05 |
| 193 | | | Pregnant | | | 30/11/05 | 15/12/05 |
| 361 | | | Pregnant | | | 27/11/05 | 16/01/06 |
| 322 | 9/05/06 | 250 | Pregnant | 16.88329 | 10/01/06 | 2/12/05 | 16/01/06 |
| 797 | | | Pregnant | | | 17/11/05 | 16/12/05 |
| 382 | | | Pregnant | | | 18/11/05 | 15/12/05 |
| 432 | | | Pregnant | | | 18/11/05 | 15/12/05 |
| 584 | | | Pregnant | | | 23/11/05 | 14/12/05 |
| 525 | | | Pregnant | | | 30/11/05 | 14/12/05 |
| 728 | | | Pregnant | | | 18/11/05 | 16/12/05 |
| 429 | | | Pregnant | | | 19/11/05 | 15/12/05 |
| 26 | | | Pregnant | | | 24/11/05 | 13/12/05 |
| 818 | | | Pregnant | | | 26/11/05 | 16/12/05 |
| 655 | 16/05/06 | 180 | Pregnant | 15.60129 | 26/01/06 | 22/11/05 | 14/12/05 |
| 691 | | | Pregnant | | | 28/11/05 | 14/12/05 |
| 670 | | | Pregnant | | | 19/11/05 | 14/12/05 |
| 552 | | | Pregnant | | | 27/11/05 | 14/12/05 |
| 531 | | | Pregnant | | | 20/11/05 | 14/12/05 |
| 714 | | | Pregnant | | | 20/11/05 | 14/12/05 |
| 555 | | | Pregnant | | | 21/11/05 | 14/12/05 |
| 262 | | | Pregnant | | | 22/11/05 | 30/11/05 |
| 300 | | | Pregnant | | | 22/11/05 | 30/11/05 |
| 51 | | | Pregnant | | | 27/11/05 | 13/12/05 |
| 383 | | | Pregnant | | | 29/11/05 | 15/12/05 |
| 788 | | | Pregnant | | | 12/12/05 | 16/12/05 |
| 566 | | | Pregnant | | | 21/11/05 | 14/12/05 |
| 504 | | | Pregnant | | | 21/11/05 | 14/12/05 |
| 420 | | | Pregnant | | | 17/11/05 | 15/12/05 |
| 578 | | | Pregnant | | | 22/11/05 | 14/12/05 |
| 581 | | | Pregnant | | | 22/11/05 | 14/12/05 |
| 583 | | | Pregnant | | | 22/11/05 | 14/12/05 |
| 742 | | | Pregnant | | | 17/11/05 | 16/12/05 |
| 370 | | | Pregnant | | | 18/11/05 | 15/12/05 |
| 662 | | | Pregnant | | | 23/11/05 | 14/12/05 |
| 675 | | | Pregnant | | | 23/11/05 | 14/12/05 |
| 313 | | | Pregnant | | | 27/11/05 | 16/01/06 |
| 732 | | | Pregnant | | | 18/11/05 | 16/12/05 |
| 407 | | | Pregnant | | | 19/11/05 | 15/12/05 |
| 74 | 11/05/06 | 600 | Pregnant | | | 19/11/05 | 14/12/05 |
| 289 | | | Pregnant | | | 21/11/05 | 30/11/05 |
| 677 | | | Pregnant | | | 24/11/05 | 14/12/05 |
| 695 | | | Pregnant | | | 18/11/05 | 14/12/05 |
| 64 | | | Pregnant | | | 26/11/05 | 14/12/05 |
| 631 | | | Pregnant | | | 26/11/05 | 14/12/05 |
| 607 | | | Pregnant | | | 19/11/05 | 14/12/05 |
| 638 | | | Pregnant | | | 3/12/05 | 14/12/05 |
| 636 | | | Pregnant | | | 20/11/05 | 14/12/05 |
| 828 | | | Pregnant | | | 21/11/05 | 16/12/05 |
| 292 | | | Pregnant | | | 22/11/05 | 30/11/05 |
| 505 | | | Pregnant | | | 28/11/05 | 14/12/05 |
| 635 | | | Pregnant | | | 21/11/05 | 14/12/05 |
| 524 | | | Pregnant | | | 21/11/05 | 14/12/05 |
| 577 | | | Pregnant | | | 21/11/05 | 14/12/05 |
| 658 | | | Pregnant | | | 21/11/05 | 14/12/05 |
| 225 | | | Pregnant | | | 23/11/05 | 30/11/05 |
| 254 | | | Pregnant | | | 23/11/05 | 30/11/05 |
| 587 | | | Pregnant | | | 28/11/05 | 14/12/05 |
| 220 | | | Pregnant | | | 24/11/05 | 30/11/05 |
| 756 | | | Pregnant | | | 30/11/05 | 16/12/05 |
| 85 | 11/05/06 | 700 | Pregnant | | | 6/12/05 | 14/12/05 |
| 97 | 11/05/06 | 700 | Pregnant | | | 6/12/05 | 14/12/05 |
| 586 | | | Pregnant | | | 22/11/05 | 14/12/05 |
| 696 | | | Pregnant | | | 22/11/05 | 14/12/05 |
| 763 | | | Pregnant | | | 23/11/05 | 16/12/05 |
| 440 | | | Pregnant | | | 18/11/05 | 15/12/05 |
| 731 | | | Pregnant | | | 17/11/05 | 16/12/05 |
| 815 | | | Pregnant | | | 17/11/05 | 16/12/05 |
| 418 | | | Pregnant | | | 18/11/05 | 15/12/05 |
| 621 | | | Pregnant | | | 17/11/05 | 14/12/05 |
| 684 | | | Pregnant | | | 17/11/05 | 14/12/05 |
| 639 | 16/05/06 | 160 | Pregnant | 15.235 | 29/01/06 | 21/11/05 | 14/12/05 |
| 614 | | | Pregnant | | | 27/11/05 | 14/12/05 |
| 652 | 16/05/06 | 400 | Pregnant | | | 18/11/05 | 14/12/05 |
| 692 | | | Pregnant | | | 18/11/05 | 14/12/05 |
| 32 | | | Pregnant | | | 2/12/05 | 13/12/05 |
| 747 | | | Pregnant | | | 20/11/05 | 16/12/05 |
| 641 | | | Pregnant | | | 3/12/05 | 14/12/05 |
| 665 | | | Pregnant | | | 10/12/05 | 14/12/05 |
| 401 | | | Pregnant | | | 12/12/05 | 15/12/05 |
| 542 | 16/05/06 | 170 | Pregnant | 15.41814 | 28/01/06 | 22/11/05 | 14/12/05 |
| 535 | | | Pregnant | | | 26/11/05 | 14/12/05 |
| 782 | | | Pregnant | | | 27/11/05 | 16/12/05 |
| 633 | | | Pregnant | | | 20/11/05 | 14/12/05 |
| 560 | | | Pregnant | | | 20/11/05 | 14/12/05 |
| 606 | | | Pregnant | | | 27/11/05 | 14/12/05 |
| 73 | | | Pregnant | | | 21/11/05 | 14/12/05 |
| 700 | | | Pregnant | | | 21/11/05 | 14/12/05 |
| 351 | | | Pregnant | | | 27/11/05 | 16/01/06 |
| 373 | | | Pregnant | | | 18/11/05 | 15/12/05 |
| 308 | | | Pregnant | | | 17/11/05 | 16/01/06 |
| 354 | 9/05/06 | 700 | Probably | | | 30/12/05 | 16/01/06 |
| 563 | | | Pregnant | | | 17/11/05 | 14/12/05 |
| 663 | | | Pregnant | | | 24/11/05 | 14/12/05 |
| 766 | 9/05/06 | 400 | Pregnant | | | 17/11/05 | 16/12/05 |
| 767 | | | Pregnant | | | 19/11/05 | 16/12/05 |
| 88 | | | Pregnant | | | 26/11/05 | 14/12/05 |
| 618 | | | Pregnant | | | 19/11/05 | 14/12/05 |
| 805 | | | Pregnant | | | 20/11/05 | 16/12/05 |
| 829 | | | Pregnant | | | 20/11/05 | 16/12/05 |
| 78 | 11/05/06 | 180 | Pregnant | 15.60129 | 21/01/06 | 3/12/05 | 14/12/05 |
| 719 | | | Pregnant | | | 12/12/05 | 16/12/05 |
| 715 | 16/05/06 | 400 | Pregnant | | | 28/11/05 | 14/12/05 |
| 611 | | | Pregnant | | | 22/11/05 | 14/12/05 |
| 660 | | | Pregnant | | | 22/11/05 | 14/12/05 |
| 808 | | | Pregnant | | | 17/11/05 | 16/12/05 |
| 760 | | | Pregnant | | | 17/11/05 | 16/12/05 |
| 314 | | | Pregnant | | | 6/12/05 | 16/01/06 |
| 744 | | | Pregnant | | | 13/12/05 | 16/12/05 |
| 532 | | | Pregnant | | | 18/11/05 | 14/12/05 |
| 707 | | | Pregnant | | | 18/11/05 | 14/12/05 |
| 2 | | | Pregnant | | | 19/11/05 | 13/12/05 |
| 579 | | | Pregnant | | | 19/11/05 | 14/12/05 |
| 649 | | | Pregnant | | | 19/11/05 | 14/12/05 |
| 423 | | | Pregnant | | | 21/11/05 | 15/12/05 |
| 654 | | | Pregnant | | | 20/11/05 | 14/12/05 |
| 749 | | | Pregnant | | | 12/12/05 | 16/12/05 |
| 835 | | | Pregnant | | | 22/11/05 | 16/12/05 |
| 467 | | | Pregnant | | | 20/11/05 | 23/11/05 |
| 610 | | | Pregnant | | | 22/11/05 | 14/12/05 |
| 722 | | | Pregnant | | | 17/11/05 | 16/12/05 |
| 823 | | | Pregnant | | | 24/11/05 | 16/12/05 |
| 37 | | | Pregnant | | | 23/11/05 | 13/12/05 |
| 496 | | | Pregnant | | | 17/11/05 | 23/11/05 |
| 195 | 11/05/06 | 190 | Pregnant | 15.78443 | 20/01/06 | 2/12/05 | 15/12/05 |
| 802 | 9/05/06 | 200 | Pregnant | 15.96757 | 17/01/06 | 2/12/05 | 16/12/05 |
| 790 | | | Pregnant | | | 20/11/05 | 16/12/05 |
| 117 | | | Pregnant | | | 20/11/05 | 14/12/05 |
| 650 | | | Pregnant | | | 21/11/05 | 14/12/05 |
| 301 | | | Pregnant | | | 30/11/05 | 30/11/05 |
| 632 | | | Pregnant | | | 22/11/05 | 14/12/05 |
| 833 | | | Pregnant | | | 18/11/05 | 16/12/05 |
| 500 | | | Pregnant | | | 20/11/05 | 23/11/05 |
| 46 | | | Pregnant | | | 25/11/05 | 13/12/05 |
| 721 | | | Pregnant | | | 20/11/05 | 16/12/05 |
| 751 | | | Pregnant | | | 20/11/05 | 16/12/05 |
| 783 | | | Pregnant | | | 20/11/05 | 16/12/05 |
| 734 | | | Pregnant | | | 12/12/05 | 16/12/05 |
| 360 | | | Pregnant | | | 27/11/05 | 16/01/06 |
| 455 | | | Pregnant | | | 19/11/05 | 23/11/05 |
| 746 | | | Pregnant | | | 13/12/05 | 16/12/05 |
| 25 | | | Pregnant | | | 18/11/05 | 13/12/05 |
| 711 | | | Pregnant | | | 19/11/05 | 14/12/05 |
| 679 | | | Pregnant | | | 20/11/05 | 14/12/05 |
| 681 | | | Pregnant | | | 20/11/05 | 14/12/05 |
| 52 | | | Pregnant | | | 7/12/05 | 13/12/05 |
| 703 | | | Pregnant | | | 8/12/05 | 14/12/05 |
| 642 | | | Pregnant | | | 18/11/05 | 14/12/05 |
| 396 | 10/05/06 | 400 | Pregnant | | | 29/11/05 | 15/12/05 |
| 15 | | | Pregnant | | | 26/11/05 | 13/12/05 |
| 464 | | | Pregnant | | | 21/11/05 | 23/11/05 |
| 61 | 11/05/06 | 180 | Pregnant | 15.60129 | 21/01/06 | 26/11/05 | 14/12/05 |
| 812 | | | Pregnant | | | 20/11/05 | 16/12/05 |
| 471 | 11/05/06 | 130 | Probably | 14.68557 | 28/01/06 | 19/11/05 | 23/11/05 |
| 493 | | | Pregnant | | | 18/11/05 | 23/11/05 |
| 452 | | | Pregnant | | | 20/11/05 | 23/11/05 |
| 701 | | | Pregnant | | | 6/12/05 | 14/12/05 |
| 277 | | | Pregnant | | | 22/11/05 | 30/11/05 |
| 232 | | | Pregnant | | | 20/11/05 | 30/11/05 |
| 489 | | | Pregnant | | | 21/11/05 | 23/11/05 |
| 344 | | | Pregnant | | | 27/11/05 | 16/01/06 |
| 814 | | | Pregnant | | | 17/11/05 | 16/12/05 |
| 76 | 11/05/06 | 180 | Pregnant | 15.60129 | 21/01/06 | 14/12/05 | 14/12/05 |
| 428 | | | Pregnant | | | 18/11/05 | 15/12/05 |
| 688 | | | Pregnant | | | 18/11/05 | 14/12/05 |
| 419 | | | Pregnant | | | 25/11/05 | 15/12/05 |
| 309 | | | Pregnant | | | 27/11/05 | 16/01/06 |
| 49 | | | Pregnant | | | 10/12/05 | 13/12/05 |
| 512 | 16/05/06 | 190 | Pregnant | 15.78443 | 25/01/06 | 23/11/05 | 14/12/05 |
| 725 | | | Pregnant | | | 21/11/05 | 16/12/05 |
| 121 | | | Pregnant | | | 17/11/05 | 14/12/05 |
| 443 | | | Pregnant | | | 17/11/05 | 15/12/05 |
| 634 | | | Pregnant | | | 18/11/05 | 14/12/05 |
| 393 | | | Pregnant | | | 17/11/05 | 15/12/05 |
| 708 | | | Pregnant | | | 19/11/05 | 14/12/05 |
| 616 | | | Pregnant | | | 22/11/05 | 14/12/05 |
| 48 | | | Pregnant | | | 5/12/05 | 13/12/05 |
| 759 | | | Pregnant | | | 19/11/05 | 16/12/05 |
| 569 | | | Pregnant | | | 19/11/05 | 14/12/05 |
| 221 | | | Pregnant | | | 20/11/05 | 30/11/05 |
| 694 | | | Pregnant | | | 22/11/05 | 14/12/05 |
| 465 | | | Pregnant | | | 21/11/05 | 23/11/05 |
| 458 | | | Pregnant | | | 18/11/05 | 23/11/05 |
| 501 | | | Pregnant | | | 21/11/05 | 14/12/05 |
| 595 | | | Pregnant | | | 24/11/05 | 14/12/05 |
| 297 | 9/05/06 | 140 | Probably | 14.86871 | 24/01/06 | 22/11/05 | 30/11/05 |
| 380 | 10/05/06 | 180 | Pregnant | 15.60129 | 20/01/06 | 28/11/05 | 15/12/05 |
| 111 | | | Probably | | | 9/12/05 | 14/12/05 |
| 378 | | | Pregnant | | | 24/11/05 | 15/12/05 |
| 137 | | | Pregnant | | | 18/11/05 | 15/12/05 |
| 186 | | | Probably | | | 11/12/05 | 15/12/05 |
| 158 | | | Pregnant | | | 18/11/05 | 15/12/05 |
| 648 | | | Pregnant | | | 21/11/05 | 14/12/05 |
| 182 | | | Pregnant | | | 19/11/05 | 15/12/05 |
| 167 | | | Pregnant | | | 5/12/05 | 15/12/05 |
| 152 | | | Pregnant | | | 6/12/05 | 15/12/05 |
| 204 | | | Probably | | | 12/12/05 | 15/12/05 |
| 196 | | | Pregnant | | | 22/11/05 | 15/12/05 |
| 203 | | | Pregnant | | | 14/12/05 | 15/12/05 |
| 171 | | | Pregnant | | | 17/11/05 | 15/12/05 |
| 170 | | | Pregnant | | | 20/11/05 | 15/12/05 |
| 164 | | | Pregnant | | | 30/11/05 | 15/12/05 |
| 188 | | | Pregnant | | | 17/11/05 | 15/12/05 |
| 392 | | | Pregnant | | | 18/11/05 | 15/12/05 |
| 184 | | | Pregnant | | | 19/11/05 | 15/12/05 |
| 198 | | | Pregnant | | | 19/11/05 | 15/12/05 |
| 154 | | | Pregnant | | | 17/11/05 | 15/12/05 |
| 145 | | | Pregnant | | | 19/11/05 | 15/12/05 |
| 175 | | | Pregnant | | | 19/11/05 | 15/12/05 |
| 177 | | | Pregnant | | | 3/12/05 | 15/12/05 |
| 172 | | | Pregnant | | | 17/11/05 | 15/12/05 |
| 148 | | | Pregnant | | | 18/11/05 | 15/12/05 |
| 139 | | | Pregnant | | | 21/11/05 | 15/12/05 |
| 153 | | | Pregnant | | | 19/11/05 | 15/12/05 |
| 147 | | | Pregnant | | | 17/11/05 | 15/12/05 |
| 570 | | | Pregnant | | | 22/11/05 | 14/12/05 |
| 173 | | | Pregnant | | | 20/11/05 | 15/12/05 |
| 144 | | | Pregnant | | | 18/11/05 | 15/12/05 |
| 209 | | | Pregnant | | | 18/11/05 | 15/12/05 |
| 187 | | | Pregnant | | | 21/11/05 | 15/12/05 |
| 174 | | | Pregnant | | | 15/12/05 | 15/12/05 |
| 194 | | | Pregnant | | | 13/12/05 | 15/12/05 |
| 142 | | | Pregnant | | | 18/11/05 | 15/12/05 |
| 150 | | | Pregnant | | | 18/11/05 | 15/12/05 |
| 138 | | | Pregnant | | | 22/11/05 | 15/12/05 |
| 146 | | | Pregnant | | | 27/11/05 | 15/12/05 |
| 168 | | | Pregnant | | | 30/11/05 | 15/12/05 |
| 202 | | | Pregnant | | | 27/11/05 | 15/12/05 |
| 739 | 9/05/06 | 20 | Not confirmed | | | 22/11/05 | 16/12/05 |
| 544 | 16/05/06 | 20 | Not confirmed | | | 21/11/05 | 14/12/05 |
| 645 | | | Probably | | | 22/11/05 | 14/12/05 |
| 83 | | | Not confirmed | | | 14/12/05 | 14/12/05 |
| 99 | | | Not confirmed | | | 26/11/05 | 14/12/05 |
| 100 | | | Not confirmed | | | 5/12/05 | 14/12/05 |
| 104 | | | Not confirmed | | | 30/11/05 | 14/12/05 |
| 143 | | | Not confirmed | | | 15/12/05 | 15/12/05 |
| 69 | | | Not confirmed | | | 9/12/05 | 14/12/05 |
| 197 | | | Not confirmed | | | 20/11/05 | 15/12/05 |
| 472 | 11/05/06 | 80 | Not confirmed | | | 21/11/05 | 23/11/05 |

A number of the data points shown in Table 5 and 6 are worked through to illustrate some embodiments of the invention.

### i) Estimated Conception Date Determination

Cow 84

| | Estimated C.D. | Calving date | Difference |
|---|---|---|---|
| Manual | 6 Dec. 2006 | 20 Oct. 2006 | 36 days early |
| ES & formula | 23 Jan. 2006 | 20 Oct. 2006 | 10 days early |
| | Based on the calving date | | |
| | the conception date was | | |
| | estimated to have been | | |
| | 11 Jan. 2006 | | |

Cow 84 was estimated to be pregnant by manual methods, and to have an estimated conception date of 6 Dec. 2005.

The first sample from this cow was obtained [step 102 FIG. 6] on 5 Apr. 2006. The result of 20 pg/mL resulted in the cow not being confirmed pregnant [steps 106, 108, 107 and 110, FIG. 6]. The second milk sample was tested on 11 May 2006 and had a result of 170 pg/mL; this result categorised the cow as pregnant [steps 102, 106, 104 FIG. 6]. Application of the regression formula (generated from historical values, as described in the specification) to this value [steps 122, 124, 126 FIG. 7] indicated the cow to be approximately 15.42 weeks pregnant [steps 128, 130, 132, 134 FIG. 7]:

y=0.1282×170+86.133=107.927 days

Therefore, the estimated conception date was 23 Jan. 2006, i.e. 15.42 weeks from the date of the latest sample.

Based on the ECD, the farmer could work out the expected calving date, and cease milking the cow 6 to 8 weeks prior. Relying on the manual method would have resulted in the farmer ceasing milking the cow 5 weeks early; thereby losing 5 weeks of income associated with the sale of her milk. In contrast, milking cessation was only 10 days early when relying on the ES assay result and the application of the regression formula thereto.

### ii) Estimated Conception Date—Validated.

Cow 765

| | ECD | Calving date | Difference |
|---|---|---|---|
| Manual | 23 Nov. 2005 | 26 Sep. 2006 | 25 days early |
| ES & formula | i) 21 Dec. 2005 - without | 26 Sep. 2006 | 5 days early |
| | validation | | |
| | ii) 13 Dec. 2005 - with | | |
| | validation | | |
| | Based on the calving date | | |
| | the conception date was | | |
| | estimated to have been | | |
| | 11 Jan. 2006 | | |

Cow 765 was estimated to be pregnant by manual methods, and to have an estimated conception date of 23 Nov. 2005.

The first milk sample from this cow was obtained on 11 Apr. 2006. The result of 190 pg/mL categorised the cow as pregnant [steps 102, 106, 104 FIG. 6]; application of the regression formula to this value [steps 122, 124, 126 FIG. 7] indicated the cow to be 15.78 weeks pregnant [steps 128, 130, 132, 134 FIG. 7]:

y=0.1282×190+86.133=110.491 days

Therefore the ECD was 21 Dec. 2005. The ECD was then validated with the available reproductive data.

The sample satisfied criteria of steps 152, 154 and 158 in FIG. 8. The ECD of 21 Dec. 2005 did not fall within an exclusive A1 period [step 160 FIG. 8] [last day in which A1 was used in the herd was 16 Dec. 2005] but was within 10 days of a recorded mating [step 162 FIG. 8] [13 Dec. 2005]. The ECD was therefore validated to be the closest mating date of 13 Dec. 2005 [step 164 FIG. 8].

Relying on the manual method would have resulted in the farmer ceasing to milk the cow almost 4 weeks early, in contrast to 5 days early when relying on the ES assay result and the application of the regression formulation thereto.

Cow 354

| | ECD | Calving date | Difference |
|---|---|---|---|
| Manual | 29 Dec. 2005 | 2 Oct. 2006 | 5 days late |
| ES & formula | i) 31 Dec. 2005 - without | 2 Oct. 2006 | 6 days late |
| | validation | | |
| | ii) 30 Dec. 2005 - with | | |
| | validation | | |
| | Based on the calving date | | |
| | the conception date was | | |
| | estimated to have been | | |
| | 24 Dec. 2005 | | |

Cow 354 was estimated to be pregnant by manual methods, and to have an estimated conception date of 29 Dec. 2005.

The first milk sample from this cow was obtained on 9 Apr. 2006. The result of 100 pg/mL categorised the cow as probably pregnant [steps 102, 106, 108, 107, 116 FIG. 6]; application of the regression formula to this value [steps 122, 124, 126 FIG. 7] indicated the cow to be 14.136 weeks pregnant [steps 128, 130, 132, 134 FIG. 7]:

y=0.1282×100+86.133=98.953 days

Therefore the ECD was 31 Dec. 2005.

A second sample from this cow was obtained on 9 May 2006. The result of 700 pg/mL categorised the cow as pregnant [steps 102, 106, 104 FIG. 6] but was too high to have the regression formula applied thereto [steps 122, 132, 134 FIG. 7].

The ECD obtained from the first test was then validated with the available reproductive data. The sample satisfied criteria of steps 152, 154 and 158 in FIG. 8. The ECD of 31 Dec. 2005 did fall within an exclusive AI period [step 160 FIG. 8] [last day in which AI was used in the herd was 16 Jan. 2006]. The ECD was after the last AI date [step 168 FIG. 8] [30 Dec. 2005] and was within 10 days of the last AI date [step 170 FIG. 8]. The ECD was therefore validated to be the last AI date. i.e., 30 Dec. 2005 [step 172 FIG. 8].

Relying on the manual method would have resulted in the farmer ceasing to milk the cow 5 days late, and 7 days late when relying on the ES assay result and the application of the regression formulation thereto.

### ii Estimated Calving Date Determination

It is possible to perform a forward calculation to determine the date of calving; in turn the farmer can determine the cessation of milking date 6-8 weeks earlier.

Cow 90

| | | | Actual |
|---|---|---|---|
| First estimate | Second estimate | Averaged date | calving date |
| 5 Oct. 2006 | 22 Oct. 2006 | 13-14 Oct. 2006 | 6 Oct. 2006 |

The first milk sample from this cow was obtained on 5 Apr. 2006. The result of 140 pg/mL categorised the cow as probably pregnant [steps 102, 106, 108, 107, 116 FIG. 6]; application of the regression formula to this value [steps 122, 124, 126 FIG. 7] indicated the cow to be 14.868 weeks pregnant [steps 128, 130, 132, 134 FIG. 7]:

y=0.1282×140+86.133=104.081 days

Therefore the cow had 183 days to go, making the estimated date of calving 5 Oct. 2006.

A second sample from this cow was obtained on 11 May 2006. The result of 250 pg/mL categorised the cow as pregnant [steps 102, 106, 104 FIG. 6]; application of the regression formula to this value [steps 122, 124, 126 FIG. 7] indicated the cow to be 16.88 weeks pregnant [steps 128, 130, 132, 134 FIG. 7]:

y=0.1282×250+86.133=118.183 days

Therefore the cow had 164 days to go, making the estimated date of calving 22 Oct. 2006. An average from the first and second test would therefore result in an estimated date of calving of 13-14 Oct. 2006.

1. A method of estimating the time elapsed within a gestation period of a pregnant or potentially pregnant ruminant, including the step of:
applying a regression formula to a calculated value of a pregnancy indicator in a sample obtained from the ruminant.

2. A method of estimating the time elapsed within a gestation period of a pregnant or potentially pregnant ruminant, including the steps of:
providing a sample from the ruminant;
calculating a value of a pregnancy indicator in the sample; and
applying a regression formula to the value of the pregnancy indicator to provide an estimate of the time elapsed within the gestation period.

3. A method according to claim 2, wherein the regression formula is characteristic of a profile of historically recorded temporal positions during a gestation period of one or more pregnant ruminants and the corresponding pregnancy indicator value in samples taken from those pregnant ruminants.

4. A method according to claim 3, wherein the regression formula is applied to pregnancy indicator values falling within a predetermined value range.

5. A method according to claim 4 wherein the predetermined range represents a period over which there is a sustained increase in the pregnancy indicator value.

6. A method according to claim 5 wherein the pregnancy indicator is estrone sulphate (ES).

7. A method according to claim 6 wherein the ES value in the sample is within the range of approximately 90 pg/mL to approximately 320 pg/mL.

8. A method according to claim 2 further including the step of categorising a pregnancy status of the ruminant based on the value of the pregnancy indicator in the sample, prior to the application of the regression formula.

9. A method according to claim 8 wherein the pregnancy indicator is estrone sulphate (ES).

10. A method according to claim 9 wherein the ruminant is categorised as being pregnant when the value of ES value is more than approximately 120 pg/mL.

11. A method according to claim 9 wherein the ruminant is categorised as being pregnant when the ES value is less than approximately 120 pg/mL, the ES value in an earlier sample is more that 90 pg/mL, and the ES value has increased by at least 0.1 pg/mL per day between the samples.

12. A method according to claim 2 further including the step of qualitatively assessing the level of the pregnancy indicator value for application thereto of the regression formula.

13. A method according to claim 2 further including the step of:
using the estimated time elapsed within the gestation period of the ruminant to derive an estimate of a date of a gestation-related event, the gestation-related event being one or more of a date of conception, a date of birthing, and a date of cessation of milking.

14. A method according to claim 13 wherein the gestation-related event is the date of conception.

15. A method according to claim 13 further including the step of:
validating the estimated date of a gestation-related event against reproductive data for that ruminant.

16. A method according to claim 15, wherein the reproductive data includes one or more of:
a date of last birthing;
one or more known artificial insemination dates;
a period of exclusive artificial insemination;
one or more known mating dates; and
a nominated voluntary waiting period for the ruminant to recover from a previous pregnancy.

17. A method according to claim 15 wherein the validation step is carried out if the ruminant calved more than a predetermined period before the estimated date of a gestation-related event.

18. Computer software including a series of instructions for use with a computing device, the computing device including a memory device for storing the series of instructions and a processor in communication with the memory device, the series of instructions causing the processor to generate an estimate of the time elapsed within a gestation period of a pregnant or potentially pregnant ruminant on the basis of a value of a pregnancy indicator in a sample obtained from the ruminant.

19. A system for generating an estimate of the time elapsed within a gestation period of a pregnant or potentially pregnant ruminant on the basis of a value of a pregnancy indicator in a sample obtained from the ruminant, the system including:
memory means for storing the series of software instructions;
processor means in communication with the memory means and configured to execute the series of instructions to estimate the time elapsed of a pregnant ruminant during a gestation period on the basis of a value of a pregnancy indicator in a sample taken from the ruminant.

20. A system according to claim 19 wherein the memory means includes a database structure, said database structure being configured to store at least one or more of the following types of data:
values of a pregnancy indicator in a sample obtained from the ruminant;
historically recorded temporal positions within a gestation period of one or more pregnant ruminants and the corresponding pregnancy indicator value in samples taken from the pregnant ruminant;
historically recorded temporal positions of one or more other pregnant ruminants during a gestation period and the corresponding pregnancy indicator value in samples taken from those pregnant ruminants;
one or more parameters used in the regression formula;
date of last birthing of the ruminant;
one or more known dates of artificial insemination;
a period of exclusive use of artificial insemination;
one or more known mating dates of the ruminant;
a nominated voluntary waiting period for the ruminant to recover from a previous pregnancy.

21. A system according to claim 19, wherein the system includes one or more remote terminals in data communication with a server system including the processor means and a memory means on which the database structure is stored, the remote terminal being adapted to enable entry of data into the database structure, and to query of the database to obtain data relating to the estimate of the time elapsed within the gestation period of the ruminant.

22. A system according to claim 19 which further includes a sample reading system for determining the value of a pregnancy indicator in the sample obtained from the ruminant.

23. A kit for estimating the time elapsed within a gestation period of a pregnant or potentially pregnant ruminant including
a sample reading system for determining a value of a pregnancy indicator in a sample; and
computer software including a series of instructions for use with a computing device, the computing device including a memory device for storing the series of instructions and a processor in communication with the memory device, the series of instructions causing the processor to generate an estimate of the time elapsed within a gestation period of a pregnant or potentially pregnant ruminant on the basis of the value of a pregnancy indicator in a sample obtained from the ruminant.
